(19) United States
(12) Patent Application Publication
(10) Pub. No.: US 2026/0239005 A1
(43) Pub. Date: Aug. 13, 2026

(54) ESIM AUTHENTICATION METHOD AND RELATED APPARATUS

(71) Applicant: Huawei Technologies Co., Ltd., Shenzhen (CN)

(72) Inventor: Tao Li, Shenzhen (CN)

(21) Appl. No.: 19/646,055

(22) Filed: Apr. 13, 2026

Related U.S. Application Data
(63) Continuation of application No. PCT/CN2024/131567, filed on Nov. 12, 2024.

(30) Foreign Application Priority Data
Nov. 14, 2023 (CN) 202311520265.X
Feb. 6, 2024 (CN) 202410173927.9

(51) Int. Cl. H04W 12/06

(52) U.S. Cl. CPC H04W 12/06

(57) ABSTRACT

A method applied to an embedded subscriber identity module (eSIM) module includes: storing a first device identity sent by a first processing module; receiving, after detecting that the eSIM module is powered off and then powered on, device check information sent by a second processing module; decrypting a second device identity from the device check information; in response to the first device identity being the same as the second device identity, normally performing a mobile communication service; and in response to the first device identity being different from the second device identity, or in response to the eSIM module not receiving the device check information sent by the second processing module after detecting that the eSIM module is powered off and then powered on, forbidding the eSIM module from performing the mobile communication service.

### CROSS-REFERENCE TO RELATED APPLICATIONS

This application is a continuation of International Application No. PCT/CN2024/131567, filed on November 12, 2024, which claims priority to Chinese Patent Application No. 202311520265.X, filed on November 14, 2023 and Chinese Patent Application No. 202410173927.9, filed on February 6, 2024. All of the aforementioned patent applications are hereby incorporated by reference in their entireties.

### TECHNICAL FIELD

This application relates to the field of communication technologies, and in particular, to an eSIM authentication method and a related apparatus.

### BACKGROUND

In the field of mobile communication, one of common mobile communication access solutions is a subscriber identity authentication access solution that is based on a subscriber identity module (SIM). A common implementation of this solution is that a user inserts a SIM card into a SIM card slot of a mobile communication device like a mobile phone or a tablet computer, and validity authentication is performed on the mobile communication device at a communication service provider through the inserted SIM card. After the authentication succeeds, the mobile communication device is allowed to access a mobile communication network.

With development of mobile communication technologies, based on the SIM card solution, an embedded SIM (eSIM) solution is proposed in the conventional technology. In the eSIM solution, a conventional SIM card is directly embedded into a chip of an electronic device, instead of being added to the device as an independent and removable component. The user does not need to insert the physical SIM card. This solution allows the user to select an operator more flexibly and write a new number into an eSIM module of the electronic device.

Currently, the user may write a new number into an eSIM module of a device like a watch on the mobile phone, so that the user can independently use the device like the watch to make and receive calls and access the Internet based on the eSIM module. However, after the eSIM module is disassembled, if the eSIM module is inserted into another device to access the mobile communication network, security of the mobile communication network is affected.

### SUMMARY

This application provides an eSIM authentication method and a related apparatus, to prevent an eSIM module in an electronic device from accessing a mobile communication network after the eSIM module is disassembled and inserted into another device, thereby improving security when the eSIM module accesses the mobile communication network.

According to a first aspect, this application provides an eSIM authentication method, applied to an eSIM module. The method includes: The eSIM module stores a first device identity sent by a first processing module; the eSIM module receives, after detecting that the eSIM module is powered off and then powered on, device check information sent by a second processing module; the eSIM module decrypts a second device identity from the device check information; and if the first device identity is the same as the second device identity, the eSIM module normally performs a mobile communication service; or if the first device identity is different from the second device identity, or the eSIM module does not receive, after detecting that the eSIM module is powered off and then powered on, the device check information sent by the second processing module, the eSIM module is forbidden from performing a mobile communication service.

According to the eSIM authentication method provided in this embodiment of this application, the first processing module and the eSIM module in the electronic device may first agree on a shared secret key. Then, the first processing module encrypts a device identity by using the shared secret key, generates device binding information, and sends the device binding information to the eSIM module. The eSIM module may decrypt the first device identity from the device binding information by using the shared secret key, and store the first device identity. When the eSIM module is powered on again or before the eSIM module needs to perform the mobile communication service, the eSIM module may enable the second processing module that communicates with the eSIM module in this case to obtain the second device identity, and encrypt the second device identity by using the shared secret key, to generate the device check information. The eSIM module may decrypt the second device identity from the device check information by using the shared secret key. If the second device identity is the same as the first device identity stored in the eSIM module, it indicates that the second processing module and the first processing module that is bound to the eSIM module are a same processing module. Therefore, the eSIM module may normally perform the mobile communication service. If the second device identity is different from the first device identity stored in the eSIM module, or the eSIM module does not receive, after detecting that the eSIM module is powered off and then powered on, the device check information sent by the second processing module, it indicates that the second processing module and the first processing module that is bound to the eSIM module are not a same processing module. Therefore, the eSIM module may be forbidden from performing the mobile communication service. In this way, the eSIM module in the electronic device can be prevented from accessing a mobile communication network after the eSIM module is disassembled and inserted into another device, thereby improving security when the eSIM module accesses the mobile communication network.

In a possible implementation, before the eSIM module stores the first device identity sent by the first processing module, the method further includes: The eSIM module receives the device binding information sent by the first processing module; and the eSIM module decrypts the first device identity from the device binding information after receiving the device binding information, and stores the first device identity.

In a possible implementation, that the eSIM module decrypts the first device identity from the device binding information after receiving the device binding information specifically includes: After receiving the device binding information, the eSIM module decrypts the first device identity from the device binding information by using the shared secret key generated by the eSIM module.

In a possible implementation, that the eSIM module decrypts the second device identity from the device check information after receiving the device check information specifically includes: After receiving the device check information, the eSIM module decrypts the second device identity from the check information by using the shared secret key generated by the eSIM module.

In a possible implementation, before the eSIM module stores the first device identity sent by the first processing module, the method further includes: The eSIM module generates an eUICC temporary working public key and an eUICC temporary working private key; the eSIM module receives a TEE temporary working public key generated by the first processing module; and the eSIM module generates the shared secret key based on the eUICC temporary working private key and the TEE temporary working public key.

In a possible implementation, before the eSIM module receives the TEE temporary working public key sent by the first processing module, the method further includes: The eSIM module receives TEE signature data sent by the first processing module; and the eSIM module verifies validity of the TEE signature data by using a TEE public key. That the eSIM module receives the TEE temporary working public key sent by the first processing module specifically includes: After verification on the validity of the TEE signature data succeeds, the eSIM module obtains the TEE temporary working public key from the TEE signature data.

In a possible implementation, before the eSIM module receives the TEE signature data sent by the first processing module, the method further includes: The eSIM module verifies validity of the TEE certificate; and after verification on the validity of the TEE certificate succeeds, the eSIM module obtains the TEE public key from the TEE certificate.

In a possible implementation, the TEE certificate includes a terminal certificate, the TEE public key is an OEM public key in the terminal certificate, and that the eSIM module verifies the validity of the TEE certificate specifically includes: The eSIM module verifies the validity of the terminal certificate by using the OEM public key in the terminal certificate.

In a possible implementation, the TEE certificate includes a device certificate and a terminal certificate, and the TEE public key is an OEM public key in the terminal certificate; and before the eSIM module verifies the validity of the TEE certificate, the method further includes: The eSIM module receives the TEE certificate sent by the first processing module. That the eSIM module verifies the validity of the TEE certificate specifically includes: The eSIM module verifies validity of the device certificate by using a terminal vendor root public key in a terminal vendor root certificate; and after verification on the validity of the device certificate succeeds, the eSIM module verifies validity of the terminal certificate by using a device public key in the device certificate, where if both the validity of the device certificate and the validity of the terminal certificate succeeds, the validity of the TEE certificate succeeds.

In a possible implementation, the TEE certificate is a terminal vendor root certificate, and the terminal vendor root certificate is preset in the eSIM module; and that the eSIM module verifies the validity of the TEE certificate specifically includes: The eSIM module verifies validity of the terminal vendor root certificate by using a terminal vendor root public key in the terminal vendor root certificate.

In a possible implementation, the method further includes: The eSIM module generates the eUICC temporary working private key and the eUICC temporary working public key, where the eUICC temporary working private key and the eUICC temporary working public key are a pair of public and private keys; the eSIM module signs the eUICC temporary working public key by using an eUICC private key, to obtain eUICC signature data; and the eSIM module sends the eUICC signature data to the first processing module, where the eUICC signature data is used by the first processing module to obtain the eUICC temporary working public key and generate the shared secret key based on the eUICC temporary working public key and a TEE temporary working private key, and the TEE temporary working private key and the TEE temporary working public key are a pair of public and private keys.

In a possible implementation, the method further includes: The eSIM module sends an EUM certificate and an eUICC certificate to the first processing module, where the eUICC certificate is signed by using an EUM private key paired with an EUM public key in the EUM certificate, the EUM certificate includes an eUICC public key, the eUICC public key and the eUICC private key are a pair of public and private keys, and the eUICC public key is used by the first processing module to verify validity of the eUICC signature data.

In a possible implementation, the first device identity is a chip identity of the first processing module, and the second device identity is a chip identity of the second processing module; or the first device identity is an international mobile equipment identity IMEI of the first processing module, and the second device identity is an IMEI of the second processing module; or the first device identity is a chip identity of the first processing module and an IMEI of the first processing module, and the second device identity is a chip identity of the second processing module and an IMEI of the second processing module.

In a possible implementation, that the eSIM module receives, after detecting that the eSIM module is powered off and then powered on, the device check information sent by the second processing module specifically includes: After detecting that the eSIM module is powered off and then powered on, the eSIM module sends a first request to the second processing module, where the first request is used to request the second processing module to send a device identity to the eSIM module.

In a possible implementation, the first request includes a first eUICC random number, and the first eUICC random number is encrypted into the device check information together with the second device identity by the second processing module.

In a possible implementation, the method further includes: The eSIM module decrypts a second eUICC random number from the device check information; and the eSIM module normally performs the mobile communication service if the first device identity is the same as the second device identity includes: If the first device identity is the same as the second device identity and the second eUICC random number is the same as the first eUICC random number, the eSIM module normally performs the mobile communication service.

In a possible implementation, the first request is a get input command.

In a possible implementation, that the eSIM module receives the device binding information sent by the first processing module specifically includes: The eSIM module receives the device binding information sent by the first processing module by using a store command.

According to a second aspect, this application provides an eSIM authentication method, applied to an electronic device including an eSIM module and a second processing module. The method includes: The eSIM module stores a first device identity sent by a first processing module; after detecting that the eSIM module is powered off and then powered on, the eSIM module sends a first request to the second processing module, where the first request is used to request the second processing module to send a device identity to the eSIM module; the second processing module obtains a second device identity; the second processing module encrypts the second device identity to obtain device check information; the second processing module sends the device check information to the eSIM module; the eSIM module decrypts the second device identity from the device check information; and if the first device identity is the same as the second device identity, the eSIM module normally performs a mobile communication service; or if the first device identity is different from the second device identity, or the eSIM module does not receive, after detecting that the eSIM module is powered off and then powered on, the device check information sent by the second processing module, the eSIM module is forbidden from performing a mobile communication service.

According to the eSIM authentication method provided in this embodiment of this application, the first processing module and the eSIM module in the electronic device may first agree on a shared secret key. Then, the first processing module encrypts a device identity by using the shared secret key, generates device binding information, and sends the device binding information to the eSIM module. The eSIM module may decrypt the first device identity from the device binding information by using the shared secret key, and store the first device identity. When the eSIM module is powered on again or before the eSIM module needs to perform the mobile communication service, the eSIM module may enable the second processing module that communicates with the eSIM module in this case to obtain the second device identity, and encrypt the second device identity by using the shared secret key, to generate the device check information. The eSIM module may decrypt the second device identity from the device check information by using the shared secret key. If the second device identity is the same as the first device identity stored in the eSIM module, it indicates that the second processing module and the first processing module that is bound to the eSIM module are a same processing module. Therefore, the eSIM module may normally perform the mobile communication service. If the second device identity is different from the first device identity stored in the eSIM module, or the eSIM module does not receive, after detecting that the eSIM module is powered off and then powered on, the device check information sent by the second processing module, it indicates that the second processing module and the first processing module that is bound to the eSIM module are not a same processing module. Therefore, the eSIM module may be forbidden from performing the mobile communication service. In this way, the eSIM module in the electronic device can be prevented from accessing a mobile communication network after the eSIM module is disassembled and inserted into another device, thereby improving security when the eSIM module accesses the mobile communication network.

In a possible implementation, before the eSIM module stores the first device identity sent by the first processing module, the method further includes: The eSIM module receives the device binding information sent by the first processing module; and the eSIM module decrypts the first device identity from the device binding information after receiving the device binding information, and stores the first device identity.

In a possible implementation, that the eSIM module decrypts the first device identity from the device binding information after receiving the device binding information specifically includes: After receiving the device binding information, the eSIM module decrypts the first device identity from the device binding information by using the shared secret key.

In a possible implementation, that the eSIM module decrypts the second device identity from the check information after receiving the device check information specifically includes: After receiving the device check information, the eSIM module decrypts the second device identity from the check information by using the shared secret key.

In a possible implementation, before the eSIM module stores the first device identity sent by the first processing module, the method further includes: The eSIM module generates an eUICC temporary working public key and an eUICC temporary working private key; the eSIM module receives a TEE temporary working public key generated by the first processing module; and the eSIM module generates the shared secret key based on the eUICC temporary working private key and the TEE temporary working public key.

In a possible implementation, before the eSIM module receives the TEE temporary working public key sent by the first processing module, the method further includes: The eSIM module receives TEE signature data sent by the first processing module; and the eSIM module verifies validity of the TEE signature data by using a TEE public key. That the eSIM module receives the TEE temporary working public key sent by the first processing module specifically includes: After verification on the validity of the TEE signature data succeeds, the eSIM module obtains the TEE temporary working public key from the TEE signature data.

In a possible implementation, before the eSIM module receives the TEE signature data sent by the first processing module, the method further includes: The eSIM module verifies validity of the TEE certificate; and after verification on the validity of the TEE certificate succeeds, the eSIM module obtains the TEE public key from the TEE certificate.

In a possible implementation, the TEE certificate includes a terminal certificate, the TEE public key is an OEM public key in the terminal certificate, and that the eSIM module verifies the validity of the TEE certificate specifically includes: The eSIM module verifies the validity of the terminal certificate by using the OEM public key in the terminal certificate.

In a possible implementation, the TEE certificate includes a terminal certificate, the TEE public key is an OEM public key in the terminal certificate, and that the eSIM module verifies the validity of the TEE certificate specifically includes: The eSIM module verifies the validity of the terminal certificate by using the OEM public key in the terminal certificate.

In a possible implementation, the TEE certificate includes a device certificate and a terminal certificate, and the TEE public key is an OEM public key in the terminal certificate; and before the eSIM module verifies the validity of the TEE certificate, the method further includes: The eSIM module receives the TEE certificate sent by the first processing module. That the eSIM module verifies the validity of the TEE certificate specifically includes: The eSIM module verifies validity of the device certificate by using a terminal vendor root public key in a terminal vendor root certificate; and after verification on the validity of the device certificate succeeds, the eSIM module verifies validity of the terminal certificate by using a device public key in the device certificate, where if both the validity of the device certificate and the validity of the terminal certificate succeeds, the validity of the TEE certificate succeeds.

In a possible implementation, the TEE certificate is a terminal vendor root certificate, and the terminal vendor root certificate is preset in the eSIM module; and that the eSIM module verifies the validity of the TEE certificate specifically includes: The eSIM module verifies validity of the terminal vendor root certificate by using a terminal vendor root public key in the terminal vendor root certificate.

In a possible implementation, the method further includes: The eSIM module generates the eUICC temporary working private key and the eUICC temporary working public key, where the eUICC temporary working private key and the eUICC temporary working public key are a pair of public and private keys; the eSIM module signs the eUICC temporary working public key by using an eUICC private key, to obtain eUICC signature data; and the eSIM module sends the eUICC signature data to the first processing module, where the eUICC signature data is used by the first processing module to obtain the eUICC temporary working public key and generate the shared secret key based on the eUICC temporary working public key and a TEE temporary working private key, and the TEE temporary working private key and the TEE temporary working public key are a pair of public and private keys.

In a possible implementation, the method further includes: The eSIM module sends an EUM certificate and an eUICC certificate to the first processing module, where the eUICC certificate is signed by using an EUM private key paired with an EUM public key in the EUM certificate, the EUM certificate includes an eUICC public key, the eUICC public key and the eUICC private key are a pair of public and private keys, and the eUICC public key is used by the first processing module to verify validity of the eUICC signature data.

In a possible implementation, the first device identity is a chip identity of the first processing module, and the second device identity is a chip identity of the second processing module; or the first device identity is an international mobile equipment identity IMEI of the first processing module, and the second device identity is an IMEI of the second processing module; or the first device identity is a chip identity of the first processing module and an IMEI of the first processing module, and the second device identity is a chip identity of the second processing module and an IMEI of the second processing module.

In a possible implementation, the first request includes a first eUICC random number; and that the second processing module encrypts the second device identity to obtain the device check information specifically includes: The second processing module encrypts the first eUICC random number and the second device identity to obtain the device check information.

In a possible implementation, the method further includes: The eSIM module decrypts a second eUICC random number from the device check information; and the eSIM module normally performs the mobile communication service if the first device identity is the same as the second device identity includes: If the first device identity is the same as the second device identity and the second eUICC random number is the same as the first eUICC random number, the eSIM module normally performs the mobile communication service.

In a possible implementation, the first request is a get input command.

In a possible implementation, that the eSIM module receives the device binding information sent by the first processing module specifically includes: The eSIM module receives the device binding information sent by the first processing module by using a store data command.

According to a third aspect, this application provides an eSIM authentication method, applied to a processing module. The method includes: A TEE of the processing module stores a first eSIM identity sent by a first eSIM module; after a second eSIM module is powered off and then powered on, the processing module receives eSIM check information sent by the second eSIM module; the processing module decrypts a second eSIM identity from the eSIM check information; and if the second eSIM identity is the same as the first eSIM identity, the processing module normally uses the second eSIM module to perform a mobile communication service; or if the second eSIM identity is different from the first eSIM identity or the processing module does not receive, after the second eSIM module is powered off and then powered on, the eSIM check information sent by the second eSIM module, the processing module is forbidden from using the second eSIM module to perform a mobile communication service.

According to the eSIM authentication method provided in this embodiment of this application, the processing module and the first eSIM module in an electronic device may first agree on a shared key. Then, the first eSIM module encrypts an eSIM identity by using the shared secret key, generates eSIM binding information, and sends the eSIM binding information to the processing module. The processing module may decrypt the first eSIM identity from the eSIM binding information by using the shared secret key, and store the first eSIM identity. When the eSIM module is powered on again or before the eSIM module needs to perform the mobile communication service, the processing module may enable the second eSIM module that communicates with the processing module in this case to obtain the second eSIM identity, and encrypt the second eSIM identity by using the shared secret key, to generate the eSIM check information. The processing module may decrypt the second eSIM identity from the eSIM check information by using the shared secret key. If the second eSIM identity is the same as the first eSIM identity stored in the TEE of the processing module, it indicates that the second eSIM module and the first eSIM module that is bound to the processing module are a same eSIM module. Therefore, the processing module may normally perform the mobile communication service. If the second eSIM identity is different from the first eSIM identity stored in the TEE of the processing module, or the processing module does not receive, after the second eSIM module is powered off and then powered on, the device check information sent by the second processing module, it indicates that the second eSIM module and the first eSIM module that is bound to the processing module are not a same eSIM module. Therefore, the processing module may be forbidden from using the second eSIM to perform the mobile communication service. In this way, an eSIM module obtained by disassembling the eSIM module in the electronic device or in another way may be prevented from being inserted into a current device to access a mobile communication network, thereby improving security when the current device includes the eSIM module to access the mobile communication network.

In a possible implementation, before the TEE of the processing module stores the first eSIM identity sent by the first eSIM module, the method further includes: The processing module receives the eSIM binding information sent by the first eSIM module; and the processing module decrypts the first eSIM identity from the eSIM binding information after receiving the eSIM binding information, and stores the first eSIM identity in the TEE.

In a possible implementation, that the processing module decrypts the first eSIM identity from the eSIM binding information after receiving the eSIM binding information specifically includes: After receiving the eSIM binding information, the processing module decrypts the first eSIM identity from the eSIM binding information by using the shared secret key generated in the TEE in the processing module.

In a possible implementation, that the processing module decrypts the second eSIM identity from the eSIM check information after receiving the eSIM check information specifically includes: After receiving the eSIM check information, the processing module decrypts the second device identity from the check information by using the shared secret key generated in the TEE.

In a possible implementation, before the processing module stores the first eSIM identity sent by the first eSIM module, the method further includes: The processing module generates a TEE temporary working public key and a TEE temporary working private key by using the TEE; the processing module receives an eUICC temporary working public key sent by the first processing module; and the processing module generates the shared secret key based on the TEE temporary working private key and the eUICC temporary working public key.

In a possible implementation, before the processing module receives the eUICC temporary working public key sent by the first eSIM module, the method further includes: The processing module receives TEE signature data sent by the first processing module.

The processing module verifies validity of the eUICC signature data by using an eUICC public key in an eUICC certificate. That the processing module receives the eUICC temporary working public key sent by the first eSIM module specifically includes: After verification on the validity of the eUICC signature data succeeds, the processing module obtains the eUICC temporary working public key from the eUICC signature data.

In a possible implementation, before the processing module receives the eUICC signature data sent by the first eSIM module, the method further includes: The processing module receives an EUM certificate and the eUICC certificate that are sent by the first eSIM module; the processing module verifies validity of the EUM certificate by using an authentication root public key in an authentication root certificate; after verification on the validity of the EUM certificate succeeds, the processing module verifies validity of the eUICC certificate by using an EUM public key in the EUM certificate; and after verification on the validity of the eUICC certificate succeeds, the processing module obtains the eUICC public key from the eUICC certificate.

In a possible implementation, the method further includes: The processing module generates the TEE temporary working private key and the TEE temporary working public key in the TEE, where the TEE temporary working private key and the TEE temporary working public key are a pair of public and private keys; the processing module signs the TEE temporary working public key by using a TEE private key, to obtain TEE signature data; and the processing module sends the TEE signature data to the first eSIM module, where the TEE signature data is used by the first eSIM module to obtain the TEE temporary working public key and generate the shared secret key based on the TEE temporary working public key and an eUICC temporary working private key, and the eUICC temporary working private key and the eUICC temporary working public key are a pair of public and private keys.

In a possible implementation, before the processing module receives the eSIM check information sent by the second eSIM module, the method further includes: After detecting that the second eSIM module is powered off and then powered on, the processing module sends a first device random number to the second eSIM module, where the first device random number is encrypted into the eSIM check information together with the second eSIM identity by the second eSIM module.

In a possible implementation, the method further includes: The processing module decrypts a second device random number from the eSIM check information. That the processing module normally uses the second eSIM module to perform the mobile communication service if the second eSIM identity is the same as the first eSIM identity specifically includes: If the second eSIM identity is the same as the first eSIM identity and the second device random number is the same as the first device random number, the processing module normally uses the second eSIM module to perform the mobile communication service.

According to a fourth aspect, this application provides an eSIM authentication method, applied to an electronic device including a processing module and a second eSIM module. The method includes: A TEE of the processing module stores a first eSIM identity sent by a first eSIM module; the second eSIM module obtains a second eSIM identity of the second eSIM module after the second eSIM module is powered off and then powered on; the second eSIM module encrypts the second eSIM identity to obtain eSIM check information; the second eSIM module sends eSIM check information to the processing module; the processing module decrypts a second eSIM identity from the eSIM check information; and if the second eSIM identity is the same as the first eSIM identity, the processing module normally uses the second eSIM module to perform a mobile communication service; or if the second eSIM identity is different from the first eSIM identity, or the processing module does not receive, after the second eSIM module is powered off and then powered on, the device check information sent by the second processing module, the processing module is forbidden from using the second eSIM module to perform a mobile communication service.

According to the eSIM authentication method provided in this embodiment of this application, the processing module and the first eSIM module in an electronic device may first agree on a shared key. Then, the first eSIM module encrypts an eSIM identity by using the shared secret key, generates eSIM binding information, and sends the eSIM binding information to the processing module. The processing module may decrypt the first eSIM identity from the eSIM binding information by using the shared secret key, and store the first eSIM identity. When the eSIM module is powered on again or before the eSIM module needs to perform the mobile communication service, the processing module may enable the second eSIM module that communicates with the processing module in this case to obtain the second eSIM identity, and encrypt the second eSIM identity by using the shared secret key, to generate the eSIM check information. The processing module may decrypt the second eSIM identity from the eSIM check information by using the shared secret key. If the second eSIM identity is the same as the first eSIM identity stored in the TEE of the processing module, it indicates that the second eSIM module and the first eSIM module that is bound to the processing module are a same eSIM module. Therefore, the processing module may normally perform the mobile communication service. If the second eSIM identity is different from the first eSIM identity stored in the TEE of the processing module, it indicates that the second eSIM module and the first eSIM module that is bound to the processing module are not a same eSIM module. Therefore, the processing module may be forbidden from using the second eSIM to perform the mobile communication service. In this way, an eSIM module obtained by disassembling the eSIM module in the electronic device or in another way may be prevented from being inserted into a current device to access a mobile communication network, thereby improving security when the current device includes the eSIM module to access the mobile communication network.

In a possible implementation, before the TEE of the processing module stores the first eSIM identity sent by the first eSIM module, the method further includes: The processing module receives the eSIM binding information sent by the first eSIM module; and the processing module decrypts the first eSIM identity from the eSIM binding information after receiving the eSIM binding information, and stores the first eSIM identity in the TEE.

In a possible implementation, that the processing module decrypts the first eSIM identity from the eSIM binding information after receiving the eSIM binding information specifically includes: After receiving the eSIM binding information, the processing module decrypts the first eSIM identity from the eSIM binding information by using the shared secret key generated in the TEE in the processing module.

In a possible implementation, that the processing module decrypts the second eSIM identity from the eSIM check information after receiving the eSIM check information specifically includes: After receiving the eSIM check information, the processing module decrypts the second device identity from the check information by using the shared secret key generated in the TEE.

In a possible implementation, before the processing module stores the first eSIM identity sent by the first eSIM module, the method further includes: The processing module generates a TEE temporary working public key and a TEE temporary working private key by using the TEE; the processing module receives an eUICC temporary working public key sent by the first processing module; and the processing module generates the shared secret key based on the TEE temporary working private key and the eUICC temporary working public key.

In a possible implementation, before the processing module receives the eUICC temporary working public key sent by the first eSIM module, the method further includes: The processing module receives TEE signature data sent by the first processing module. The processing module verifies validity of the eUICC signature data by using an eUICC public key in an eUICC certificate. That the processing module receives the eUICC temporary working public key sent by the first eSIM module specifically includes: After verification on the validity of the eUICC signature data succeeds, the processing module obtains the eUICC temporary working public key from the eUICC signature data.

In a possible implementation, before the processing module receives the eUICC signature data sent by the first eSIM module, the method further includes: The processing module receives an EUM certificate and the eUICC certificate that are sent by the first eSIM module; the processing module verifies validity of the EUM certificate by using an authentication root public key in an authentication root certificate; after verification on the validity of the EUM certificate succeeds, the processing module verifies validity of the eUICC certificate by using an EUM public key in the EUM certificate; and after verification on the validity of the eUICC certificate succeeds, the processing module obtains the eUICC public key from the eUICC certificate.

In a possible implementation, the method further includes: The processing module generates the TEE temporary working private key and the TEE temporary working public key in the TEE, where the TEE temporary working private key and the TEE temporary working public key are a pair of public and private keys; the processing module signs the TEE temporary working public key by using a TEE private key, to obtain TEE signature data; and the processing module sends the TEE signature data to the first eSIM module, where the TEE signature data is used by the first eSIM module to obtain the TEE temporary working public key and generate the shared secret key based on the TEE temporary working public key and an eUICC temporary working private key, and the eUICC temporary working private key and the eUICC temporary working public key are a pair of public and private keys.

In a possible implementation, before the processing module receives the eSIM check information sent by the second eSIM module, the method further includes: After detecting that the second eSIM module is powered off and then powered on, the processing module sends a first device random number to the second eSIM module, where the first device random number is encrypted into the eSIM check information together with the second eSIM identity by the second eSIM module.

In a possible implementation, the method further includes: The processing module decrypts a second device random number from the eSIM check information. That the processing module normally uses the second eSIM module to perform the mobile communication service if the second eSIM identity is the same as the first eSIM identity specifically includes: If the second eSIM identity is the same as the first eSIM identity and the second device random number is the same as the first device random number, the processing module normally uses the second eSIM module to perform the mobile communication service.

According to a fifth aspect, this application provides an eSIM authentication method, applied to an electronic device including a second processing module and a second eSIM module. The method includes: A TEE of the second processing module stores a first eSIM identity sent by a first eSIM module; the second eSIM module stores a first device identity sent by a first processing module; the second eSIM module obtains a second eSIM identity of the second eSIM module after the second eSIM module is powered off and then powered on; the second eSIM module encrypts the second eSIM identity to obtain eSIM check information; the second eSIM module sends the eSIM check information to the second processing module; the second processing module obtains the second device identity, encrypts the second device identity to obtain device check information, and sends the device check information to the second eSIM module; the second processing module decrypts the second eSIM identity from the eSIM check information; the second eSIM module decrypts the second device identity from the device check information; and if the second eSIM identity is the same as the first eSIM identity and the second device identity is the same as the first device identity, the electronic device normally uses the second eSIM module to perform a mobile communication service; or if the second eSIM identity is different from the first eSIM identity, or the second device identity is different from the first device identity, or the second processing module does not receive, after the second eSIM module is powered off and then powered on, the eSIM check information sent by the second eSIM module, or the second eSIM module does not receive, after the second eSIM module is powered off and then powered on, the device check information sent by the second processing module, the electronic device is forbidden from using the second eSIM module to perform a mobile communication service.

According to the eSIM authentication method provided in this embodiment of this application, the second processing module is validly bound to the first eSIM module. Therefore, the TEE of the second processing module stores the first eSIM identity of the first eSIM module and a shared secret key that is agreed-on with the first eSIM module. The second eSIM module is validly bound to the first processing module. Therefore, the second eSIM module stores the first device identity of the first processing module and a shared secret key that is agreed-on with the first processing module. When the second processing module works in cooperation with the second eSIM module, before the second eSIM module is powered on or if the second eSIM module needs to perform the mobile communication service, the second processing module may obtain the second device identity of the second processing module, encrypt the second device identity into the device check information by using the shared secret key, and send the device check information to the second eSIM module. The second eSIM module may also obtain the second eSIM identity of the second eSIM module, encrypt the second eSIM identity into the eSIM check information by using the shared secret key, and send the eSIM check information to the second processing module. The second processing module may decrypt the second eSIM identity from the eSIM check information by using the shared secret key, and the second eSIM module may decrypt the second device identity from the device check information by using the shared secret key. If the second eSIM identity is the same as the first eSIM identity stored in the TEE of the processing module, and the second device identity is the same as the first device identity, it indicates that the second eSIM module and the second processing module are bound to each other. Therefore, the second processing module may normally use the second eSIM module to perform the mobile communication service. If the second eSIM identity is different from the first eSIM identity stored in the TEE of the processing module, or the second device identity is different from the first device identity, or the second processing module does not receive the eSIM check information after the second eSIM module is powered off and then powered on, or the second eSIM module does not receive the device check information after the second eSIM module is powered off and then powered on, it indicates that the second eSIM module and the second processing module are not bound to each other. Therefore, the second processing module may be forbidden from using the second eSIM to perform the mobile communication service. In this way, the eSIM module in the electronic device can be prevented from accessing a mobile communication network after the eSIM module is disassembled and inserted into another device, thereby improving security when the eSIM module accesses the mobile communication network.

In a possible implementation, before the second eSIM module stores the first device identity sent by the first processing module, the method further includes: The second eSIM module receives the device binding information sent by the first processing module; and the second eSIM module decrypts the first device identity from the device binding information after receiving the device binding information, and stores the first device identity.

In a possible implementation, that the second eSIM module decrypts the first device identity from the device binding information after receiving the device binding information specifically includes: After receiving the device binding information, the second eSIM module decrypts the first device identity from the device binding information by using the shared secret key generated by the second eSIM module.

In a possible implementation, that the second eSIM module decrypts the second device identity from the device check information after receiving the device check information specifically includes: After receiving the device check information, the second eSIM module decrypts the second device identity from the check information by using the shared secret key generated by the second eSIM module.

In a possible implementation, before the second eSIM module stores the first device identity sent by the first processing module, the method further includes: The second eSIM module generates an eUICC temporary working public key and an eUICC temporary working private key; the second eSIM module receives a TEE temporary working public key generated by the first processing module; and the second eSIM module generates the shared secret key based on the eUICC temporary working private key and the TEE temporary working public key.

In a possible implementation, before the second eSIM module receives the TEE temporary working public key sent by the first processing module, the method further includes: The second eSIM module receives TEE signature data sent by the first processing module; and the second eSIM module verifies validity of the TEE signature data by using a TEE public key. That the second eSIM module receives the TEE temporary working public key sent by the first processing module specifically includes: After verification on the validity of the TEE signature data succeeds, the second eSIM module obtains the TEE temporary working public key from the TEE signature data.

In a possible implementation, before the second eSIM module receives the TEE signature data sent by the first processing module, the method further includes: The second eSIM module verifies validity of the TEE certificate; and after verification on the validity of the TEE certificate succeeds, the second eSIM module obtains the TEE public key from the TEE certificate.

In a possible implementation, the TEE certificate includes a terminal certificate, the TEE public key is an OEM public key in the terminal certificate, and that the second eSIM module verifies the validity of the TEE certificate specifically includes: The second eSIM module verifies the validity of the terminal certificate by using the OEM public key in the terminal certificate.

In a possible implementation, the TEE certificate includes a device certificate and a terminal certificate, and the TEE public key is an OEM public key in the terminal certificate; and before the eSIM module verifies the validity of the TEE certificate, the method further includes: The second eSIM module receives the TEE certificate sent by the first processing module. That the second eSIM module verifies the validity of the TEE certificate specifically includes: The second eSIM module verifies validity of the device certificate by using a terminal vendor root public key in a terminal vendor root certificate; and after verification on the validity of the device certificate succeeds, the second eSIM module verifies validity of the terminal certificate by using a device public key in the device certificate, where if both the validity of the device certificate and the validity of the terminal certificate succeeds, the validity of the TEE certificate succeeds.

In a possible implementation, the TEE certificate is a terminal vendor root certificate, and the terminal vendor root certificate is preset in the second eSIM module; and that the second eSIM module verifies the validity of the TEE certificate specifically includes: The second eSIM module verifies validity of the terminal vendor root certificate by using a terminal vendor root public key in the terminal vendor root certificate.

In a possible implementation, the method further includes: The second eSIM module generates the eUICC temporary working private key and the eUICC temporary working public key, where the eUICC temporary working private key and the eUICC temporary working public key are a pair of public and private keys; the second eSIM module signs the eUICC temporary working public key by using an eUICC private key, to obtain eUICC signature data; and the second eSIM module sends the eUICC signature data to the first processing module, where the eUICC signature data is used by the first processing module to obtain the eUICC temporary working public key and generate the shared secret key based on the eUICC temporary working public key and a TEE temporary working private key, and the TEE temporary working private key and the TEE temporary working public key are a pair of public and private keys.

In a possible implementation, the method further includes: The second eSIM module sends an EUM certificate and an eUICC certificate to the first processing module, where the eUICC certificate is signed by using an EUM private key paired with an EUM public key in the EUM certificate, the EUM certificate includes an eUICC public key, the eUICC public key and the eUICC private key are a pair of public and private keys, and the eUICC public key is used by the first processing module to verify validity of the eUICC signature data.

In a possible implementation, the first device identity is a chip identity of the first processing module, and the second device identity is a chip identity of the second processing module; or the first device identity is an international mobile equipment identity IMEI of the first processing module, and the second device identity is an IMEI of the second processing module; or the first device identity is a chip identity of the first processing module and an IMEI of the first processing module, and the second device identity is a chip identity of the second processing module and an IMEI of the second processing module.

In a possible implementation, before the TEE of the second processing module stores the first eSIM identity sent by the first eSIM module, the method further includes: The second processing module receives the eSIM binding information sent by the first eSIM module; and the second processing module decrypts the first eSIM identity from the eSIM binding information after receiving the eSIM binding information, and stores the first eSIM identity in the TEE.

In a possible implementation, that the second processing module decrypts the first eSIM identity from the eSIM binding information after receiving the eSIM binding information specifically includes: After receiving the eSIM binding information, the second processing module decrypts the first eSIM identity from the eSIM binding information by using the shared secret key generated in the TEE in the second processing module.

In a possible implementation, that the second processing module decrypts the second eSIM identity from the eSIM check information after receiving the eSIM check information specifically includes: After receiving the eSIM check information, the second processing module decrypts the second device identity from the check information by using the shared secret key generated in the TEE.

In a possible implementation, before the second processing module stores the first eSIM identity sent by the first eSIM module, the method further includes: The second processing module generates a TEE temporary working public key and a TEE temporary working private key by using the TEE; the second processing module receives the eUICC temporary working public key sent by the first processing module; and the second processing module generates the shared secret key based on the TEE temporary working private key and the eUICC temporary working public key.

In a possible implementation, before the second processing module receives the eUICC temporary working public key sent by the first eSIM module, the method further includes: The second processing module receives TEE signature data sent by the first processing module. The second processing module verifies validity of the eUICC signature data by using an eUICC public key in an eUICC certificate. That the second processing module receives the eUICC temporary working public key sent by the first eSIM module specifically includes: After verification on the validity of the eUICC signature data succeeds, the second processing module obtains the eUICC temporary working public key from the eUICC signature data.

In a possible implementation, before the second processing module receives the eUICC signature data sent by the first eSIM module, the method further includes: The second processing module receives an EUM certificate and the eUICC certificate that are sent by the first eSIM module; the second processing module verifies validity of the EUM certificate by using an authentication root public key in an authentication root certificate; after verification on the validity of the EUM certificate succeeds, the second processing module verifies validity of the eUICC certificate by using an EUM public key in the EUM certificate; and after verification on the validity of the eUICC certificate succeeds, the second processing module obtains the eUICC public key from the eUICC certificate.

In a possible implementation, the method further includes: The second processing module generates the TEE temporary working private key and the TEE temporary working public key in the TEE, where the TEE temporary working private key and the TEE temporary working public key are a pair of public and private keys; the second processing module signs the TEE temporary working public key by using a TEE private key, to obtain TEE signature data; and the second processing module sends the TEE signature data to the first eSIM module, where the TEE signature data is used by the first eSIM module to obtain the TEE temporary working public key and generate the shared secret key based on the TEE temporary working public key and an eUICC temporary working private key, and the eUICC temporary working private key and the eUICC temporary working public key are a pair of public and private keys.

In a possible implementation, the method further includes: after detecting that the second eSIM module is powered off and then powered on, the second processing module sends an eUICC random number obtaining command to the second processing module, where the eUICC random number obtaining command is used to request the second processing module to send an eUICC random number to the second processing module; after receiving the eUICC random number obtaining command, the second eSIM module generates a first eUICC random number, and sends the first eUICC random number to the second processing module; and the second processing module generates a first device random number. That the second processing module obtains the second device identity, and encrypts the second device identity to obtain the device check information specifically includes: The second processing module obtains the second device identity, and encrypts the second device identity, the first device random number, and the first eUICC random number to obtain the device check information.

In a possible implementation, the method further includes: After receiving the device check information, the second eSIM module decrypts a second eUICC random number and a third device random number from the device check information; and that the second eSIM module encrypts the second eSIM identity to obtain the eSIM check information specifically includes: The second eSIM module encrypts the second eSIM identity and the third device random number to obtain the eSIM check information.

In a possible implementation, the method further includes: The second processing module decrypts a second device random number from the eSIM check information. That the electronic device normally uses the second eSIM module to perform the mobile communication service if the second eSIM identity is the same as the first eSIM identity and the second device identity is the same as the first device identity specifically includes: If the second eSIM identity is the same as the first eSIM identity, the second device identity is the same as the first device identity, the second device random number is the same as the first device random number, and the second eUICC random number is the same as the first eUICC random number, the electronic device normally uses the second eSIM module to perform the mobile communication service.

According to a sixth aspect, this application provides an eSIM module, including a processing circuit, a storage circuit, and an interface circuit. The storage circuit is configured to store data and code instructions. The interface circuit is configured to send a command to a processing module through a modem or receive, through the modem, a command sent by the processing module. The processing circuit is configured to run the code instructions to perform the method in any one of the first aspect and the possible implementations of the first aspect.

According to a seventh aspect, this application provides a processing module, including a processing circuit, a storage circuit, and an interface circuit. The storage circuit is configured to store data and code instructions. The interface circuit is configured to send a command to an eSIM module through a modem or receive, through the modem, a command sent by the eSIM module. The processing circuit is configured to run the code instructions to perform the method in any one of the third aspect and the possible implementations of the third aspect.

According to an eighth aspect, this application provides an electronic device, including an eSIM module, a second processing module, and one or more memories. The one or more memories are coupled to the second processing module, the one or more memories are configured to store a computer program, and when the second processing module executes the computer program, the electronic device is enabled to perform the method in any one of the second aspect and the possible implementations of the second aspect.

According to a ninth aspect, this application provides an electronic device, including a second eSIM module, a processing module, and one or more memories. The one or more memories are coupled to the processing module, the one or more memories are configured to store a computer program, and when the processing module executes the computer program, the electronic device is enabled to perform the method in any one of the fourth aspect and the possible implementations of the fourth aspect.

According to a tenth aspect, this application provides an electronic device, including a second eSIM module, a second processing module, and one or more memories. The one or more memories are coupled to the second processing module, the one or more memories are configured to store a computer program, and when the second processing module executes the computer program, the electronic device is enabled to perform the method in any one of the fifth aspect and the possible implementations of the fifth aspect.

According to an eleventh aspect, an embodiment of this application provides a computer storage medium, including computer instructions. When the computer instructions are run on a processor of an electronic device, the electronic device is enabled to perform the method in any one of the possible implementations of the second aspect.

According to a twelfth aspect, an embodiment of this application provides a computer storage medium, including computer instructions. When the computer instructions are run on a processor of an electronic device, the electronic device is enabled to perform the method in any one of the fourth aspect and the possible implementations of the fourth aspect.

According to a thirteenth aspect, an embodiment of this application provides a computer storage medium, including computer instructions. When the computer instructions are run on a processor of an electronic device, the electronic device is enabled to perform the method in any one of the fifth aspect and the possible implementations of the fifth aspect.

For beneficial effect of the second aspect to the thirteenth aspect, refer to the beneficial effect of any one of the first aspect and the possible implementations of the first aspect. Details are not described herein again.

### BRIEF DESCRIPTION OF THE DRAWINGS

FIG. 1 is a diagram of a structure of an electronic device according to an embodiment of this application;

FIG. 2 is a diagram of a structure of a trusted execution environment of an electronic device according to an embodiment of this application;

FIG. 3A and FIG. 3B are a diagram of certificate chains in a TEE and an eSIM module of an electronic device according to an embodiment of this application;

FIG. 4 is a diagram of a certificate signing process according to an embodiment of this application;

FIG. 5A to FIG. 5C are a schematic flowchart of device-card binding in an eSIM authentication method according to an embodiment of this application;

FIG. 6 is a schematic flowchart of device-card verification in an eSIM authentication method according to an embodiment of this application;

FIG. 7A to FIG. 7E are a schematic flowchart of signaling interaction for device-card binding in an eSIM authentication method according to an embodiment of this application;

FIG. 8A is a diagram of an encryption process of a plain command data field in a store data command according to an embodiment of this application;

FIG. 8B is a diagram of an encryption process of a plain response data field in a response command according to an embodiment of this application;

FIG. 9A and FIG. 9B are a schematic flowchart of signaling interaction for device-card verification in an eSIM authentication method according to an embodiment of this application;

FIG. 10 is a diagram of a command format of a get input command according to an embodiment of this application;

FIG. 11 is a diagram of a structure of an execution environment of an electronic device according to an embodiment of this application;

FIG. 12A and FIG. 12B are a diagram of certificate chains in a TEE and an eSIM module of an electronic device according to an embodiment of this application;

FIG. 13 is a schematic flowchart of one-way device-card binding in an eSIM authentication method according to an embodiment of this application;

FIG. 14A and FIG. 14B are a schematic flowchart of two-way device-card binding in an eSIM authentication method according to an embodiment of this application;

FIG. 15A to FIG. 15C are a schematic flowchart of two-way device-card binding in an eSIM authentication method according to an embodiment of this application;

FIG. 16A to FIG. 16C are a schematic flowchart of two-way device-card verification in an eSIM authentication method according to an embodiment of this application;

FIG. 17A to FIG. 17C are a schematic flowchart of signaling interaction for one-way device-card binding in an eSIM authentication method according to an embodiment of this application;

FIG. 18A to FIG. 18C are a schematic flowchart of signaling interaction for two-way device-card binding in an eSIM authentication method according to an embodiment of this application;

FIG. 19A to FIG. 19E are a schematic flowchart of signaling interaction for two-way device-card binding in an eSIM authentication method according to another embodiment of this application; and

FIG. 20A to FIG. 20C are a schematic flowchart of two-way device-card verification in an eSIM authentication method according to an embodiment of this application.

### DETAILED DESCRIPTION OF ILLUSTRATIVE EMBODIMENTS

The technical solutions according to embodiments of this application are clearly and completely described in the following with reference to the accompanying drawings. In descriptions of embodiments of this application, unless otherwise specified, "/" indicates "or". For example, A/B may indicate A or B. The term "and/or" in this specification merely describes an association relationship between associated objects, and indicates that three relationships may exist. For example, A and/or B may indicate the following three cases: Only A exists, both A and B exist, and only B exists. In addition, in the descriptions of embodiments of this application, "a plurality of" means two or more.

In the following descriptions, terms such as "first" and "second" are merely used for description, and shall not be understood as an indication or implication of relative importance or implicit indication of a quantity of indicated technical features. Therefore, a feature limited by "first" or "second" may explicitly or implicitly include one or more of the features. In the descriptions of embodiments of this application, unless otherwise specified, "a plurality of" means two or more.

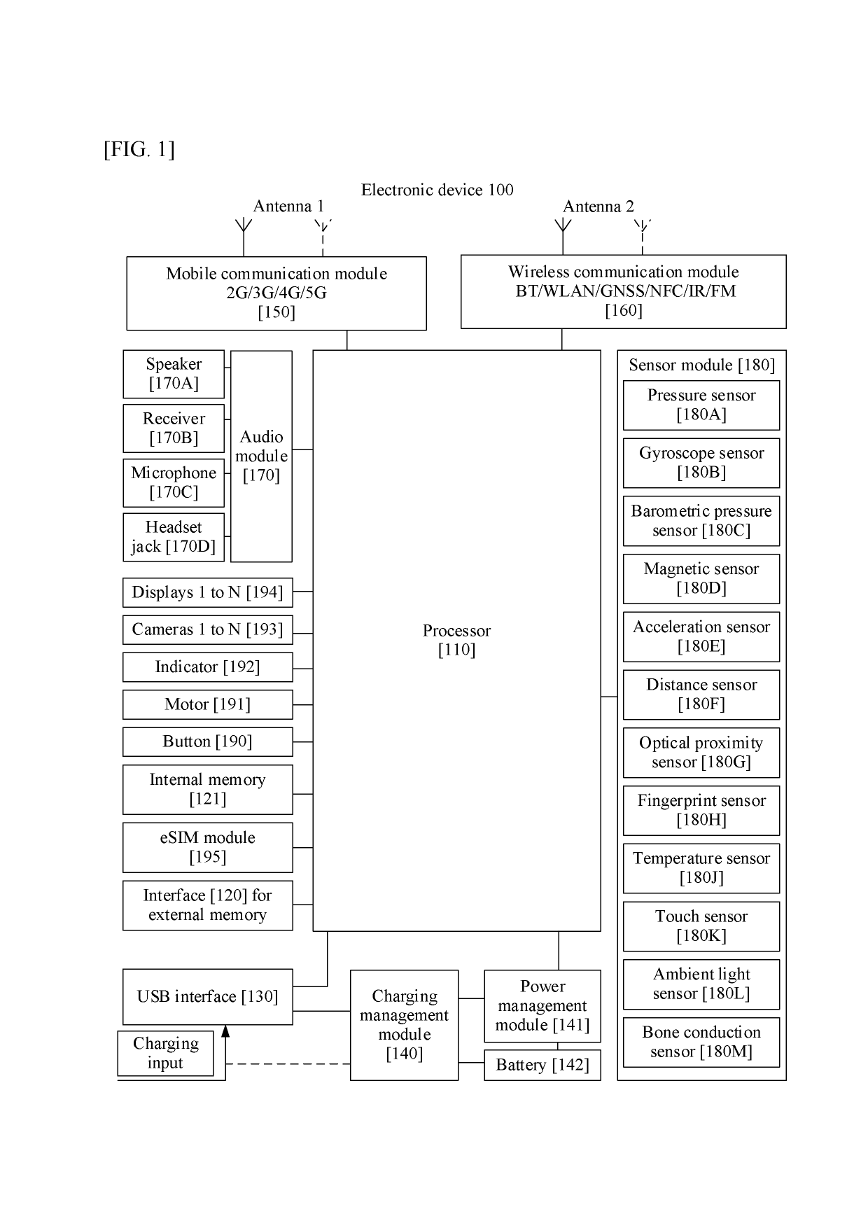

FIG. 1 is a diagram of a structure of an electronic device 100.

The following uses the electronic device 100 as an example to describe embodiments in detail. It should be understood that the electronic device 100 shown in FIG. 1 is merely an example, and the electronic device 100 may have more or fewer components than those shown in FIG. 1, or may combine two or more components, or may have different component configurations. Various components shown in the figure may be implemented in hardware including one or more signal processing and/or application-specific integrated circuits, software, or a combination of hardware and software.

The electronic device 100 may include a processor 110, an interface 120 for external memory, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, an embedded SIM (eSIM) module 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of the present invention does not constitute a specific limitation on the electronic device 100. In some other embodiments of this application, the electronic device 100 may include more or fewer components than those shown in the figure, or some components may be combined, or some components may be split, or different component arrangements may be used. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a memory, a video codec, a digital signal processor (DSP), a baseband processor, and/or a neural-network processing unit (NPU). Different processing units may be independent components, or may be integrated into one or more processors.

The controller may be a nerve center and a command center of the electronic device 100. The controller may generate an operation control signal based on an instruction operation code and a time sequence signal, to complete control of instruction reading and instruction execution.

A memory may be further disposed in the processor 110, and is configured to store instructions and data. In some embodiments, the memory in the processor 110 is a cache memory. The memory may store instructions or data that has been used or cyclically used by the processor 110. If the processor 110 needs to use the instructions or the data again, the processor may directly invoke the instructions or the data from the memory. This avoids repeated access, reduces waiting time of the processor 110, and improves system efficiency.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The I2C interface is a two-way synchronization serial bus, and includes one serial data line (SDA) and one serial clock line (SCL). In some embodiments, the processor 110 may include a plurality of groups of I2C buses. The processor 110 may be separately coupled to the touch sensor 180K, a charger, a flash, the camera 193, and the like through different I2C bus interfaces. For example, the processor 110 may be coupled to the touch sensor 180K through the I2C interface, so that the processor 110 communicates with the touch sensor 180K through the I2C bus interface, to implement a touch function of the electronic device 100.

The I2S interface may be used for audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transmit an audio signal to the wireless communication module 160 through the I2S interface, to implement a function of answering a call through a Bluetooth headset.

The PCM interface may also be used for audio communication, and sample, quantize, and code an analog signal. In some embodiments, the audio module 170 may be coupled to the wireless communication module 160 through a PCM bus interface. In some embodiments, the audio module 170 may alternatively transmit an audio signal to the wireless communication module 160 through the PCM interface, to implement a function of answering a call through a Bluetooth headset. Both the I2S interface and the PCM interface may be used for audio communication.

The UART interface is a universal serial data bus, and is used for asynchronous communication. The bus may be a two-way communication bus, and converts to-be-transmitted data between serial communication and parallel communication. In some embodiments, the UART interface is usually configured to connect the processor 110 to the wireless communication module 160. For example, the processor 110 communicates with a Bluetooth module in the wireless communication module 160 through the UART interface, to implement a Bluetooth function. In some embodiments, the audio module 170 may transmit an audio signal to the wireless communication module 160 through the UART interface, to implement a function of playing music through a Bluetooth headset.

The MIPI interface may be configured to connect the processor 110 to a peripheral device like the display 194 or the camera 193. The MIPI interface includes a camera serial interface (CSI), a display serial interface (DSI), and the like. In some embodiments, the processor 110 communicates with the camera 193 through the CSI interface, to implement a photographing function of the electronic device 100. The processor 110 communicates with the display 194 through the DSI interface, to implement a display function of the electronic device 100.

The GPIO interface may be configured by software. The GPIO interface may be configured for control signals or data signals. In some embodiments, the GPIO interface may be configured to connect the processor 110 to the camera 193, the display 194, the wireless communication module 160, the audio module 170, the sensor module 180, and the like. The GPIO interface may alternatively be configured as an I2C interface, an I2S interface, a UART interface, an MIPI interface, or the like.

The USB interface 130 is an interface that conforms to a USB standard specification, and may be specifically a mini USB interface, a micro USB interface, a USB type-C interface, or the like. The USB interface 130 may be connected to the charger to charge the electronic device 100, or may be configured to transmit data between the electronic device 100 and a peripheral device, or may be configured to connect to a headset to play audio through the headset. Alternatively, the interface may be configured to connect to another electronic device, for example, an AR device.

It may be understood that an interface connection relationship between the modules shown in this embodiment of the present invention is merely an example for description, and does not constitute a limitation on the structure of the electronic device 100. In some other embodiments of this application, the electronic device 100 may alternatively use an interface connection manner different from that in the foregoing embodiment, or use a combination of a plurality of interface connection manners.

The charging management module 140 is configured to receive a charging input from the charger. The charger may be a wireless charger or a wired charger. In some wired charging embodiments, the charging management module 140 may receive a charging input from a wired charger through the USB interface 130. In some wireless charging embodiments, the charging management module 140 may receive a wireless charging input through a wireless charging coil of the electronic device 100. The charging management module 140 supplies power to the electronic device through the power management module 141 while charging the battery 142.

The power management module 141 is configured to connect the battery 142, the charging management module 140, and the processor 110. The power management module 141 receives an input of the battery 142 and/or the charging management module 140, to supply power to the processor 110, the internal memory 121, an external memory, the display 194, the camera 193, the wireless communication module 160, and the like. The power management module 141 may further be configured to monitor parameters such as a battery capacity, a battery cycle count, and a battery health status (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the electronic device 100 may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the electronic device 100 may be configured to cover one or more communication frequency bands. Different antennas may be further reused to improve antenna utilization. For example, the antenna 1 may be reused as a diversity antenna of a wireless local area network. In some other embodiments, the antenna may be used in combination with a tuning switch.

The mobile communication module 150 may provide a wireless communication solution that is applied to the electronic device 100 and that includes 2G, 3G, 4G, 5G, and the like. The mobile communication module 150 may include at least one filter, a switch, a power amplifier, a low noise amplifier (LNA), and the like. The mobile communication module 150 may receive an electromagnetic wave through the antenna 1, perform processing such as filtering or amplification on the received electromagnetic wave, and transmit a processed electromagnetic wave to the modem processor for demodulation. The mobile communication module 150 may further amplify a signal modulated by the modem processor, and convert an amplified signal into an electromagnetic wave for radiation through the antenna 1. In some embodiments, at least some functional modules of the mobile communication module 150 may be disposed in the processor 110. In some embodiments, at least some functional modules of the mobile communication module 150 may be disposed in a same device as at least some modules of the processor 110.

The modem processor may include a modulator and a demodulator. The modulator is configured to modulate a to-be-sent low-frequency baseband signal into a medium or high-frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal through an audio device (which is not limited to the speaker 170A, the receiver 170B, or the like), or displays an image or a video through the display 194. In some embodiments, the modem processor may be an independent device. In some other embodiments, the modem processor may be independent of the processor 110, and is disposed in a same device as the mobile communication module 150 or another functional module.

The wireless communication module 160 may provide a wireless communication solution that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like and that is applied to the electronic device 100. The wireless communication module 160 may be one or more devices integrating at least one communication processing module. The wireless communication module 160 receives an electromagnetic wave through the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the signal, and convert a processed signal into an electromagnetic wave for radiation through the antenna 2.

In some embodiments, in the electronic device 100, the antenna 1 and the mobile communication module 150 are coupled, and the antenna 2 and the wireless communication module 160 are coupled, so that the electronic device 100 can communicate with a network and another device by using a wireless communication technology. The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, an IR technology, and/or the like. The GNSS may include a global positioning system (GPS), a global navigation satellite system (global navigation satellite system, GLONASS), a BeiDou navigation satellite system (BDS), a quasi-zenith satellite system (QZSS), and/or a satellite based augmentation system (SBAS).

The electronic device 100 may implement a display function through the GPU, the display 194, the application processor, and the like. The GPU is a microprocessor for image processing, and is connected to the display 194 and the application processor. The GPU is configured to: perform mathematical and geometric computation, and render an image. The processor 110 may include one or more GPUs that execute program instructions to generate or change display information.

The display 194 is configured to display an image, a video, and the like. The display 194 includes a display panel. The display panel may be a liquid crystal display (LCD). The display panel may alternatively be an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the electronic device 100 may include one or N displays 194, where N is a positive integer greater than 1.

The electronic device 100 may implement a photographing function through the ISP, the camera 193, the video codec, the GPU, the display 194, the application processor, and the like.

The ISP is configured to process data fed back by the camera 193. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, brightness, and the like of the image. The ISP may further optimize parameters such as exposure and a color temperature of a photographing scenario. In some embodiments, the ISP may be disposed in the camera 193.

The camera 193 is configured to capture a static image or a video. An optical image of an object is generated through the lens, and is projected onto the photosensitive element. The photosensitive element may be a charge-coupled device (CCD) or a complementary metal-oxide-semiconductor (CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the electronic device 100 may include one or N cameras 193, where N is a positive integer greater than 1.

The digital signal processor is configured to process a digital signal, and may process another digital signal in addition to the digital image signal. For example, when the electronic device 100 selects a frequency, the digital signal processor is configured to perform Fourier transformation on frequency energy.

The video codec is configured to compress or decompress a digital video. The electronic device 100 may support one or more video codecs. Therefore, the electronic device 100 may play or record videos in a plurality of coding formats, for example, moving picture experts group (MPEG)-1, MPEG-2, MPEG-3, and MPEG-4.

The NPU is a neural-network (NN) computing processor, quickly processes input information by referring to a structure of a biological neural network, for example, by referring to a mode of transmission between human brain neurons, and may further continuously perform self-learning. Applications such as intelligent cognition of the electronic device 100 may be implemented through the NPU, for example, image recognition, facial recognition, speech recognition, and text understanding.

The interface 120 for external memory may be used to connect to an external storage card, for example, a micro SD card, to extend a storage capability of the electronic device 100. The external storage card communicates with the processor 110 through the interface 120 for external memory, to implement a data storage function. For example, files such as music and videos are stored in the external storage card.

The internal memory 121 may be configured to store computer-executable program code. The executable program code includes instructions. The processor 110 runs the instructions stored in the internal memory 121, to perform various function applications of the electronic device 100 and data processing. The internal memory 121 may include a program storage area and a data storage area. The program storage area may store an operating system, an application required by at least one function (for example, a voice playing function or an image playing function), and the like. The data storage area may store data (for example, audio data, a phone book, and the like) created in a process of using the electronic device 100, and the like. In addition, the internal memory 121 may include a high-speed random access memory, and may further include a nonvolatile memory, for example, at least one magnetic disk storage device, a flash storage device, or a universal flash storage (UFS).

The electronic device 100 may implement an audio function, for example, music playing and recording, through the audio module 170, the speaker 170A, the receiver 170B, the microphone 170C, the headset jack 170D, the application processor, and the like. The pressure sensor 180A is configured to sense a pressure signal, and can convert the pressure signal into an electrical signal. In some embodiments, the pressure sensor 180A may be disposed on the display 194. The gyroscope sensor 180B may be configured to determine a motion posture of the electronic device 100. The barometric pressure sensor 180C is configured to measure barometric pressure. The magnetic sensor 180D includes a Hall effect sensor. The electronic device 100 may detect opening and closing of a flip cover through the magnetic sensor 180D. The acceleration sensor 180E may detect accelerations in various directions (usually on three axes) of the electronic device 100. The distance sensor 180F is configured to measure a distance. The optical proximity sensor 180G may include, for example, a light-emitting diode (LED) and an optical detector, for example, a photodiode. The ambient light sensor 180L is configured to sense ambient light brightness. The fingerprint sensor 180H is configured to collect a fingerprint. The temperature sensor 180J is configured to detect a temperature. The touch sensor 180K is also referred to as a "touch panel". The touch sensor 180K may be disposed on the display 194. The touch sensor 180K and the display 194 form a touchscreen, which is also referred to as a "touch screen". The touch sensor 180K is configured to detect a touch operation performed on or near the touch sensor. The touch sensor may transfer the detected touch operation to the application processor to determine a type of the touch event. A visual output related to the touch operation may be provided through the display 194. In some other embodiments, the touch sensor 180K may alternatively be disposed on a surface of the electronic device 100 at a location different from that of the display 194. The bone conduction sensor 180M may obtain a vibration signal. The button 190 includes a power button, a volume button, and the like. The motor 191 may generate a vibration prompt. The indicator 192 may be an indicator light, and may indicate a charging status and a power change, or may indicate a message, a missed call, a notification, and the like.

The eSIM module 195 may be embedded in the electronic device 100. The eSIM module is usually embedded inside a main board of the electronic device, and may replace a physical SIM card, but the eSIM has a much smaller size. Different from a SIM card, an eSIM card can be used to randomly change a number or an operator, because information on the eSIM card can be rewritten. The eSIM card is remotely configured through card writing by using an over-the-air (OTA). In this way, an operator configuration file can be downloaded to, installed on, activated on, deactivated on, and deleted from to a terminal through a network.

In embodiments of this application, a device type of the electronic device 100 may include any one of a smartphone, a smartwatch, a smart speaker, a personal computer, a smart television, a tablet computer, a smart socket, an air purifier, a smart desk lamp, a smart air conditioner, a smart curtain, a smart water heater, a smart lock, a smart camera, and the like.

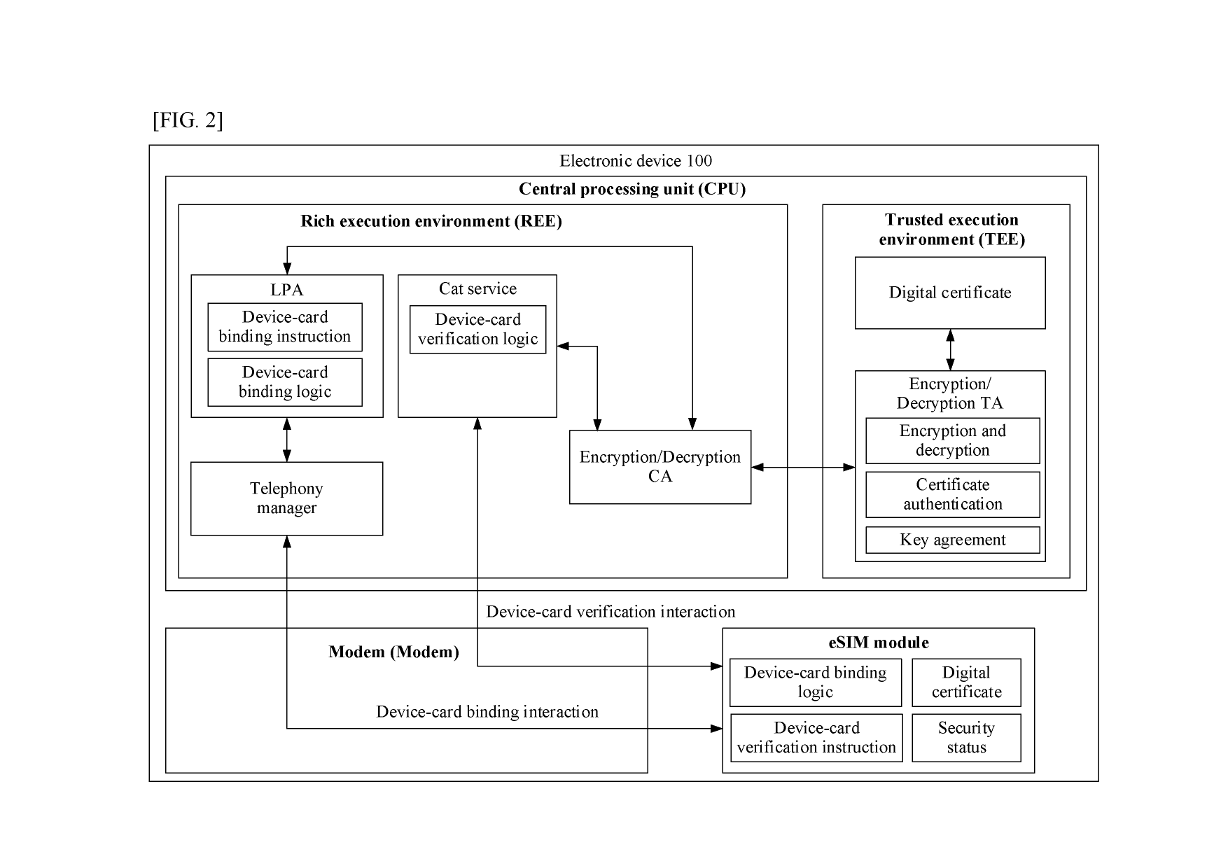

FIG. 2 is a diagram of a structure of a trusted execution environment of an electronic device according to an embodiment of this application.

As shown in FIG. 2, an electronic device 100 may include a central processing unit (CPU), a modem, and an eSIM module. Two application environments may run in the CPU: a rich execution environment (REE) and a trusted execution environment (TEE).

An application running in the REE may be referred to as a client application. The client application in the REE may include an encryption/decryption client application (CA). A local profile assistant (LPA), a card application tool service (Cat service), and a telephony manager may further run in the REE.

An application running in the TEE may be referred to as a trusted application (TEE application, TA). The trusted application in the TEE may include an encryption/decryption TA, and the TEE may further manage some digital certificates issued by a digital certificate authority (Certificate Authority). For example, the digital certificates in the TEE may include an authentication root certificate (CERT.CI.ECDSA), a device certificate (CERT.DEVICE.ECDSA), and a terminal certificate (CERT.OEM.ECDSA).

An operating system running in the REE may be referred to as a rich execution environment operating system (REE OS), and an operating system running in the TEE may be referred to as a trusted execution environment operating system (TEE OS). The TEE is a secure running environment running in the CPU. A secure boot process of the TEE needs to be verified, and the secure boot process of the TEE is separated from that of the REE. Applications running in the TEE are independent of each other, and the applications cannot access each other without authorization. This ensures that a resource and data processing process of the applications in the TEE is performed in a trusted environment, thereby providing a security service for the REE operating system. The TEE has its own execution space, has a higher security level than the REE operating system, and is a security architecture that overlaps a hardware architecture of the currently used CPU. Software and hardware resources that can be accessed by the TEE are separate from those of the REE operating system, and hardware supported isolation is provided. The encryption/decryption CA and the encryption/decryption TA share a memory. If the encryption/decryption CA needs to communicate with the encryption/decryption TA, the encryption/decryption CA may apply to the TEE OS for setting up a session with the requested encryption/decryption TA. After the session between the encryption/decryption CA and the encryption/decryption TA is set up, the encryption/decryption CA may send a processing request and to-be-processed data to the encryption/decryption TA through the shared memory. After obtaining the processing request and the to-be-processed data of the encryption/decryption CA from the shared memory, the encryption/decryption TA may execute the processing request in the TEE environment, and store an obtained processing result in the shared memory. The encryption/decryption CA may obtain the processing result of the encryption/decryption TA through the shared memory. After the encryption/decryption CA obtains the processing result, if the encryption/decryption TA does not need to continue processing, the encryption/decryption CA may initiate a close session request to the TEE OS. After receiving the close session request, the TEE OS may reclaim related resources of the encryption/decryption TA.

The LPA may invoke device-card binding logic and send a device-card binding instruction to the eSIM module. The LPA may perform device-card binding interaction with the eSIM module through the telephony manager and the modem. The LPA may communicate with the encryption/decryption TA in the TEE by invoking the encryption/decryption CA, to invoke the encryption/decryption TA to provide services such as encryption/decryption, certificate verification, and key agreement in the device-card binding interaction process.

The eSIM module may manage the device-card binding logic, a digital certificate, and a security status, and send a device-card verification command. The digital certificate managed in the eSIM module may include an authentication root certificate, a terminal vendor root certificate (CERT.OEMCI.ECDSA), and the like.

The eSIM module may invoke the device-card binding logic, and send a device-card verification instruction to the Cat service through the modem, to trigger device-card verification interaction between the eSIM module and the Cat service. The Cat service may communicate with the encryption/decryption TA in the TEE by invoking the encryption/decryption CA, to invoke the encryption/decryption TA to provide services such as encryption/decryption in the device-card verification interaction process.

1. In the device-card binding logic:

The LPA may first request a certificate chain of the eSIM module, and invoke the encryption/decryption TA through the encryption/decryption CA to verify the certificate chain of the eSIM module. After verification on validity of the certificate chain of the eSIM module succeeds, the encryption/decryption TA may obtain an embedded universal integrated circuit card (eUICC) public key from the certificate chain of the eSIM module. The LPA may invoke the encryption/decryption TA through the encryption/decryption CA to generate a TEE temporary working public key and a TEE temporary working private key, invoke the encryption/decryption TA to sign the TEE temporary working public key by using a TEE private key (for example, an OEM private key), and send signature data including the TEE temporary working public key to the eSIM module.

The LPA may send a certificate chain of the TEE to the eSIM module. The eSIM module may verify the certificate chain of the TEE. After verification on validity of the certificate chain of the TEE succeeds, the eSIM module may obtain a TEE public key (for example, an OEM public key) from the certificate chain of the TEE. The eSIM module generates an eUICC temporary working public key and an eUICC temporary working private key, signs the eUICC temporary working public key by using an eUICC private key, and sends signature data including the eUICC temporary working public key to the LPA.

The LPA may verify, by invoking the encryption/decryption TA and by using an eUICC public key, the signature data including the eUICC temporary working public key, and obtain the eUICC temporary working public key after verification succeeds. The encryption/decryption TA may generate a shared secret key based on the eUICC temporary working public key and the TEE temporary working private key.

The eSIM module may verify, by using the TEE public key (for example, the OEM public key), the signature data including the TEE temporary working public key, and obtain the TEE temporary working public key after verification succeeds. The eSIM module may generate the shared secret key based on the TEE temporary working public key and the eUICC temporary working private key.

Both the eSIM module and the encryption/decryption TA may generate the same shared secret key by using a temporary working public key of the peer party and their own temporary working private keys.

The LPA may obtain a device identity 1 (for example, an identity and/or an IMEI of the CPU), and invoke the encryption/decryption TA to encrypt the device identity 1 by using the shared secret key, to obtain binding information. The LPA may send the binding information to the eSIM module.

The eSIM module may decrypt the device identity from the binding information by using the shared secret key, and store the device identity 1.

2. In the device-card verification logic:

After the device-card binding logic is performed on the eSIM module, the device identity 1 is bound to the eSIM module. When the eSIM module is powered on again or before network registration is initiated, the eSIM module may actively send a device identity obtaining request to the Cat service. After obtaining the device identity obtaining request, the Cat service may obtain a device identity 2 in the CPU, and invoke the encryption/decryption TA to encrypt the device identity 2 by using the shared secret key, to obtain check information. The Cat service may send the check information to the eSIM module. The eSIM module may decrypt the device identity 2 from the check information by using the shared secret key. The eSIM module may determine whether the device identity 2 decrypted from the check information is the same as the stored device identity 1. If the device identity 2 is the same as the device identity 1, the device-card verification succeeds, and the eSIM module can normally perform a communication service. If the device identity 2 is different from the device identity 1, the device-card verification fails, and the eSIM module is forbidden from performing a communication service.

In a possible implementation, the device identity obtaining request may carry a random number. The encryption/decryption TA may encrypt the device identity 2 and the random number together by using the shared secret key, to obtain the check information. The eSIM module may decrypt the device identity 2 and a random number from the check information by using the shared secret key. If the decrypted random number is the same as the random number carried in the device identity obtaining request, and the device identity 2 is the same as the device identity 1, the device-card verification succeeds. If the decrypted random number is different from the random number carried in the device identity obtaining request, or the device identity 2 is different from the device identity 1, the device-card verification fails.

In embodiments of this application, the central processing unit is merely an example for explaining this application, and is not limited. The central processing unit may alternatively be another processing module, and the processing module may include the REE and the TEE. For function descriptions of the REE and the TEE and architectures of internal modules, refer to the embodiment shown in FIG. 2. Details are not described herein again.

In embodiments of this application, the CPU may be referred to as a processing module, a first CPU may be referred to as a first processing module, and a second CPU may be referred to as a second processing module. The first CPU may be understood as an example of the first processing module, and the second CPU may also be understood as an example of the second processing module. In some possible embodiments of this application, the first processing module and the second processing module may be a same processing module, or may be different processing modules.

In embodiments of this application, the electronic device 100 may be referred to as a terminal, and the processing module and the modem in the electronic device 100 may be collectively referred to as a terminal device. Therefore, the terminal may include the terminal device and the eSIM module.

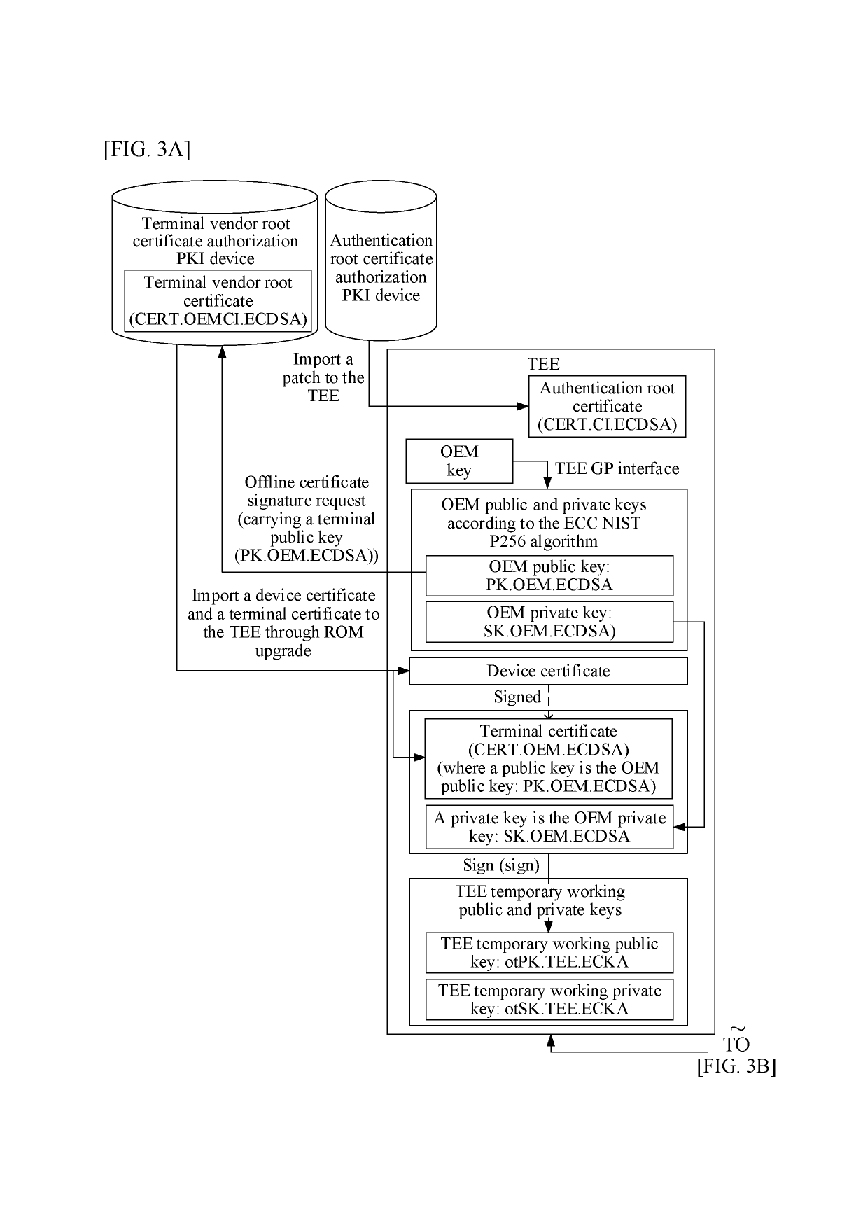

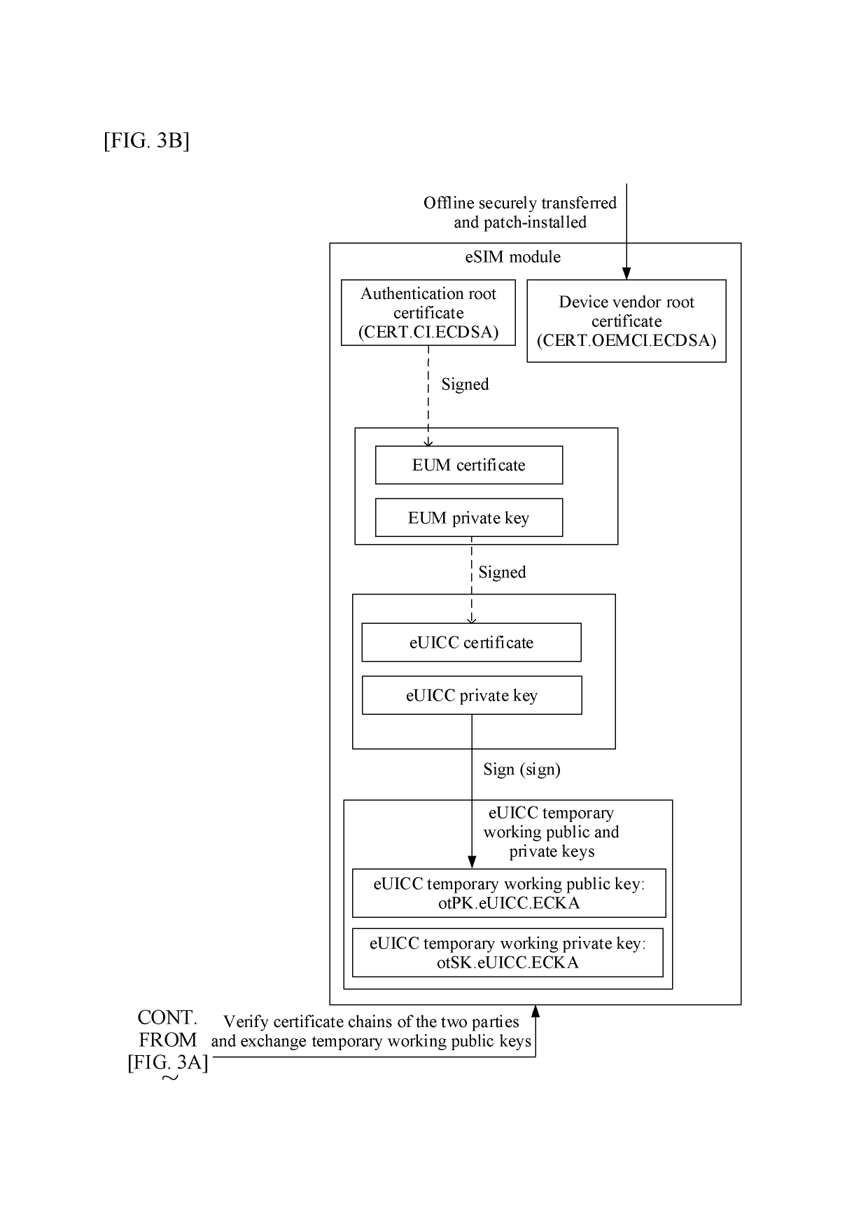

FIG. 3A and FIG. 3B are a diagram of certificate chains in the TEE and the eSIM module of the electronic device 100 according to an embodiment of this application.

As shown in FIG. 3A and FIG. 3B, the TEE may manage the authentication root certificate (CERT.CI.ECDSA), the device certificate, and the terminal certificate (CERT.OEM.ECDSA). The authentication root certificate is a root certificate of an embedded UICC manufacturer (EUM) certificate in the eSIM module, and the EUM certificate is a root certificate of an eUICC certificate. In other words, the EUM certificate is signed by using a private key corresponding to the authentication root certificate, and the eUICC certificate is signed by using a private key corresponding to the EUM certificate.

The authentication root certificate (CERT.CI.ECDSA) may be imported to the TEE of the electronic device 100 in an OTA manner by an authentication root certificate authorization public key infrastructure (PKI) device.

The TEE may generate a pair of OEM public and private keys. The OEM public and private keys include an OEM public key (PK.OEM.ECDSA) and an OEM private key (SK.OEM.ECDSA). The OEM public and private keys may be public and private keys in an elliptic curve cryptography (ECC) standard of the NIST P256 standard. A signature algorithm of the OEM public and private keys may be an elliptic curve digital signature algorithm (ECDSA).

The TEE may offline import a TEE certificate to the TEE through a device vendor certificate authorization PKI device. For example, the TEE certificate may include the device certificate and the terminal certificate. The TEE may send an offline certificate signature request to the device vendor certificate authorization PKI device. The offline certificate signature request includes the OEM public key (PK.OEM.ECDSA). The offline certificate signature request is used to request the device vendor certificate authorization PKI device to issue a digital certificate for the OEM public key. After receiving the offline certificate signature request, the device vendor certificate authorization PKI device may first issue the device certificate by using a private key corresponding to the terminal vendor root certificate, and then issue, by using a private key corresponding to the device certificate, the terminal certificate including the OEM public key. The terminal certificate includes the OEM public key (PK.OEM.ECDSA), and a private key corresponding to the terminal certificate is the OEM private key (SK.OEM.ECDSA).

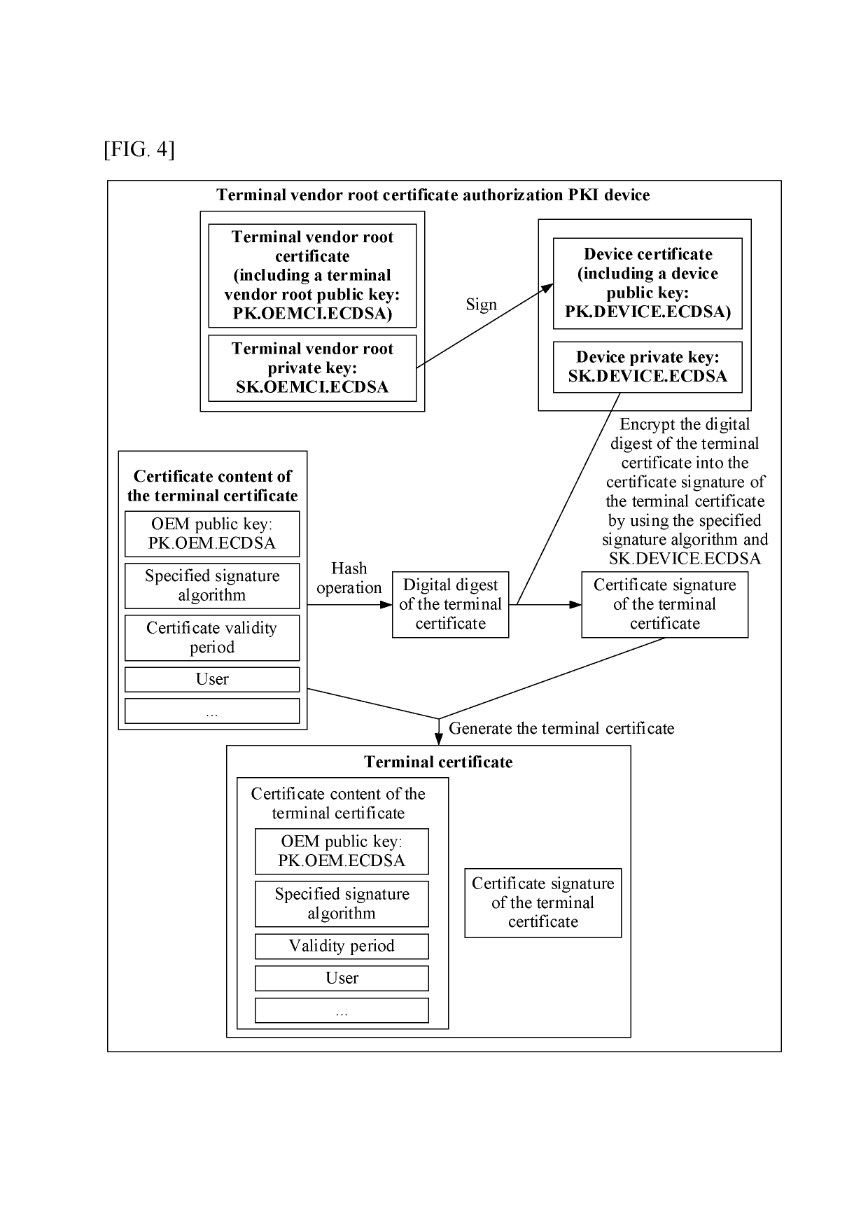

For example, refer to a certificate signing process shown in FIG. 4.

1. A device vendor root certificate authorization PKI device may store the terminal vendor root certificate and the private key (SK.OEMCI.ECDSA) corresponding to the terminal vendor root certificate. The device vendor certificate authorization PKI device may use the private key (SK.OEMCI.ECDSA) corresponding to the terminal vendor root certificate to sign certificate content of the device certificate, to generate the device certificate. The device certificate includes a device public key (PK.DEVICE.ECDSA), and a device private key (SK.DEVICE.ECDSA) paired with the device public key (PK.DEVICE.ECDSA) is stored in a terminal vendor root authorization PKI device.

2. After receiving the offline certificate signature request sent by the TEE of the electronic device 100, the device vendor certificate authorization PKI device may obtain the OEM public key (PK.OEM.ECDSA) from the offline certificate signature request, and generate certificate content of the terminal certificate. The certificate content of the terminal certificate may include the OEM public key (PK.OEM.ECDSA), a specified signature algorithm (for example, the ECDSA), a certificate validity period, a user, and the like.

3. The terminal vendor root authorization PKI device may perform a hash (hash) operation on the certificate content of the terminal certificate, to generate a digital digest of the terminal certificate. The terminal vendor root authorization PKI device may encrypt the digital digest of the terminal certificate into a certificate signature of the terminal certificate by using the device private key (SK.DEVICE.ECDSA) and the specified signature algorithm. The terminal vendor root authorization PKI device may combine the digital digest of the terminal certificate and a certificate signature of a service root certificate to generate the terminal certificate.

The terminal vendor root certificate, an authentication root certificate (CERT.CI.ECDSA), an EUM certificate, an eUICC certificate, an EUM private key corresponding to the EUM certificate, and an eUICC private key (SK.eUICC.ECDSA) corresponding to the eUICC certificate may be preset in the eSIM module. The terminal vendor root certificate includes a terminal vendor root public key, the authentication root certificate (CERT.CI.ECDSA) includes an authentication root public key (PK.CI.ECDSA), the EUM certificate includes an EUM public key, and the eUICC certificate includes an eUICC public key (PK.eUICC.ECDSA). The EUM certificate has been signed by using an authentication root private key corresponding to the authentication root certificate (CERT.CI.ECDSA). The EUM certificate has been signed by using the EUM private key corresponding to the EUM certificate.

The TEE and the eSIM module may verify the certificate chains of each other and exchange temporary working public keys.

Details are as follows:

(1) The encryption/decryption TA in the TEE may verify the certificate chain of the eSIM module.

The certificate chain of the eSIM module includes the authentication root certificate, the EUM certificate, and the eUICC certificate. The eSIM module may send the EUM certificate and the eUICC certificate to the encryption/decryption TA. The encryption/decryption TA may verify validity of the EUM certificate by using the authentication root public key in the authentication root certificate preset in the TEE. If verification on the validity of the EUM certificate succeeds, the encryption/decryption TA may verify validity of the eUICC certificate by using the EUM public key in the EUM certificate. If verification on the validity of the eUICC certificate succeeds, the encryption/decryption TA may determine that verification on validity of the certificate chain of the eSIM module succeeds.

(2) The eSIM module may verify the certificate chain of the TEE.

The certificate chain of the TEE includes the device certificate and the terminal certificate. The encryption/decryption TA may send the device certificate and the terminal certificate to the eSIM module. The eSIM module may verify validity of the device certificate by using the public key in the terminal vendor root certificate preset in the eSIM module. If verification on the validity of the device certificate succeeds, the eSIM module may verify validity of the terminal certificate by using the device public key in the device certificate. If verification on the validity of the terminal certificate succeeds, the eSIM module may determine that verification on validity of the certificate chain of the TEE succeeds.

In a possible implementation, the TEE certificate may include the terminal vendor root certificate. The terminal vendor root certificate is self-signed by using the terminal vendor root private key corresponding to the terminal vendor root certificate. In this case, after OTA upgrade is completed, the eSIM module may store the terminal vendor root certificate. Because the device certificate managed by the TEE includes only the terminal vendor root certificate, the LPA does not need to send the terminal vendor root certificate to the eSIM module for verification. After receiving the TEE temporary working public key subsequently, the eSIM module may directly perform verification in a signature manner.

(3) The encryption/decryption TA in the TEE and the eSIM module exchange temporary working public keys.

The encryption/decryption TA may generate TEE temporary working public and private keys. The TEE temporary working public and private keys include a TEE temporary working public key (otPK.TEE.ECKA) and a TEE temporary working private key (otSK.TEE.ECKA). After the encryption/decryption TA and the eSIM module verify the certificate chains of each other, the encryption/decryption TA may sign the TEE temporary working public key (otPK.TEE.ECDSA) by using the OEM private key (SK.OEM.ECDSA), and sends TEE signature data including the TEE temporary working public key (otPK.TEE.ECKA) to the eSIM module.

After verifying the certificate chain of the TEE, the eSIM module may obtain the OEM public key in the terminal certificate of the TEE. The eSIM module may verify, by using the OEM public key, the TEE signature data including the TEE temporary working public key (otPK.TEE.ECKA), and obtain the TEE temporary working public key (otPK.TEE.ECKA) after verification succeeds.

The eSIM module may generate eUICC temporary working public and private keys. The eUICC temporary working public and private keys include an eUICC temporary working public key (otPK.eUICC.ECKA) and an eUICC temporary working private key (otSK.eUICC.ECKA). The eSIM module may sign the eUICC temporary working public key (otPK.eUICC.ECKA) by using the eUICC private key (SK.eUICC.ECDSA), and send eUICC signature data including the eUICC temporary working public key (otPK.eUICC.ECKA) to the encryption/decryption TA.

After verifying the certificate chain of the eSIM module, the encryption/decryption TA may obtain the eUICC public key (PK.eUICC.ECDSA) in the eUICC certificate. The encryption/decryption TA may verify, by using the eUICC public key (PK.eUICC.ECDSA), the eUICC signature data including the eUICC temporary working public key (otPK.eUICC.ECKA), and obtain the eUICC temporary working public key (otPK.TEE.ECKA) after verification succeeds.

The eSIM module may generate the shared secret key (ShS) based on the TEE temporary working public key (otPK.TEE.ECKA) and the eUICC temporary working private key (otSK.eUICC.ECKA).

The encryption/decryption TA may generate the shared secret key (ShS) based on the eUICC temporary working public key (otPK.eUICC.ECKA) and the TEE temporary working private key (otSK.TEE.ECKA).

The TEE temporary working public key (otPK.TEE.ECKA) and the TEE temporary working private key (otSK.TEE.ECKA) are a pair of public and private keys, and the eUICC temporary working public key (otPK.eUICC.ECKA) and the eUICC temporary working private key (otSK.eUICC.ECKA) are a pair of public and private keys. Therefore, both the eSIM module and the encryption/decryption TA may generate the same shared secret key (ShS) by using the temporary working public key of the peer party and their own temporary working private keys.

In a possible implementation, the authentication root certificate (CERT.CI.ECDSA) may be a root certificate issued by an operator, a root certificate issued by a third-party organization, a root certificate issued by a terminal vendor, a root certificate issued by an EUM vendor, or the like.

In a possible implementation, the terminal certificate (CERT.OEM.ECDSA) may be directly issued by using the terminal vendor root certificate or an intermediate certificate issued by using the terminal vendor root certificate, or may be issued by using the authentication root certificate.

In a possible implementation, the terminal certificate (CERT.OEM.ECDSA) may be self-signed.

In a possible implementation, the device vendor root certificate (CERT.OEMCI.ECDSA) may be preset in the eSIM module before delivery of the electronic device 100.

In a possible implementation, the device vendor root certificate (CERT.OEMCI.ECDSA) may alternatively be delivered by a server to the electronic device 100 during OTA upgrade after delivery of the electronic device 100. The processing module (for example, the CPU) in the electronic device 100 is preset in the eSIM module.

The following describes abbreviations of certificates in embodiments of this application in a unified manner.

(1) The authentication root certificate may be abbreviated as CERT.CI.ECDSA, CERT.CI.SIG, or CERT.CNCI.SIG. The authentication root public key of the authentication root certificate may be abbreviated as PK.CI.ECKA, PK.CNCI.ECKA, PK.CNCI.SIG, or the like. The authentication root private key corresponding to the authentication root certificate may be abbreviated as SK.CI.ECKA, SK.CNCI.ECKA, SK.CNCI.SIG, or the like.

(2) The EUM certificate may be abbreviated as CERT.EUM.ECDSA or CERT.EUM.SIG. The EUM public key of the EUM certificate may be abbreviated as PK.EUM.ECKA, PK.EUM.ECKA, PK.EUM.SIG, or the like. The EUM private key corresponding to the EUM certificate may be abbreviated as SK.EUM.ECKA, SK.EUM.ECKA, SK.EUM.SIG, or the like.

(3) The eUICC certificate may also be referred to as an eSIM certificate. The eUICC certificate (also referred to as the eSIM certificate) may be abbreviated as CERT.eUICC.ECDSA, CERT.eUICC.SIG, CERT.eSIM.ECDSA, or CERT.eSIM.SIG. The eUICC public key (also referred to as an eSIM public key) of the eUICC certificate (also referred to as the eSIM certificate) may be abbreviated as PK.eUICC.ECKA, PK.eUICC.ECKA, PK.eUICC.SIG, PK.eSIM.ECKA, PK.eSIM.ECKA, PK.eSIM.SIG, or the like. The eUICC private key (also referred to as an eSIM private key) corresponding to the eUICC certificate (also referred to as the eSIM certificate) may be abbreviated as SK.eUICC.ECKA, SK.eUICC.ECKA, SK.eUICC.SIG, SK.eSIM.ECKA, SK.eSIM.ECKA, SK.eSIM.SIG, or the like.

(4) The terminal vendor root certificate may be abbreviated as CERT.OEMCI.ECDSA or CERT.OEMCI.SIG. The terminal vendor root public key of the terminal vendor root certificate may be abbreviated as PK.OEMCI.ECKA or PK.OEMCI.SIG. The terminal vendor root private key corresponding to the terminal vendor root certificate may be abbreviated as SK.OEMCI.ECKA or SK.OEMCI.SIG.

(5) The device certificate may be abbreviated as CERT.DEVICE.ECDSA or CERT.DEVICE.SIG. The device public key of the device certificate may be abbreviated as PK.DEVICE.ECKA or PK.DEVICE.SIG. The device private key corresponding to the device certificate may be abbreviated as SK.DEVICE.ECKA or SK.DEVICE.SIG.

(6) The terminal certificate may be abbreviated as CERT.OEM.ECDSA or CERT.OEM.SIG. The terminal public key of the terminal certificate may be abbreviated as PK.OEM.ECKA or PK.OEM.SIG. The device private key corresponding to the device certificate may be abbreviated as SK.OEM.ECKA or SK.OEM.SIG.

In embodiments of this application, for ease of description of the certificates, the certificates are uniformly described by using an abbreviation format ending with ".ECDSA".

The following describes an eSIM authentication method provided in embodiments of this application.

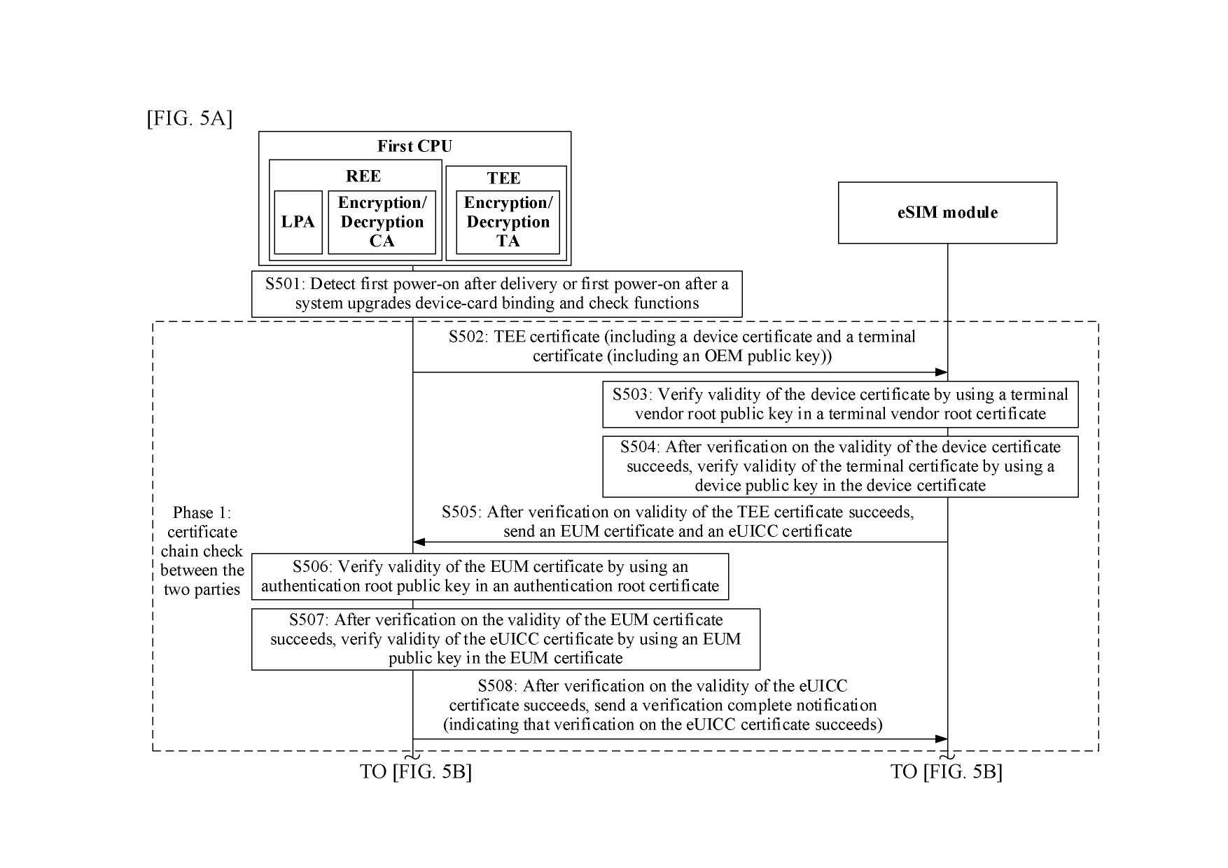

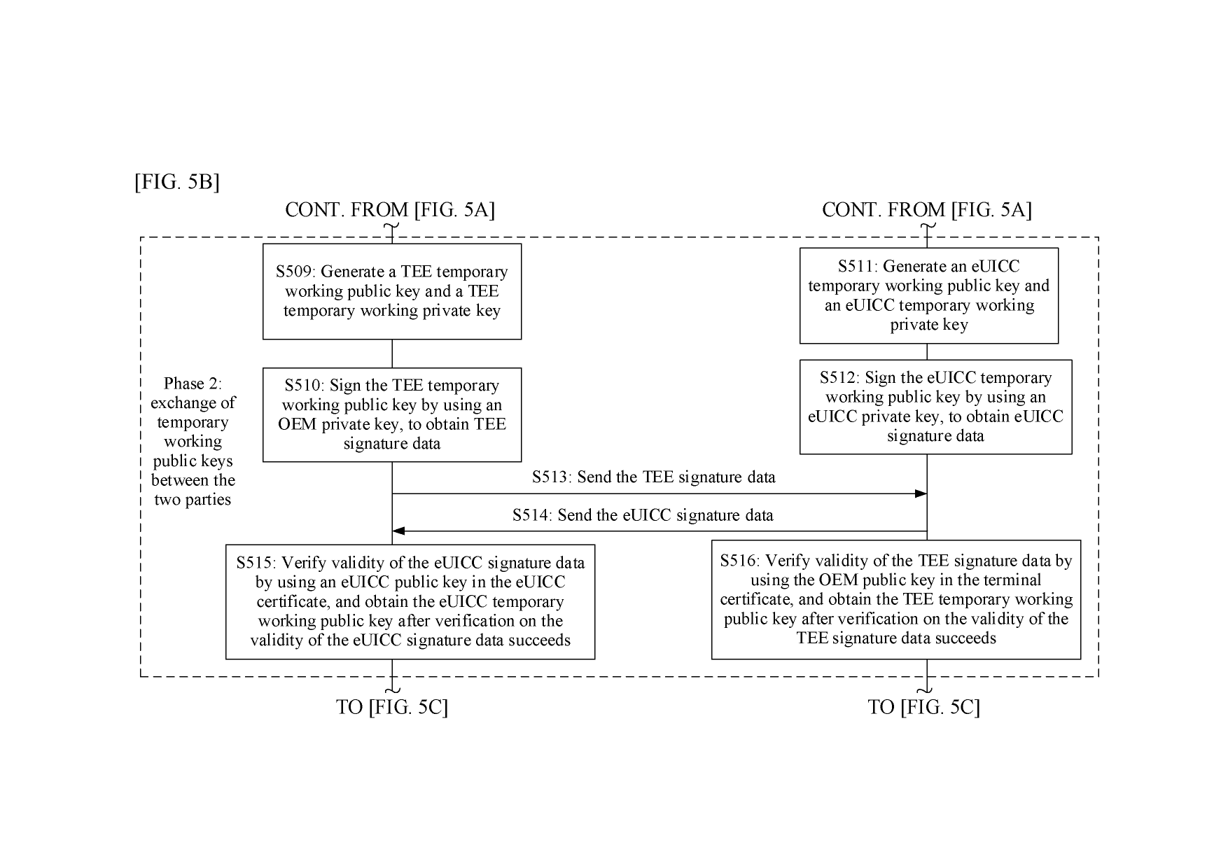

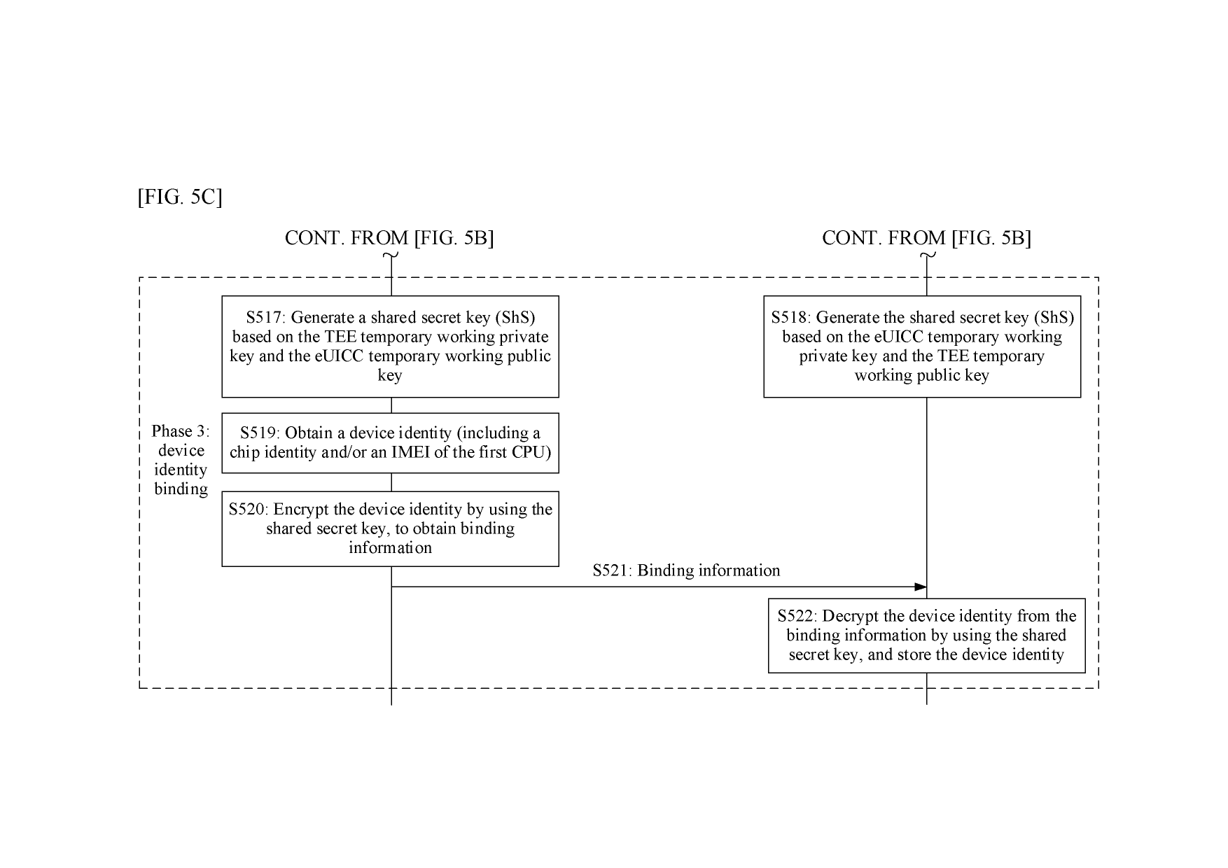

FIG. 5A to FIG. 5C are a schematic flowchart of device-card binding in an eSIM authentication method according to an embodiment of this application.

The eSIM authentication method may be applied to a first electronic device including a first CPU and an eSIM module. An REE and a TEE may run in the first CPU. An LPA and an encryption/decryption CA may run in the REE, and an encryption/decryption TA may run in the TEE. For specific descriptions of the REE and the TEE, refer to the embodiments shown in FIG. 2 to FIG. 4. Details are not described herein again.

As shown in FIG. 5A to FIG. 5C, the device-card binding procedure may include the following steps.

S501: The first CPU may detect first power-on after delivery or first power-on after a system upgrades device-card binding and check functions.

The first CPU may trigger a subsequent device-card binding procedure after detecting the first power-on after delivery or the first power-on after the system upgrades the device-card binding and check functions. The device-card binding procedure may include the following three phases: certificate check between the two parties, exchange of temporary working public keys between the two parties, and device identity binding.

A device-card binding function and a device-card check function may be preset in the first electronic device before delivery. In this way, the first CPU and the eSIM module in the first electronic device can be bound when the first electronic device is powered on for the first time after delivery, to prevent the eSIM module of the first electronic device from being normally used on another device after being disassembled.

In a possible implementation, after delivery, the first electronic device may obtain the device-card binding function and the device-card check function when performing system upgrade through OTA. In this way, the first CPU and the eSIM module in the electronic device that has been sold are bound in a system upgrade manner, to prevent the eSIM module of the first electronic device that has been sold from being normally used on another device after being disassembled.

Phase 1: certificate check between the two parties

S502: The first CPU may send a TEE certificate to the eSIM module.

The TEE certificate may include a device certificate and a terminal certificate. The TEE certificate may be managed by the TEE. The TEE may further manage an authentication root certificate.

In a possible implementation, the TEE certificate may be a terminal vendor root certificate, and the terminal vendor root certificate is signed by using a terminal vendor root public key in the terminal vendor root certificate.

S503: The eSIM module may verify validity of the device certificate by using the terminal vendor root public key in the terminal vendor root certificate.

The terminal vendor root certificate, an authentication root certificate (CERT.CI.ECDSA), an EUM certificate, an eUICC certificate, an EUM private key corresponding to the EUM certificate, and an eUICC private key (SK.eUICC.ECDSA) corresponding to the eUICC certificate may be preset in the eSIM module. The terminal vendor root certificate includes the terminal vendor root public key, the authentication root certificate (CERT.CI.ECDSA) includes an authentication root public key (PK.CI.ECDSA), the EUM certificate includes an EUM public key, and the eUICC certificate includes an eUICC public key (PK.eUICC.ECDSA). The EUM certificate has been signed by using an authentication root private key corresponding to the authentication root certificate (CERT.CI.ECDSA). The eUICC certificate has been signed by using the EUM private key corresponding to the EUM certificate.

Specifically, the eSIM module may decrypt digest information 1 of the device certificate from a certificate signature of the device certificate by using the terminal vendor root public key in the terminal vendor root certificate. Then, the eSIM module may perform a hash operation on certificate content of the device certificate, to obtain digest information 2. If the digest information 2 is the same as the digest information 1, the eSIM module may determine that the validity of the device certificate succeeds. If the digest information 2 is different from the digest information 1, the eSIM module may determine that the validity of the device certificate fails.

S504: After verification on the validity of the device certificate succeeds, the eSIM module may verify validity of the terminal certificate by using a device public key in the device certificate.

Specifically, the eSIM module may decrypt digest information 3 of the terminal certificate from a certificate signature of the terminal certificate by using the device public key in the device certificate. Then, the eSIM module may perform a hash operation on certificate content of the terminal certificate, to obtain digest information 4. If the digest information 3 is the same as the digest information 4, the eSIM module may determine that the validity of the terminal certificate succeeds. If the digest information 3 is different from the digest information 4, the eSIM module may determine that the validity of the terminal certificate fails.

S505: After verification on validity of the TEE certificate succeeds, the eSIM module may send the EUM certificate and the eUICC certificate to the first CPU.

S506: After receiving the EUM certificate and the eUICC certificate, the first CPU may verify validity of the EUM certificate by using the authentication root public key in the authentication root certificate.

The TEE running in the first CPU may manage the authentication root certificate (CERT.CI.ECDSA), the device certificate, and the terminal certificate (CERT.OEM.ECDSA). The authentication root certificate is a root certificate of an embedded UICC manufacturer (EUM) certificate in the eSIM module, and the EUM certificate is a root certificate of an eUICC certificate. In other words, the EUM certificate is signed by using the authentication root private key corresponding to the authentication root certificate, and the eUICC certificate is signed by using the EUM private key corresponding to the EUM certificate. The terminal certificate is signed by using the device private key corresponding to the device certificate, and the device certificate is signed by using the terminal vendor root private key corresponding to the terminal vendor root certificate.

Specifically, after receiving the EUM certificate and the eUICC certificate, the first CPU may first decrypt digest information 5 of the EUM certificate from a certificate signature of the EUM certificate by using the authentication root public key in the authentication root certificate. Then, the first CPU may perform a hash operation on certificate content of the EUM certificate, to obtain digest information 6. If the digest information 5 is the same as the digest information 6, the first CPU may determine that the validity of the EUM certificate succeeds. If the digest information 5 is different from the digest information 6, the first CPU may determine that the validity of the EUM certificate fails.

S507: After verification on the validity of the EUM certificate succeeds, the first CPU may verify validity of the eUICC certificate by using the EUM public key in the EUM certificate.

Specifically, the first CPU may first decrypt digest information 7 of the eUICC certificate from a certificate signature of the eUICC certificate by using the EUM public key in the EUM certificate. Then, the first CPU may perform a hash operation on certificate content of the eUICC certificate, to obtain digest information 8. If the digest information 7 is the same as the digest information 8, the first CPU may determine that the validity of the eUICC certificate succeeds. If the digest information 7 is different from the digest information 8, the first CPU may determine that the validity of the eUICC certificate fails.

S508: After verification on the validity of the eUICC certificate succeeds, the first CPU sends a verification complete notification to the eSIM module.

The verification complete notification indicates that verification on the eUICC certificate succeeds.

Phase 2: exchange of temporary working public keys between the two parties

S509: After sending the verification complete notification to the eSIM module, the first CPU may generate a TEE temporary working public key and a TEE temporary working private key.

The TEE temporary working public key and the TEE temporary working private key are a pair of paired public and private keys.

S510: The first CPU may sign the TEE temporary working public key by using an OEM private key, to obtain TEE signature data.

The OEM private key and the OEM public key are a pair of paired public and private keys. The TEE signature data may include the TEE temporary working public key and a TEE signature value.

S511: After receiving the verification complete notification, the eSIM module may generate an eUICC temporary working public key and an eUICC temporary working private key.

The eUICC temporary working public key and the eUICC temporary working private key are a pair of paired public and private keys.

S512: The eSIM module may sign the eUICC temporary working public key by using an eUICC private key, to obtain eUICC signature data.

The eUICC signature data includes the eUICC temporary working public key and an eUICC signature value.

S513: The first CPU may send the TEE signature data to the eSIM module.

S514: The eSIM module may send the eUICC signature data to the first CPU.

S515: The first CPU may verify validity of the eUICC signature data by using the eUICC public key in the eUICC certificate, and obtain the eUICC temporary working public key after verification on the validity of the eUICC signature data succeeds.

The first CPU may decrypt digest information 9 from the eUICC signature value in the eUICC signature data by using the eUICC public key in the eUICC certificate. Then, the first CPU may perform a hash operation on the eUICC temporary working public key in the eUICC signature data, to obtain digest information 10. If the digest information 10 is the same as the digest information 9, the first CPU may determine that verification on the validity of the eUICC signature data succeeds, and the first CPU may store the eUICC temporary working public key in the eUICC signature data by using the TEE.

S516: The eSIM module may verify validity of the TEE signature data by using the OEM public key in the terminal certificate, and obtain the TEE temporary working public key after verification on the validity of the TEE signature data succeeds.

The eSIM module may decrypt digest information 11 from the TEE signature value in the TEE signature data by using the OEM public key in the terminal certificate. Then, the eSIM module may sign the TEE temporary working public key in the TEE signature data, to obtain digest information 12. If the digest information 12 is the same as the digest information 11, the eSIM module may determine that verification on the validity of the TEE signature data succeeds, and the eSIM module may store the TEE temporary working public key that is in the TEE signature data.

Phase 3: device identity binding

S517: The first CPU may generate a shared secret key (ShS) based on the TEE temporary working private key and the eUICC temporary working public key.

S518: The eSIM module may generate the shared secret key (ShS) based on the eUICC temporary working private key and the TEE temporary working public key.

The TEE temporary working public key and the TEE temporary working private key are a pair of public and private keys, and the eUICC temporary working public key and the eUICC temporary working private key are a pair of public and private keys. Therefore, both the eSIM module and the encryption/decryption TA may generate the same shared secret key (ShS) by using the temporary working public key of the peer party and their own temporary working private keys.

S519: The first CPU may obtain a device identity.

The device identity may include a chip identity (chipID) and/or an international mobile equipment identity (IMEI) of the first CPU, and the like.

S520: The first CPU may encrypt the device identity by using the shared secret key, to obtain binding information.

S521: The first CPU may send the binding information to the eSIM module.

S522: The eSIM module may decrypt the device identity from the binding information by using the shared secret key, and store the device identity.

After the eSIM module stores the device identity, the device-card binding process is completed.

In some embodiments, step S501 is optional, and step S502 to step S522 may be performed on a production line before delivery of the electronic device.

In the embodiment shown in FIG. 5A to FIG. 5C in this application, steps performed by the first CPU may be specifically performed by the LPA in the first CPU, or may be performed by the encryption/decryption TA in the TEE that is triggered by the LPA through the encryption/decryption CA. For example, in steps S501 and S502, after detecting the first power-on after delivery or the first power-on after the system upgrades the device-card binding function, the LPA may obtain the TEE certificate from the TEE, and send the TEE certificate to the eSIM module. Steps S506, S507, S509, S510, S515, S517, S519, and S520 are performed by the encryption/decryption TA that is triggered by the LPA through the encryption/decryption CA. Steps S509, S513, and S521 are performed by the LPA.

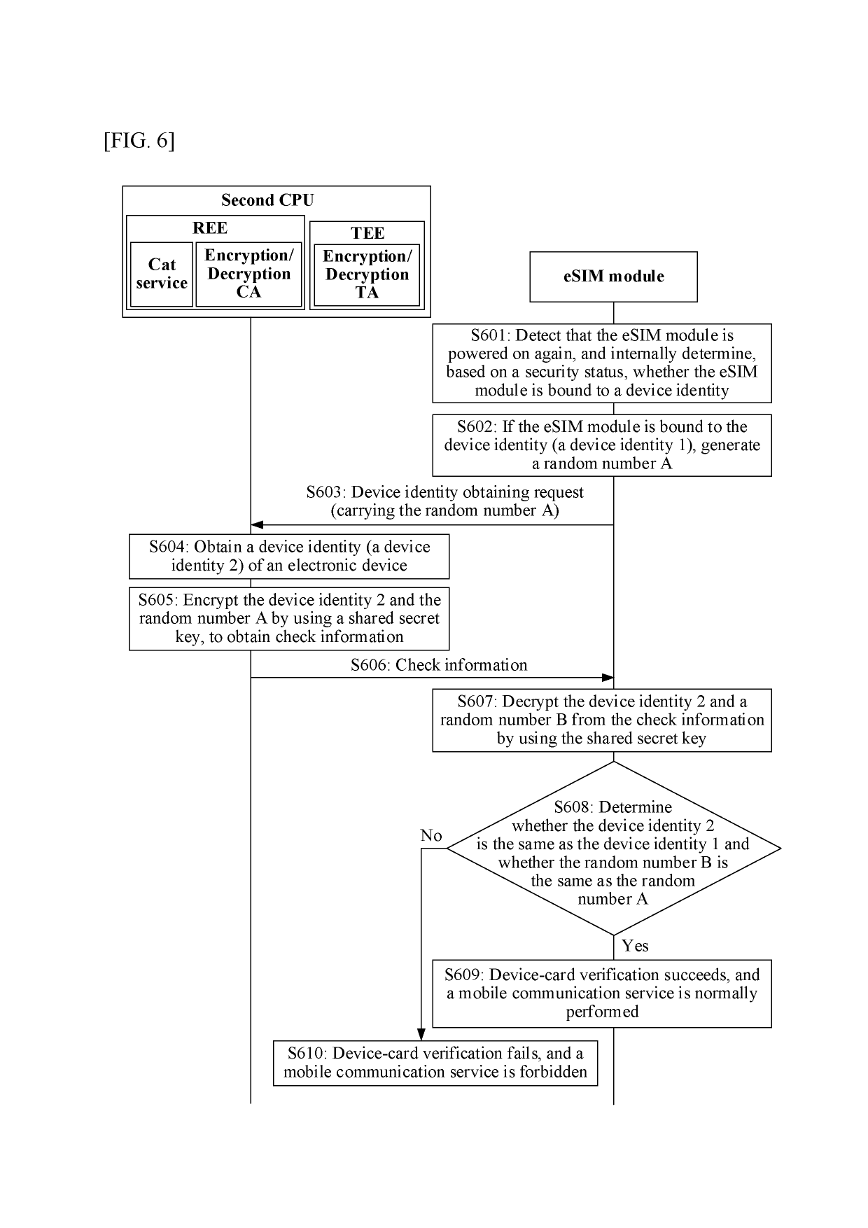

FIG. 6 is a schematic flowchart of device-card verification in an eSIM authentication method according to an embodiment of this application.

The eSIM authentication method may be applied to an electronic device including a second CPU and an eSIM module. An REE and a TEE may run in the second CPU. A Cat service and an encryption/decryption CA may run in the REE, and an encryption/decryption TA may run in the TEE. For specific descriptions of the REE and the TEE, refer to the embodiments shown in FIG. 2 to FIG. 4. Details are not described herein again.

As shown in FIG. 6, the device-card verification procedure may include the following steps.

S601: When detecting that the eSIM module is powered on again, the eSIM module may internally determine, based on a security status, whether the eSIM module is bound to a device identity.

In a possible implementation, alternatively, when receiving a request for performing a communication service, the eSIM module may determine whether the eSIM module is bound to a device identity.

S602: If the eSIM module is bound to the device identity (a device identity 1), generate a random number A.

S603: The eSIM module sends a device identity obtaining request to the second CPU, where the device identity obtaining request carries the random number A.

S604: The second CPU may obtain a device identity (a device identity 2) of the electronic device.

The device identity of the electronic device may include a chip identity (chipID), an IMEI, and/or the like.

S605: The second CPU may encrypt the device identity 2 and the random number A by using a shared secret key, to obtain check information.

S606: The second CPU sends the check information to the eSIM module.

S607: The eSIM module may decrypt the device identity 2 and a random number B, from the check information by using the shared secret key.

S608: The eSIM module may determine whether the device identity 2 is the same as the device identity 1 and whether the random number B is the same as the random number A.

S609: If the device identity 2 is the same as the device identity 1, and the random number B is the same as the random number A, device-card verification succeeds, and the eSIM module can normally perform a mobile communication service.

S610: If the device identity 2 is different from the device identity 1 or the random number B is different from the random number A, device-card verification fails, and the eSIM module is forbidden from performing a mobile communication service.

In this embodiment of this application, if the device-card verification succeeds, it indicates that the second CPU and the first CPU in the embodiment shown in FIG. 5A to FIG. 5C are a same CPU, and the first electronic device is the same as the second electronic device.

If the device-card verification fails, it indicates that the second CPU and the first CPU in the embodiment shown in FIG. 5A to FIG. 5C are not a same CPU, the second electronic device and the first electronic device are different, and for the eSIM module, the second electronic device is not bound to the eSIM module.

In a possible implementation, if the eSIM module detects that the device-card verification fails for a specified quantity of times (for example, three times), the eSIM module is permanently locked.

In the embodiment shown in FIG. 6 in this application, steps performed by the second CPU may be specifically performed by the Cat service in the second CPU, or may be performed by the encryption/decryption TA in the TEE that is triggered by the Cat service through the encryption/decryption CA. For example, a receiver of the device identity obtaining request in step S603 may be the Cat service, step S604 may be performed by the Cat service, step S605 may be performed by the encryption/decryption TA that is triggered by the Cat service through the encryption/decryption CA, and step S606 may be performed by the Cat service.

In a possible implementation, if the eSIM module does not receive, after sending the device identity obtaining request to the second CPU, the check information sent by the second CPU, the device-card verification fails, and the eSIM module is forbidden from performing the mobile communication service.

According to the eSIM authentication method provided in this embodiment of this application, the first CPU and the eSIM module in the first electronic device may first agree on the shared key after an occasion like system upgrade or first power-on after delivery. Then, the first CPU encrypts the device identity by using the shared secret key to generate the binding information, and sends the binding information to the eSIM module. The eSIM module may decrypt the first device identity from the binding information by using the shared secret key, and store the first device identity. When the eSIM module is powered on again or before the eSIM module needs to perform the mobile communication service, the eSIM module may enable the second CPU that communicates with the eSIM module in this case to obtain a second device identity, and encrypt the second device identity by using the shared secret key, to generate the check information. The eSIM module may decrypt the second device identity from the check information by using the shared key. If the second device identity is the same as the first device identity stored in the eSIM module, the eSIM module may normally perform the mobile communication service. If the second device identity is different from the first device identity stored in the eSIM module, or the eSIM module does not receive, after the eSIM module is powered off and then powered on, the device check information sent by the second CPU, the eSIM module may be forbidden from performing the mobile communication service. In this way, the eSIM module in the first electronic device can be prevented from accessing a mobile communication network after the eSIM module is disassembled and inserted into another device, thereby improving security when the eSIM module accesses the mobile communication network.

The following specifically describes, with reference to signaling, a device-card binding procedure in the eSIM authentication method provided in embodiment of this application.

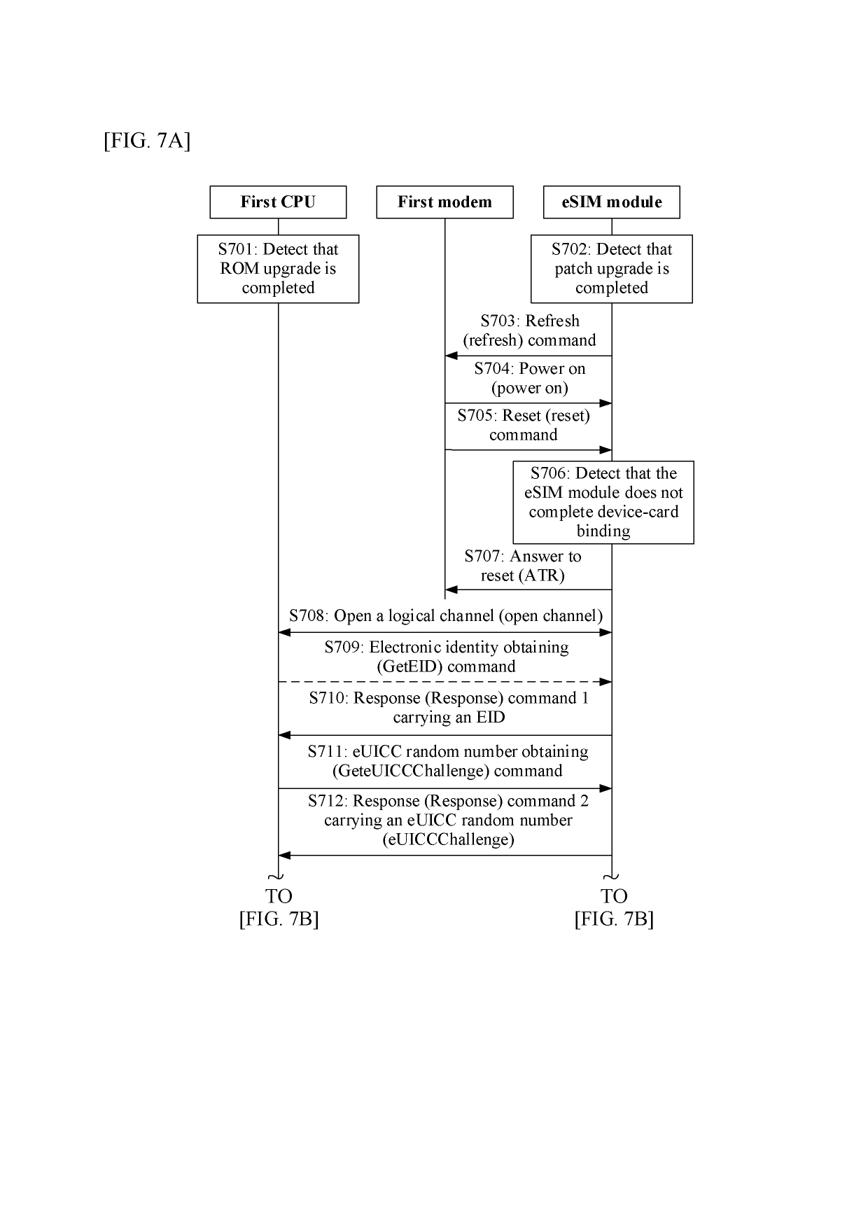

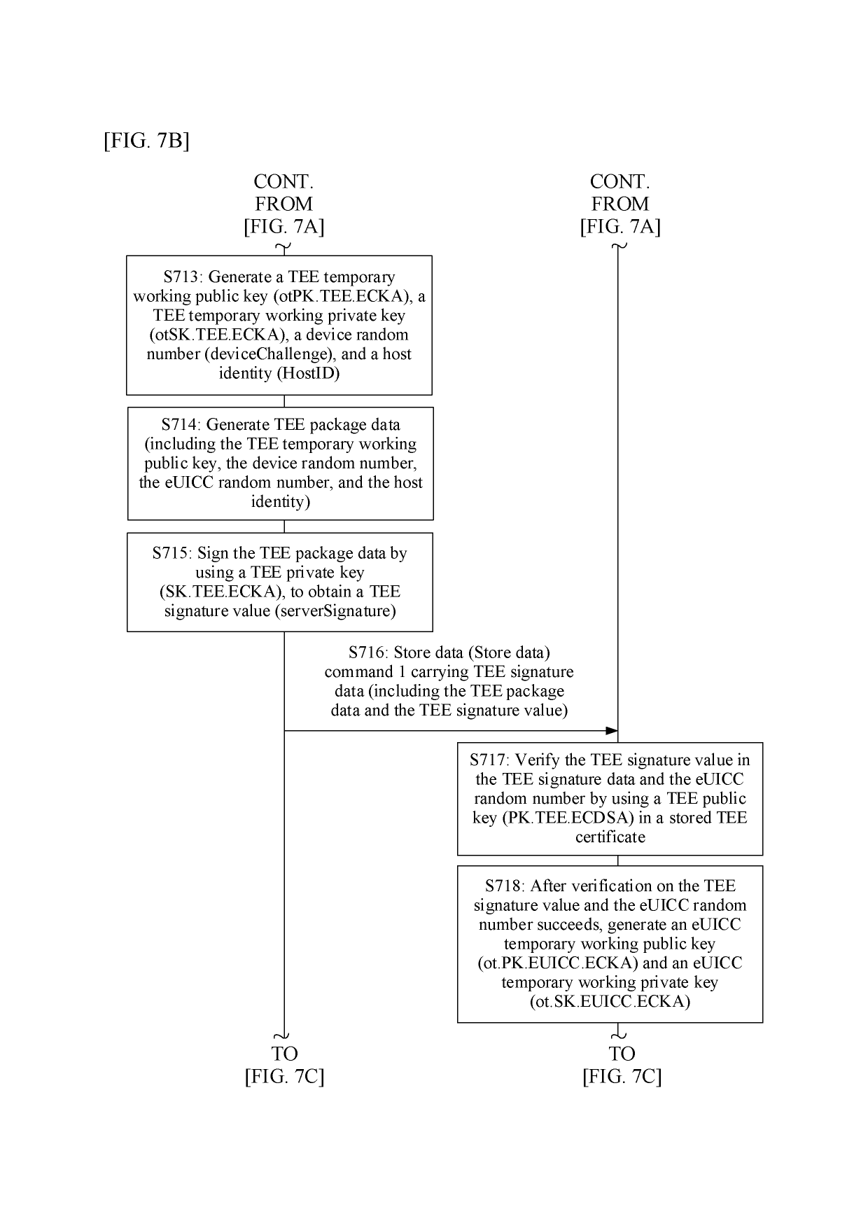

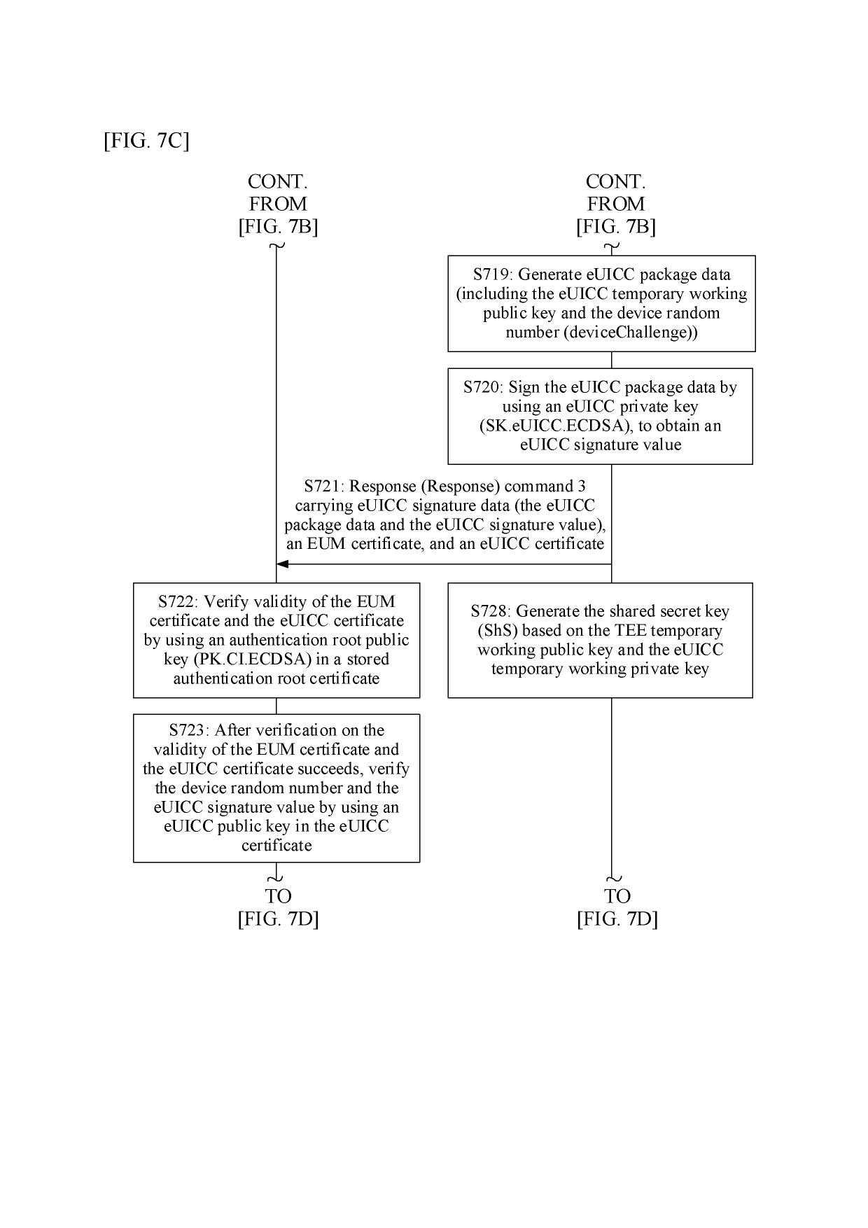

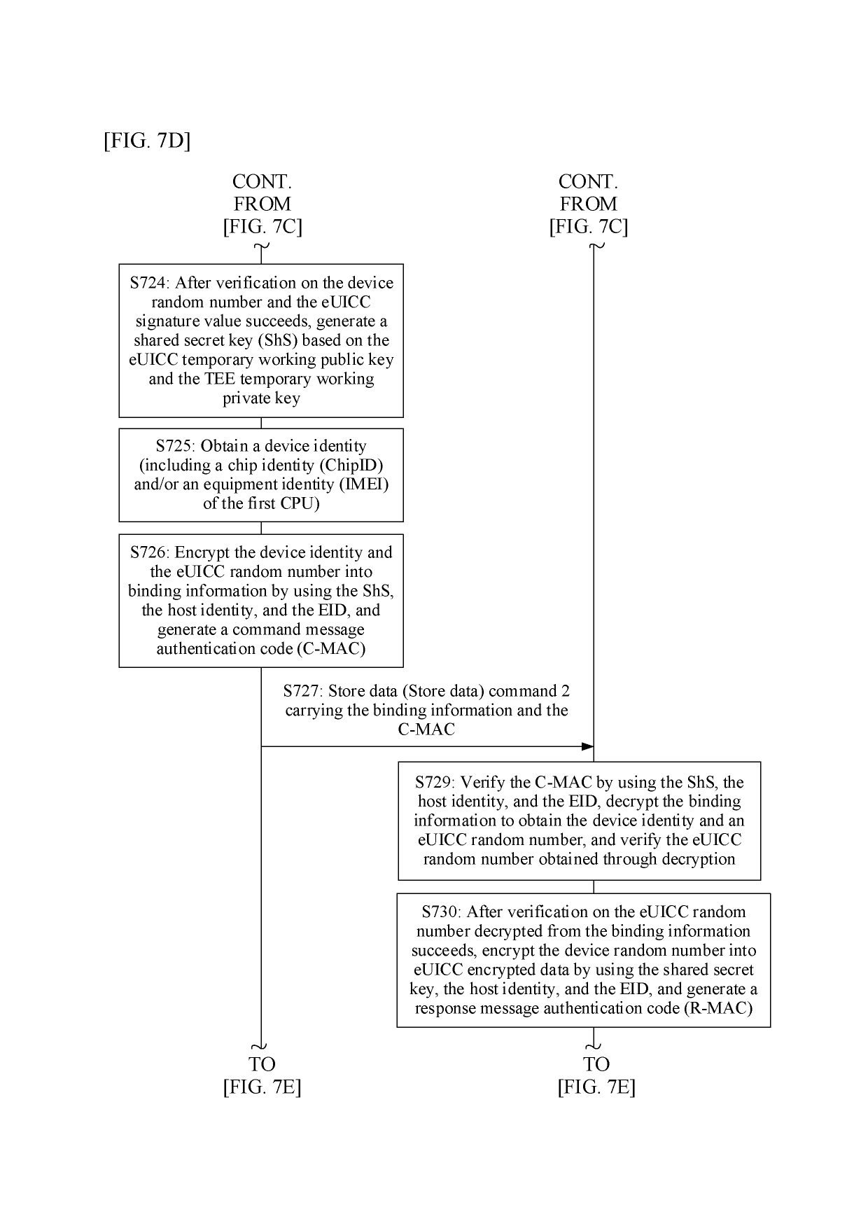

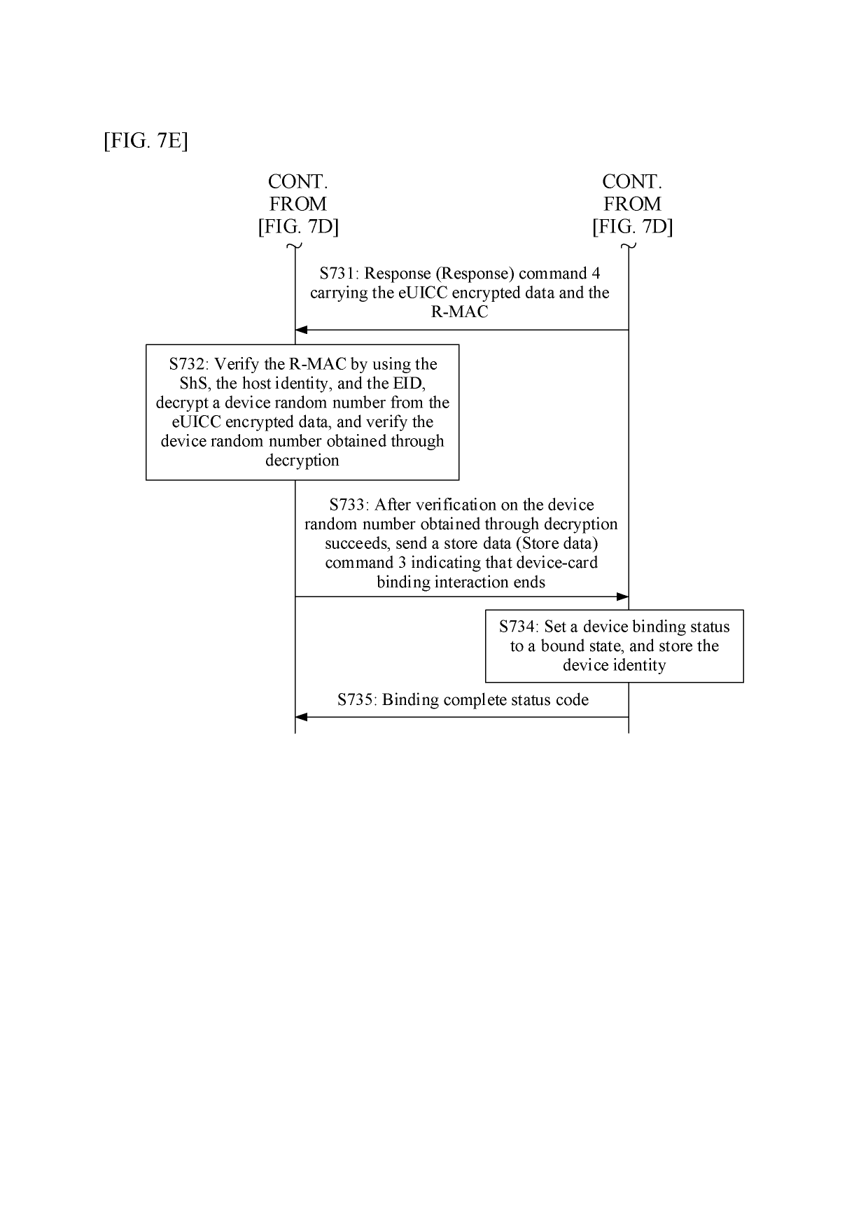

FIG. 7A to FIG. 7E are a schematic flowchart of signaling interaction for device-card binding in an eSIM authentication method according to an embodiment of this application.

The eSIM authentication method may be applied to a first electronic device including a first CPU, a first modem, and an eSIM module. An REE and a TEE may run in the first CPU. An LPA and an encryption/decryption CA may run in the REE, and an encryption/decryption TA may run in the TEE. For specific descriptions of the REE and the TEE, refer to the embodiments shown in FIG. 2 to FIG. 4. Details are not described herein again.

As shown in FIG. 7A to FIG. 7E, the device-card binding signaling interaction procedure in the eSIM authentication method may include the following steps.

S701: The first CPU detects that ROM upgrade is completed.

After detecting that the ROM upgrade is completed, the LPA may invoke a system upgrade management (OsUpdateManager) module to upgrade a patch of the eSIM module.

S702: The eSIM module detects that the patch upgrade is completed.

After the ROM upgrade is completed, the TEE running in the first CPU may manage a TEE certificate and an authentication root certificate (CERT.CI.ECDSA). The authentication root certificate is a root certificate of an EUM certificate in the eSIM module, and the EUM certificate is a root certificate of an eUICC certificate. In other words, the EUM certificate is signed by using a private key corresponding to the authentication root certificate, and the eUICC certificate is signed by using a private key corresponding to the EUM certificate.

In a possible implementation, the TEE certificate may include a device certificate and a terminal certificate (CERT.OEM.ECDSA). The terminal certificate is signed by using a device private key corresponding to the device certificate, the device certificate is signed by using a terminal vendor root private key corresponding to the terminal vendor root certificate, and the terminal vendor root certificate is self-signed by using the terminal vendor root private key corresponding to the terminal vendor root certificate. In this case, after the patch upgrade is completed, the eSIM module may store the terminal vendor root certificate. The eSIM module may verify the TEE certificate by using the terminal vendor root certificate.

In a possible implementation, the TEE certificate may include the terminal vendor root certificate. The terminal vendor root certificate is self-signed by using the terminal vendor root private key corresponding to the terminal vendor root certificate. In this case, after the patch upgrade is completed, the eSIM module may store the terminal vendor root certificate. Because the TEE certificate managed by the TEE includes only the terminal vendor root certificate, the LPA does not need to send the terminal vendor root certificate to the eSIM module for verification, and the eSIM module may directly perform self-verification on the stored terminal vendor root certificate.

In subsequent embodiments of this application, an example in which the device certificate includes the terminal vendor root certificate and the LPA does not need to send the terminal vendor root certificate to the eSIM module for verification is used for description.

After the patch upgrade is completed, the terminal vendor root certificate, the authentication root certificate (CERT.CI.ECDSA), the EUM certificate, the eUICC certificate, the EUM private key corresponding to the EUM certificate, and an eUICC private key (SK.eUICC.ECDSA) corresponding to the eUICC certificate may be stored in the eSIM module. The terminal vendor root certificate includes the terminal vendor root public key, the authentication root certificate (CERT.CI.ECDSA) includes an authentication root public key (PK.CI.ECDSA), the EUM certificate includes an EUM public key, and the eUICC certificate includes an eUICC public key (PK.eUICC.ECDSA). The EUM certificate has been signed by using an authentication root private key corresponding to the authentication root certificate (CERT.CI.ECDSA). The EUM certificate has been signed by using the EUM private key corresponding to the EUM certificate.

In a possible implementation, step S701 and step S702 are optional. The first CPU may complete subsequent step S703 to step S735 when the first electronic device is powered on for a first time after delivery.

S703: The eSIM module may send a refresh command to the first modem.

The refresh command may be a proactive command.

S704: The first modem powers on the eSIM module.

After receiving the refresh command, the first modem may power on the eSIM module again.

S705: After powering on (power on) the eSIM module, the first modem sends a reset command to the eSIM module.

After the patch upgrade is completed, the eSIM module may set a value of a bound device tag to an initial value. For example, the value of the bound device tag may be set to "0x00".

The bound device tag indicates a device binding status of the eSIM module. When the value of the bound device tag is the initial value, it indicates that the eSIM module is in an unbound state.

S706: The eSIM module may detect that the eSIM module does not complete device-card binding.

After the reset, the eSIM module may detect, by using the bound device tag, that the eSIM module does not complete device-card binding.

S707: The eSIM module may send an answer to reset (ATR) to the first modem.

The ATR indicates that the reset of the eSIM module is completed.

S708: The first CPU may open a logical channel (open channel) with the eSIM module.

After the first modem receives the ATR, the first modem may complete a necessary device-card interaction procedure with the eSIM module.

The first modem may trigger the LPA to invoke device-card binding logic, to open the logical channel between the LPA and the eSIM module.

S709: The first CPU may send an electronic identity obtaining (GetEID) command to the eSIM module.

The LPA may determine whether an electronic identity (EID) of the eSIM module has been obtained. If the EID of the eSIM module has not been obtained, the LPA may send a GetEID command to the eSIM module, to obtain the EID of the eSIM module. If the EID of the eSIM module has been obtained, the LPA does not need to send the GetEID command to the eSIM module.

S710: After receiving the electronic identity obtaining command, the eSIM module may return a response command 1 to the first CPU. The response command 1 carries the EID.

For example, the response command 1 may be "BF3312 5A10 12345634202200001234512345112233". The EID is "12345634202200001234512345112233".

S711: The first CPU may send an eUICC random number obtaining (GeteUICCChallenge) command to the eSIM module.

The LPA may send the eUICC random number obtaining command to the eSIM module, to obtain an eUICC random number (eUICCChallenge).

S712: After receiving the eUICC random number obtaining command, the eSIM module may return a response command 2 to the first CPU. The response command 2 may carry an eUICC random number (eUICCChallenge).

For example, the response command 2 may be "BF2312 8010 76543212BE97D30B2D1FBECA7B7A9668". The eUICC random number may be "76543212BE97D30B2D1FBECA7B7A9668".

S713: The first CPU may generate a TEE temporary working public key (otPK.TEE.ECKA), a TEE temporary working private key (otSK.TEE.ECKA), a device random number (deviceChallenge), and a host identity (HostID).

The LPA may invoke the encryption/decryption CA, and invoke the encryption/decryption TA through the encryption/decryption CA to generate the TEE temporary working public key, the TEE temporary working private key, and the device random number (deviceChallenge). The TEE temporary working public key and the TEE temporary working private key may meet the public and private key standard "ECC-256".

The host identity (HostID) may indicate an identity of an initiator of a session currently set up on the logical channel between the LPA and the eSIM module.

S714: The first CPU may generate TEE package data. The TEE package data includes the TEE temporary working public key, the device random number, the eUICC random number, and the host identity.

The LPA may invoke the encryption/decryption CA, and invoke the encryption/decryption TA through the encryption/decryption CA to generate the TEE package data.

S715: The first CPU may sign the TEE package data by using a TEE private key (SK.TEE.ECKA), to obtain a TEE signature value (serverSignature).

The LPA may invoke the encryption/decryption CA, and invoke the encryption/decryption TA through the encryption/decryption CA to sign the TEE package data by using the TEE private key (SK.TEE.ECDSA), to obtain the TEE signature value (serverSignature).

For example, the TEE package data may sequentially include the eUICC random number, the device random number, the host identity, and the TEE temporary working public key from front to back.

Specifically, the encryption/decryption TA may first perform a hash operation on the TEE package data, to obtain digest information of the TEE package data. Then, the encryption/decryption TA may encrypt the digest information of the TEE package data into the TEE signature value (serverSignature) by using the TEE private key (SK.TEE.ECDSA) and a specified signature algorithm (for example, an ECDSA signature algorithm).

In a possible implementation, the TEE private key (SK.TEE.ECDSA) may be an OEM private key (SK.OEM.ECDSA) corresponding to the terminal certificate (CERT.OEM.ECDSA) in the foregoing embodiment, the TEE public key (PK.TEE.ECDSA) paired with the TEE private key (SK.TEE.ECDSA) may be used as the OEM public key in the terminal certificate (CERT.OEM.ECDSA) in the foregoing embodiment. (PK.OEM.ECDSA).

In a possible implementation, the TEE private key (SK.TEE.ECDSA) may be the terminal vendor root private key (SK.OEMCI.ECDSA) corresponding to the terminal vendor root certificate in the foregoing embodiment. The TEE public key (PK.TEE.ECDSA) paired with the TEE private key (SK.TEE.ECDSA) may be used as the terminal vendor root public key (PK.OEMCI.ECDSA) in the terminal vendor root certificate in the foregoing embodiment.

S716: The first CPU may send a store data command 1 to the eSIM module. The store data command 1 carries TEE signature data, and the TEE signature data may include the TEE package data and the TEE signature value.

For example, the store data command 1 may be:

"80E29211XX

6F800281XX

30 XX

8210 [eUICCChallenge]

8211 [deviceChallenge]

8330 [HostID]

3F4333 [otPK.TEE.ECKA]

3F2444 [serverSignature] ".

S717: After receiving the store data command 1, the eSIM module may verify the TEE signature value in the TEE signature data and the eUICC random number by using the TEE public key (PK.TEE.ECDSA) in the stored TEE certificate.

The eSIM module may first decrypt digest information A from the TEE signature value by using the TEE public key. Then, the eSIM module may perform a hash operation on the TEE package data, to generate digest information B. The eSIM module may determine whether the digest information A is the same as the digest information B. If the digest information A is the same as the digest information B, verification on the TEE signature value succeeds. If the digest information A is different from the digest information B, verification on the TEE signature value fails.

After verification on the TEE signature succeeds, the eSIM module may determine whether the eUICC random number in the TEE package data is the same as the eUICC random number previously generated by the eSIM module. If the eUICC random number in the TEE package data is the same as the eUICC random number previously generated by the eSIM module, verification on the eUICC random number succeeds. If the eUICC random number in the TEE package data is different from the eUICC random number previously generated by the eSIM module, verification on the eUICC random number fails.

When verification on the TEE signature value fails and/or verification on the eUICC random number fails, the eSIM module terminates subsequent steps.

S718: After verification on the TEE signature value and the eUICC random number succeeds, the eSIM module may generate an eUICC temporary working public key (ot.PK.EUICC.ECKA) and an eUICC temporary working private key (ot.SK.EUICC.ECKA).

S719: The eSIM module may generate eUICC package data. The eUICC package data may include the eUICC temporary working public key and a device random number (deviceChallenge).

S720: The eSIM module may sign the eUICC package data by using the eUICC private key (SK.eUICC.ECDSA), to obtain an eUICC signature value.

For example, the eUICC package data may be sequentially the device random number and the eUICC temporary working public key from front to back.

The eSIM module may first perform a hash operation on the eUICC package data, to obtain digest information of the eUICC package data. Then, the eSIM module may encrypt the digest information of the eUICC package data into the eUICC signature value (eUICCSignature) by using the eUICC private key (SK.eUICC.ECDSA) and a specified signature algorithm (for example, the ECDSA signature algorithm).

S721: The eSIM module may send a response command 3 to the first CPU. The response command 3 carries the eUICC signature data, the EUM certificate (CERT.EUM.ECDSA), and the eUICC certificate (CERT.eUICC.ECDSA).

The eUICC signature data may include the eUICC package data and the eUICC signature value.

For example, the response command 3 may be:

"6F8002 82XXX

A082XXXX

30 XX

8211 [deviceChallenge]

3F5031 [ot.PK.EUICC.ECKA]

3F5032 [eUICCSignature]

1082XXXX [CERT.eUICC.ECDSA]

1082YYYY [CERT.EUM.ECDSA]

"

The response command 3 carries a large amount of content, which exceeds a specific quantity (for example, 255 bytes). The first modem may continuously send a get response command based on a state word (SW) returned by the eSIM module, to obtain the entire response command 3. The first modem may send all content of the response command 3 to the LPA.

S722: After receiving the response command 3, the first CPU may verify validity of the EUM certificate and the eUICC certificate by using the authentication root public key (PK.CI.ECDSA) in the stored authentication root certificate.

Specifically, the LPA may invoke the encryption/decryption CA, and invoke the encryption/decryption TA through the encryption/decryption CA to verify the EUM certificate and the eUICC certificate by using the authentication root public key (PK.CI.ECDSA) in the stored authentication root certificate. The encryption/decryption TA may first decrypt digest information 5 of the EUM certificate from a certificate signature of the EUM certificate by using the authentication root public key in the authentication root certificate. Then, the encryption/decryption TA may perform a hash operation on certificate content of the EUM certificate, to obtain digest information 6. If the digest information 5 is the same as the digest information 6, the encryption/decryption TA may determine that the validity of the EUM certificate succeeds. If the digest information 5 is different from the digest information 6, the encryption/decryption TA may determine that the validity of the EUM certificate fails.

After verification on the validity of the EUM certificate succeeds, the encryption/decryption TA may decrypt digest information 7 of the eUICC certificate from a certificate signature of the eUICC certificate by using the EUM public key in the EUM certificate. Then, the encryption/decryption TA may perform a hash operation on certificate content of the eUICC certificate, to obtain digest information 8. If the digest information 7 is the same as the digest information 8, the encryption/decryption TA may determine that the validity of the eUICC certificate succeeds. If the digest information 7 is different from the digest information 8, the encryption/decryption TA may determine that the validity of the eUICC certificate fails.

S723: After verification on the validity of the EUM certificate and the eUICC certificate succeeds, the first CPU may verify the device random number and the eUICC signature value by using the eUICC public key in the eUICC certificate.

The encryption/decryption TA may decrypt digest information C from the eUICC signature value by using the eUICC public key (PK.EUICC.ECDSA). Then, the encryption/decryption TA may perform a hash operation on the eUICC package data, to generate digest information D. The encryption/decryption TA may determine whether the digest information C is the same as the digest information D. If the digest information C is the same as the digest information D, verification on the eUICC signature value succeeds. If the digest information C is different from the digest information D, verification on the eUICC signature value fails.

After verification on the eUICC signature succeeds, the encryption/decryption TA may determine whether the device random number in the eUICC package data is the same as the device random number previously generated by the encryption/decryption TA. If the device random number in the eUICC package data is the same as the device random number previously generated by the encryption/decryption TA, verification on the device random number succeeds. If the device random number in the eUICC package data is different from the device random number previously generated by the encryption/decryption TA, verification on the device random number fails.

When verification on the eUICC signature value fails and/or verification on the device random number fails, the encryption/decryption TA terminates subsequent steps.

S724: After verification on the device random number and the eUICC signature value succeeds, the first CPU generates the shared secret key (ShS) based on the eUICC temporary working public key and the TEE temporary working private key.

The LPA may invoke the encryption/decryption TA, and the encryption/decryption TA may generate the ShS based on the eUICC temporary working public key and the TEE temporary working private key through a "TEE DeriveKey" interface.

S725: The first CPU may obtain a device identity. The device identity may include a chip identity (ChipID), an equipment identity (IMEI), and/or the like of the first CPU.

For example, the LPA may invoke a file stream "read" interface to read a storage path of "/sys/devices/soc0/serial number", to obtain the chip identity (chipID) of the first CPU.

S726: The first CPU may encrypt the device identity and the eUICC random number into binding information by using the ShS, the host identity, and the EID, and generate a command message authentication code (C-MAC).

S727: The first CPU may send a store data command 2 to the eSIM module. The store data command 2 may carry the binding information and the C-MAC.

The encryption/decryption TA may derive an initial message authentication code chaining value (Initial MAC chaining value), a session encryption key (S-ENC), and a session message authentication code (S-MAC) based on the ShS, the host identity, and the EID according to the "BSI TR-03111 X9.63 Key Derivation Function" standard rule.

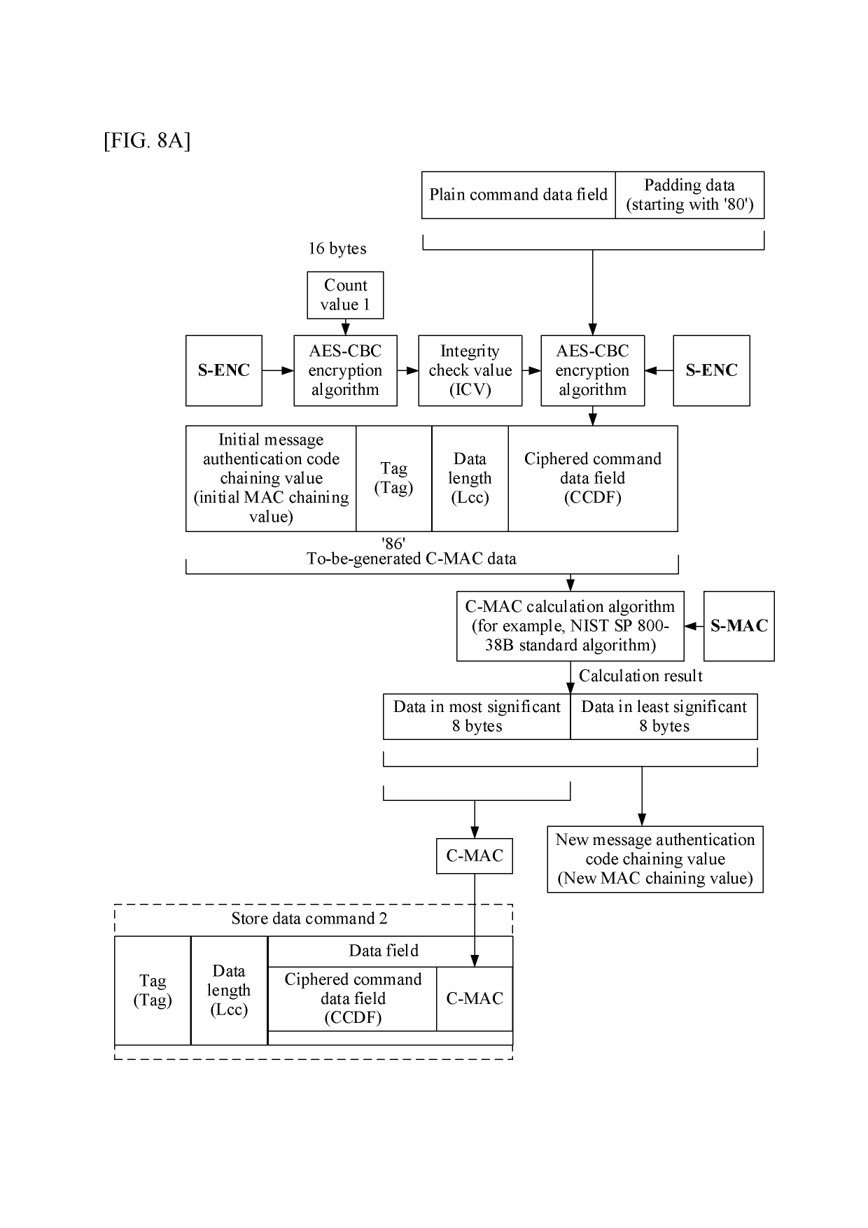

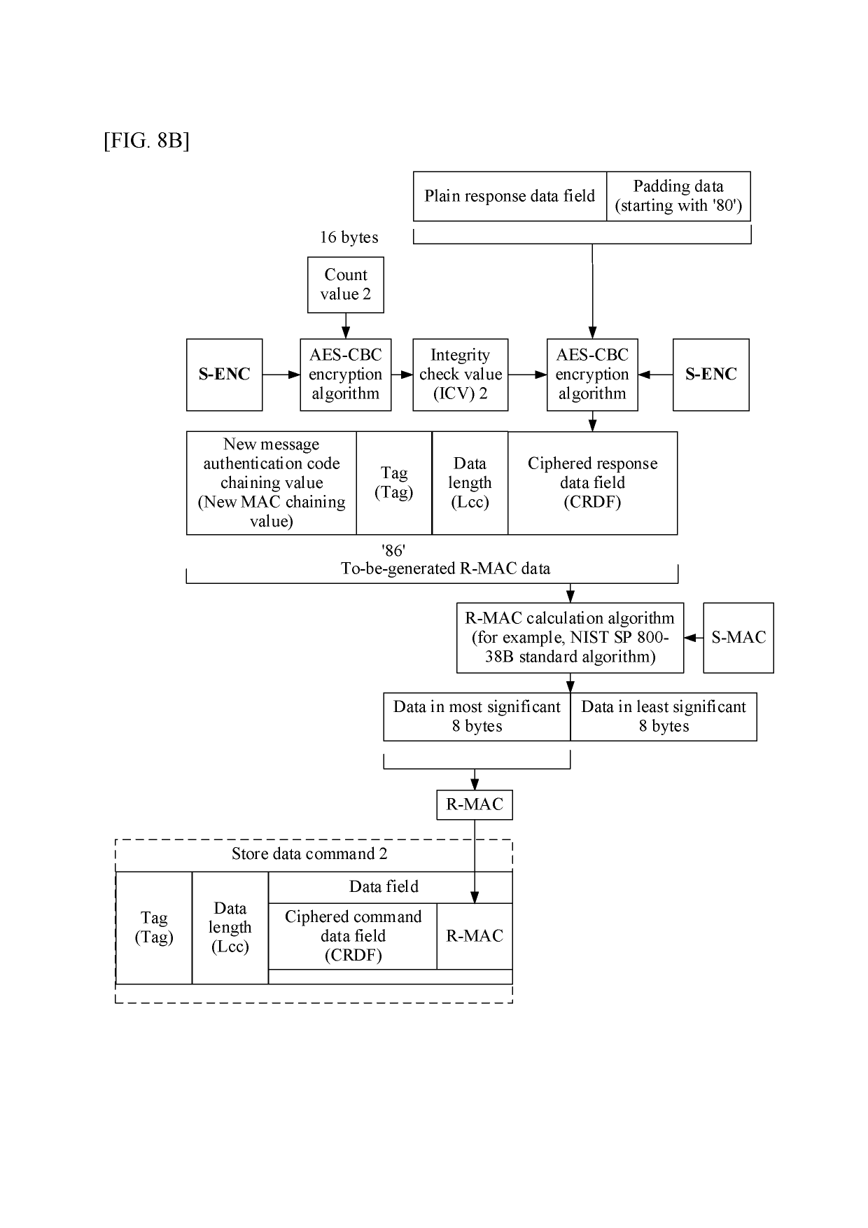

As shown in FIG. 8A, a process of encrypting a plain command data field in the store data command may be as follows:

1. The encryption/decryption TA may generate the plain command data field based on the device identity and the eUICC random number.

For example, the plain command data field may be:

"6F8002 XX

[device identity in a TLV format]

[eUICC random number in the TLV format]".

2. The encryption/decryption TA may add padding data after the plain command data field, so that a total length of the plain command data field and the padding data is an integer quantity of bytes. The padding data may start with "80".

3. The encryption/decryption TA may determine an integrity check value (ICV) 1 based on a count value 1 and the S-ENC according to an AES-CBC encryption algorithm. A length of the count value 1 may be 16 bytes.

4. The encryption/decryption TA may determine a ciphered command data field (CCDF) based on the plain command data field to which the padding data is added, the integrity check value 1, and the S-ENC according to an AEC-CBC encryption algorithm. The ciphered command data field is the binding information.

5. The encryption/decryption TA may add a data length (Lcc) field before the ciphered command data field, add a tag before the data length field, and add an initial MAC chaining value before the tag, to obtain to-be-generated C-MAC data.

6. The encryption/decryption TA may determine C-MAC signature data based on the to-be-generated C-MAC data and the S-MAC according to a C-MAC calculation algorithm, and use data in most significant 8 bytes and data in least significant 8 bytes in the C-MAC signature data as a new message authentication code chaining value (New MAC chaining value). The C-MAC calculation algorithm may be the "NIST SP 800-38B" standard algorithm.

7. The encryption/decryption TA may extract the data in the most significant 8 bytes from the C-MAC signature data as the C-MAC.

8. The encryption/decryption TA may return the C-MAC and the ciphered command data field (CCDF) to the LPA through the encryption/decryption CA.

9. After receiving the C-MAC and the ciphered command data field (CCDF), the LPA may assemble the store data command 2. The store data command 2 may include a tag, a data length field, and a data field. A value of the tag may be "86", and when the value of the tag may be "86", it may indicate that a data structure following the tag in the store data command 2 is a TLV data grid structure that meets a requirement of the GSMA specification. The data length field indicates a length of the data field. The data field of the store data command 2 may include the ciphered command data field (CCDF) and the C-MAC. The ciphered command data field (CCDF) of the store data command 2 is the binding information.

S728: After sending the response command 3 to the first CPU, the eSIM module may generate the ShS based on the TEE temporary working public key and the eUICC temporary working private key.

S729: After obtaining the store data command 2, the eSIM module may verify the C-MAC by using the ShS, the host identity, and the EID, decrypt the binding information to obtain the device identity and an eUICC random number, and verify the eUICC random number obtained through decryption.

The eSIM module may derive the initial MAC chaining value, the S-ENC, and the S-MAC based on the ShS, the host identity, and the EID according to the "BSI TR-03111 X9.63 Key Derivation Function" standard rule.

Then, the eSIM module adds, after the initial MAC chaining value, the tag, the data length field, and the command ciphertext that are in the storage data command 2, to form MAC check information, and re-determines a C-MAC based on the MAC check information and the S-MAC according to the C-MAC calculation algorithm. The eSIM module may determine whether the re-determined C-MAC is the same as the C-MAC carried in the store data command 2. If the re-determined C-MAC is the same as the C-MAC carried in the store data command 2, check on the C-MAC succeeds. The eSIM module may decrypt the device identity and the eUICC random number from the ciphered command data field (namely, the binding information) in the store data command 2 based on the S-ENC and the S-MAC.

The eSIM module may determine whether the eUICC random number decrypted from the store data command 2 is the same as the eUICC random number previously generated by the eSIM module. If the eUICC random number decrypted from the store data command 2 is the same as the eUICC random number previously generated by the eSIM module, verification on the eUICC random number succeeds. If the eUICC random number decrypted from the store data command 2 is different from the eUICC random number previously generated by the eSIM module, verification on the eUICC random number fails.

S730: After verification on the eUICC random number decrypted from the binding information succeeds, the eSIM module encrypts the device random number into eUICC encrypted data by using the shared secret key, the host identity, and the EID, and generates a response message authentication code (R-MAC).

S731: The eSIM module may send a response command 4 to the first CPU. The response command 4 carries the eUICC encrypted data and the R-MAC.

As shown in FIG. 8B, a process of encrypting a plain response data field of the response command 4 may be as follows:

1. The eSIM module may assemble the plain response data field of the response command 4 based on the device random number.

For example, the plain response data field may be:

"6F8002 XX

[device random number in a TLV format]

"

2. The eSIM module may add padding data after the plain response data field, so that a total length of the plain response data field and the padding data is an integer quantity of bytes. The padding data may start with "80".

3. The eSIM module may determine an integrity check value (ICV) 2 based on a count value 2 and the S-ENC according to the AES-CBC encryption algorithm. A length of the count value 2 may be 16 bytes.

4. The eSIM module may determine a ciphered response data field (CRDF) based on the plain response data field to which the padding data is added, the integrity check value 2, and the S-ENC according to the AEC-CBC encryption algorithm. The ciphered response data field is the eUICC encrypted data.

5. The eSIM module may add a data length (Lcc) field before the ciphered response data field, add a tag before the data length field, and add a new MAC chaining value before the tag, to obtain to-be-generated R-MAC data.

6. The eSIM module may determine R-MAC signature data based on the to-be-generated R-MAC data and the S-MAC according to an R-MAC calculation algorithm, and use data in most significant 8 bytes in the R-MAC signature data as an R-MAC. The R-MAC calculation algorithm may be the "NIST SP 800-38B" standard algorithm.

7. The eSIM module may assemble the response command 4. The response command 4 may include a tag, a data length field, and a data field. The data field in the response command 4 may include the ciphered response data field (CRDF) and the R-MAC. The data length field indicates a length of the data field, and the ciphered response data field (CRDF) in the response command 4 is the eUICC encrypted data.

S732: The first CPU verifies the R-MAC by using the ShS, the host identity, and the EID, decrypts a device random number from the eUICC encrypted data, and verifies the device random number obtained through decryption.

The LPA may invoke the encryption/decryption TA to verify the R-MAC, decrypt the device random number from the eUICC encrypted data, and verify the device random number obtained through decryption.

For a process in which the encryption/decryption TA verifies the R-MAC, refer to the foregoing process in which the eSIM module verifies the C-MAC. Details are not described herein again.

S733: After verification on the device random number obtained through decryption succeeds, the first CPU sends a store data command 3 to the eSIM module. The store data command 3 indicates that the device-card binding interaction ends.

The store data command 3 includes a tag, a data length field, and a data field. The data field in the store data command 3 includes a ciphered end indication obtained by encrypting a plain end indication (for example, "0F6001 03 03") and the C-MAC.

For a process of obtaining the ciphered end indication through encryption and a process of generating the C-MAC in the store data command 3, refer to the process of obtaining the ciphered command data field through encryption and the process of generating the C-MAC in the embodiment shown in FIG. 8A. A count value used in the process of obtaining the ciphered end indication through encryption is obtained by increasing the count value 1 shown in FIG. 8A by 1.

S734: After receiving the store data command 3, the eSIM module sets the device binding status to a bound state, and stores the device identity.

After receiving the store data command 3, the eSIM module may verify the C-MAC in the store data command 3, and decrypt the ciphered end indication in the store data command 3 after verification on the C-MAC in the store data command 3 succeeds, to obtain the plain end indication (for example, "0F6001 0303").

After obtaining the plain end indication, the eSIM module may set the value of the bound device tag to a first value (for example, "0x12"). When the value of the bound device tag is the first value, it indicates that the eSIM module is in the bound state.

When the eSIM module completes the device-card binding, to improve compatibility, it may be considered by default that the device-card check succeeds. The eSIM module may further reset a binding information check tag to a second value (for example, "0x44"). When a value of the binding information check tag is a second value, it indicates that check performed by the eSIM module on the binding information is completed.

S735: The eSIM module returns a binding complete status code to the first CPU. The binding complete status code indicates that the device-card binding is completed.

The eSIM module may return the binding complete status code to the LPA by using status words SW1 and SW2. For example, values of SW1 and SW2 may be 9000.

In some embodiments, steps S701 and S702 are optional, and step S703 to step S735 may be performed on a production line before delivery of the electronic device.

The following specifically describes, with reference to signaling, a device-card verification procedure in the eSIM authentication method provided in embodiment of this application.

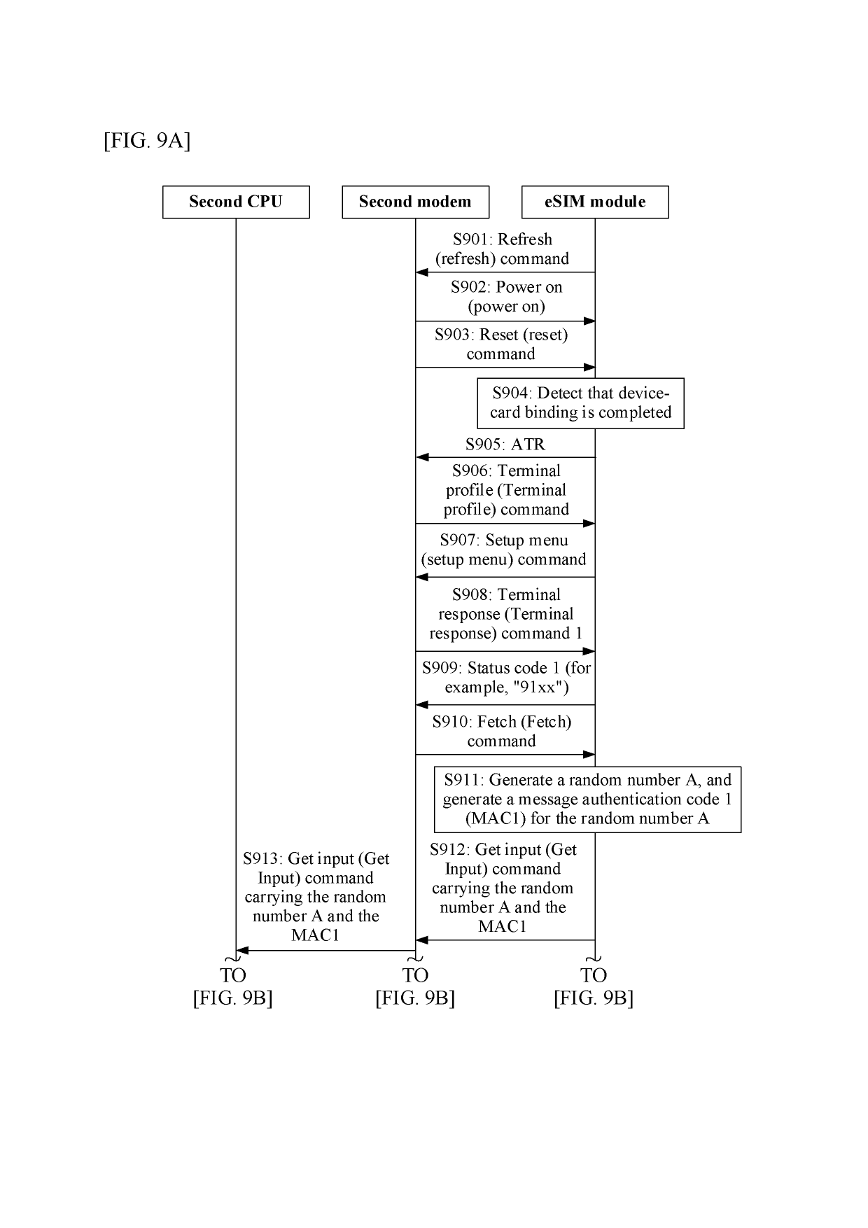

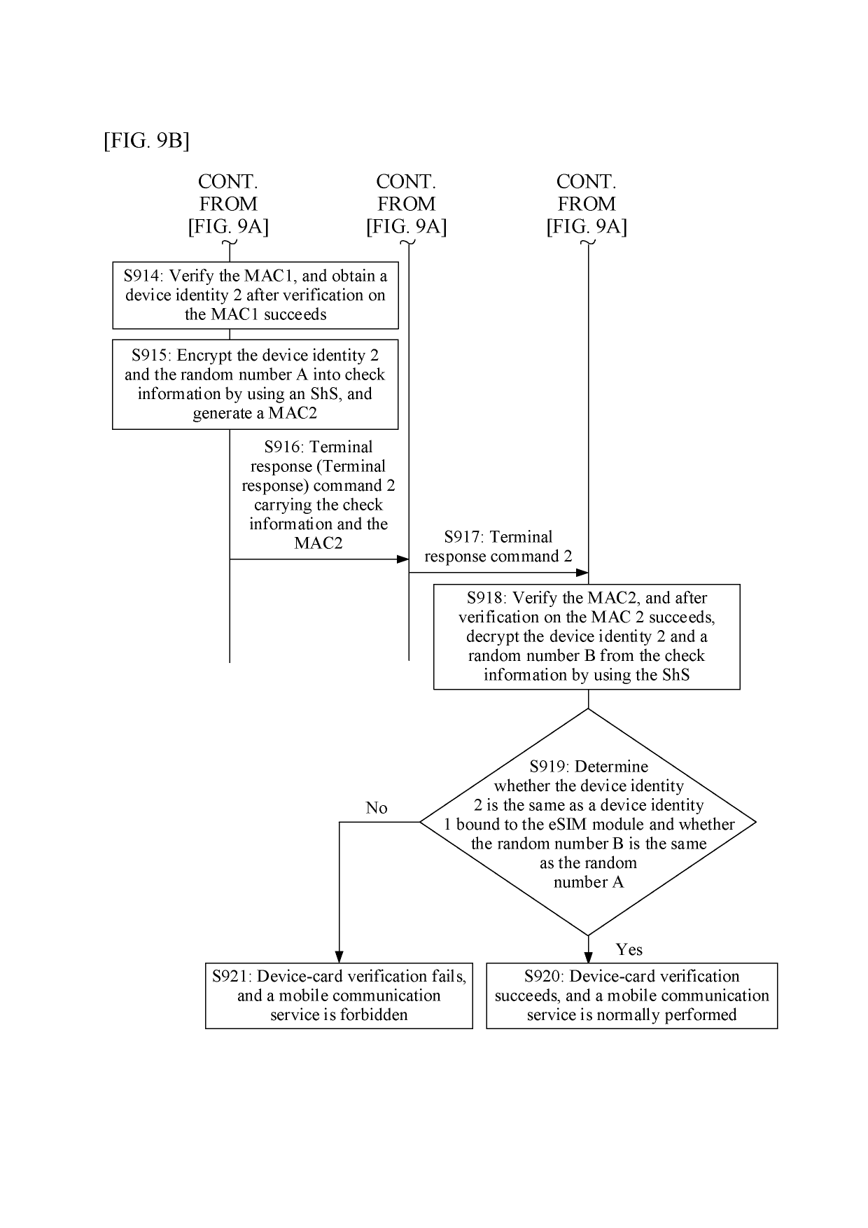

FIG. 9A and FIG. 9B are a schematic flowchart of signaling interaction for device-card verification in an eSIM authentication method according to an embodiment of this application.

The eSIM authentication method may be applied to a second electronic device including a second CPU, a second modem, and an eSIM module. An REE and a TEE may run in the second CPU. A Cat service and an encryption/decryption CA may run in the REE, and an encryption/decryption TA may run in the TEE. For specific descriptions of the REE and the TEE, refer to the embodiments shown in FIG. 2 to FIG. 4. Details are not described herein again.

As shown in FIG. 9A and FIG. 9B, the device-card verification signaling interaction procedure in the eSIM authentication method may include the following steps.

S901: The eSIM module sends a refresh command to the second modem.

The refresh command may be a proactive command.

S902: The second modem powers on the eSIM module.

After receiving the refresh command, the second modem may power on the eSIM module again.

S903: After powering on the eSIM module, the second modem sends a reset command to the eSIM module.

S904: The eSIM module may detect that the eSIM module has completed device-card binding.

After receiving the reset command, the eSIM module may complete a reset operation, and detect, by using a bound device tag, that the device-card binding is completed.

S905: The eSIM module may send an ATR to the second modem.

The ATR indicates that the reset of the eSIM module is completed.

S906: The second modem may send a terminal profile command to the eSIM module.

S907: The eSIM module may send a setup menu command to the second modem.

S908: The second modem may send a terminal response command 1 to the eSIM module.

S909: The eSIM module sends a status code 1 (for example, "91xx") to the second modem.

The status code 1 may be used to request the modem to send a fetch command to the eSIM module, to obtain a get input command from the eSIM module.

S910: The second modem may send the fetch command to the eSIM module.

S911: The eSIM module may generate a random number A, and generate a message authentication code 1 (MAC1) for the random number A.

The eSIM module may perform MAC calculation on the random number A based on the S-MAC derived by using the ShS and the C-MAC calculation algorithm (for example, the NIST SP 800-38B standard algorithm), and use data in most significant 8 bytes in a calculation result as the MAC1.

S912: The eSIM module may send the get input command to the second modem. The get input command may carry the random number A and the MAC1.

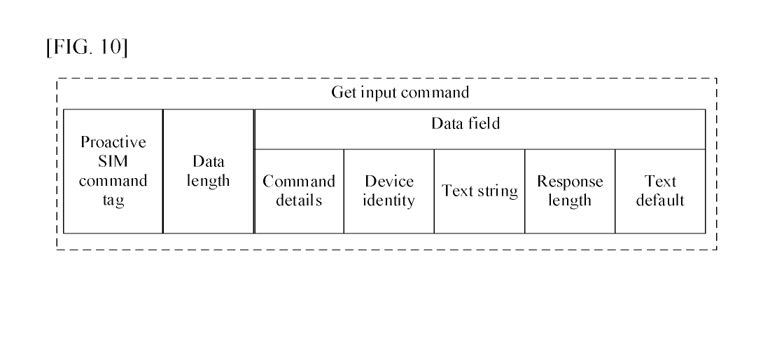

As shown in FIG. 10, the get input command may include a proactive SIM command tag (proactive SIM command tag), a data length field, and a data field. The proactive SIM command tag may be used for a type of the get input command. For example, the proactive SIM command tag in the get input command may be "D0". The data length field may indicate a data length of the data field. The data field may include a command details field, a device identity field, a text string field, a response length field, and a text default field.

The text string field may include a text string tag, a text string length field, a text string encoding scheme field, and a text string data field. The text string tag may be used to tag a start location of the text string field. The text string length field may indicate a total data length of a data encoding scheme field and the text string data field. The text string encoding scheme field may indicate an encoding scheme of the text string data field.

The text default field may include a text default tag, a text default length field, the data encoding scheme field, and a text default data field. The text default tag may be used to tag a start location of the text default field. The text default length field may indicate a total data length of the text default encoding scheme field and the text default data field. The text default encoding scheme field may indicate an encoding scheme of the text default data field.

The random number A and the MAC1 may be carried in the text default data field of the text default field in the get input command, and the text string data field of the text string field may include a specified character string (for example, an ASCII code of "Verify"). The ASCII code of the character string "Verify" may be "566572696679".

For example, values of fields in the get input command may be specifically shown as follows:

The proactive SIM command tag may be "D0".

A value of the data length field may be "XX".

A value of the command details field may be "8103012311".

A value of the device identity field may be "82028122".

A value of the text string field may be "0D0E01 566572696679".

A value of the response length field may be "6102FFFF".

A value of the text default field may be "970901 [random number A] [MAC1]".

In a possible implementation, the random number A and the MAC1 may alternatively be carried in the text string data field of the text string field in the get input command. This is not limited herein.

S913: The second modem sends the get input command to the second CPU. The get input command carries the random number A and the MAC1.

After receiving the get input command, the Cat service running in the second CPU parses a data structure of the get input command by using a command parameter proxy class (CommandParamsFactory). After the command parameter proxy class parses a specified character string (for example, an ASCII code of "VerifyBinding") from the text string data field of the text string field in the get input command, the Cat service may parse the text default field in the get input command.

S914: The second CPU verifies the MAC1, and obtains a device identity 2 after verification on the MAC1 succeeds.

The Cat service may invoke the encryption/decryption CA, and then verify the MAC1 through the encryption/decryption TA. For verification on the MAC1, refer to the process of checking the C-MAC or the R-MAC in the embodiment shown in FIG. 7A to FIG. 7E. Details are not described herein again.

After verification on the MAC1 succeeds, the Cat service may obtain the random number A from the text default field and provide the random number A for the encryption/decryption TA.

S915: The second CPU encrypts the device identity 2 and the random number A into check information by using an ShS, and generates a MAC2.

The Cat service may invoke the encryption/decryption TA to derive an S-ENC, an S-MAC, and an initial MAC chaining value by using the ShS, encrypt the device identity 2 and the random number A into the check information, and generate the MAC2. For a process of encrypting the device identity 2 and the random number A and generating the MAC2, refer to the process of encrypting and generating the C-MAC in the embodiment shown in FIG. 8A. Details are not described herein again.

S916: The second CPU sends a terminal response command 2 to the second modem. The terminal response command 2 carries the check information and the MAC2.

S917: The second modem sends the terminal response command 2 to the eSIM module.

S918: After receiving the terminal response command 2, the eSIM module verifies the MAC2, and after verification on the MAC 2 succeeds, decrypts the device identity 2 and a random number B from the check information by using the ShS.

For a process in which the eSIM module verifies the MAC2, refer to the process in which the eSIM module verifies the C-MAC in step S729 in the embodiment shown in FIG. 7D. Details are not described herein again.

S919: The eSIM module determines whether the device identity 2 is the same as the device identity 1 bound to the eSIM module and whether the random number B is the same as the random number A.

S920: If the device identity 2 is the same as the device identity 1 bound to the eSIM module, and the random number B is the same as the random number A, device-card verification succeeds, and the eSIM module normally performs a mobile communication service.

If the device-card verification succeeds, the eSIM module may set a value of a binding information check tag to a second value (for example, "0x44"). When the value of the binding information check tag is set to the second value (for example, "0x44"), it indicates that device-card check on the eSIM module succeeds.

If the device-card verification succeeds, the eSIM module may set the value of the binding information check tag to a third value (for example, "0x66"). When the value of the binding information check tag is set to the third value (for example, "0x66"), it indicates that device-card check on the eSIM module fails.

S921: If the device identity 2 is different from the device identity 1 bound to the eSIM module or the random number B is different from the random number A, device-card verification fails, and the eSIM module is forbidden from performing a mobile communication service.

For example, when the eSIM module triggers a network camping authentication procedure, the eSIM module may determine whether the binding information check tag indicates that the device-card check is completed and the device-card check succeeds. If the binding information check tag indicates that the device-card check is completed and the device-card check succeeds (for example, the value of the binding information check tag is "0x44"), it indicates that the eSIM module completes the network camping authentication procedure. If the binding information check tag indicates that the device-card check fails, the eSIM module returns a check failure response to the second modem. The check failure response indicates that the eSIM module is not an eSIM bound to the second CPU.

In this embodiment of this application, if the device-card verification succeeds, it indicates that the second CPU and the first CPU in the embodiment shown in FIG. 7A to FIG. 7E are a same CPU, and the first electronic device is the same as the second electronic device.

If the device-card verification fails, it indicates that the second CPU and the first CPU in the embodiment shown in FIG. 7A to FIG. 7E are not a same CPU, the second electronic device and the first electronic device are different, and for the eSIM module, the second electronic device is not bound to the eSIM module.

In a possible implementation, if the eSIM module does not receive, after sending a device identity obtaining request to the second CPU, check information sent by the second CPU, the device-card verification fails, and the eSIM module is forbidden from performing the mobile communication service.

In a possible implementation, if the eSIM module detects that the device-card verification fails for a specified quantity of times (for example, three times), the eSIM module is permanently locked.

According to the eSIM authentication method provided in this embodiment of this application, the first CPU and the eSIM module in the first electronic device may first agree on the shared key after an occasion like system upgrade or first power-on after delivery. Then, the first CPU encrypts the device identity by using the shared secret key to generate the binding information, and sends the binding information to the eSIM module. The eSIM module may decrypt the first device identity from the binding information by using the shared secret key, and store the first device identity. When the eSIM module is powered on again or before the eSIM module needs to perform the mobile communication service, the eSIM module may enable the second CPU that communicates with the eSIM module in this case to obtain a second device identity, and encrypt the second device identity by using the shared secret key, to generate the check information. The eSIM module may decrypt the second device identity from the check information by using the shared key. If the second device identity is the same as the first device identity stored in the eSIM module, the eSIM module may normally perform the mobile communication service. If the second device identity is different from the first device identity stored in the eSIM module, or the eSIM module does not receive, after the eSIM module is powered off and then powered on, the device check information sent by the second CPU, the eSIM module may be forbidden from performing the mobile communication service. In this way, the eSIM module in the first electronic device can be prevented from accessing a mobile communication network after the eSIM module is disassembled and inserted into another device, thereby improving security when the eSIM module accesses the mobile communication network.

The following describes a structure of an execution environment of another electronic device according to an embodiment of this application.

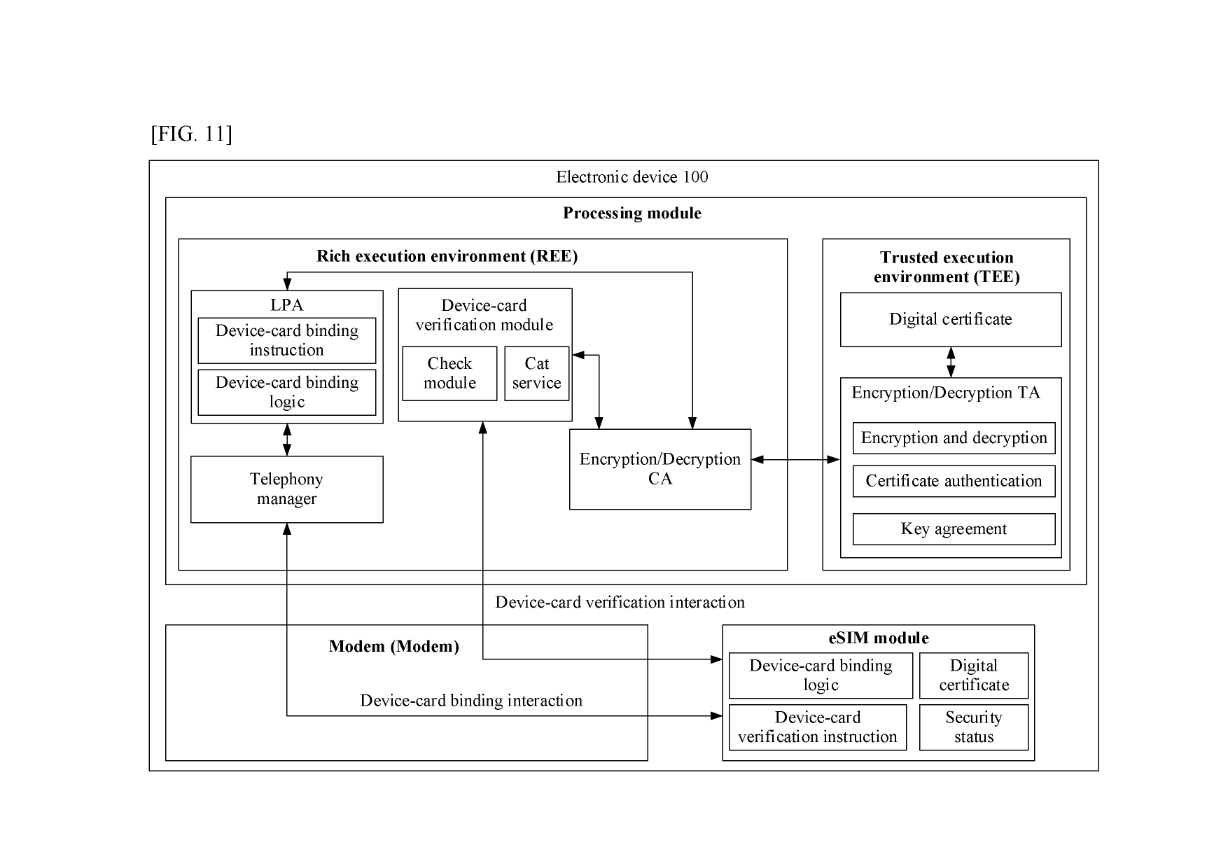

FIG. 11 is a diagram of a structure of an execution environment of another electronic device according to an embodiment of this application.

As shown in FIG. 11, an electronic device 100 may include a processing module, a modem, and an eSIM module. Two application environments may run in the processing module: a rich execution environment (REE) and a trusted execution environment (TEE). The processing module may be a CPU, or may be another module with a processing function. This is not limited herein.

An application running in the REE may be referred to as a client application. The client application in the REE may include an encryption/decryption client application (CA). A local profile assistant (LPA), a device-card verification module, a telephony manager, and the like may further run in the REE. The device-card verification module may include a card application tool service (Cat service) and a check module. For example, the check module may be a radio interface layer (RiL). For ease of description, in this embodiment of this application, an example in which the check module is the RiL is used for description.

An application running in the TEE may be referred to as a trusted application (TEE application, TA). The trusted application in the TEE may include an encryption/decryption TA, and the TEE may further manage some digital certificates issued by a digital certificate authority. For example, the digital certificates in the TEE may include an authentication root certificate (CERT.CI.ECDSA), a device certificate (CERT.DEVICE.ECDSA), and a terminal certificate (CERT.OEM.ECDSA).

The LPA may invoke device-card binding logic and send a device-card binding instruction to the eSIM module. The LPA may perform device-card binding interaction with the eSIM module through the telephony manager and the modem. The LPA may communicate with the encryption/decryption TA in the TEE by invoking the encryption/decryption CA, to invoke the encryption/decryption TA to provide services such as encryption/decryption, certificate verification, and key agreement in the device-card binding interaction process.

The eSIM module may invoke the device-card binding logic, and send a device-card verification instruction to the device-card verification module through the modem, to trigger device-card verification interaction between the eSIM module and the device-card verification module. The device-card verification module may communicate with the encryption/decryption TA in the TEE by invoking the encryption/decryption CA, to invoke the encryption/decryption TA to provide services such as encryption/decryption in the device-card verification interaction process.

Specifically, the eSIM module may invoke the device-card binding logic, and perform command interaction for device validity verification with the Cat service through the modem, to trigger the eSIM module to verify device validity (which may also be understood as verifying validity of the processing module). The Cat service may communicate with the encryption/decryption TA in the TEE by invoking the encryption/decryption CA, to invoke the encryption/decryption TA to provide services such as encryption/decryption in the device validity verification process.

The check module may invoke the device-card binding logic, and perform command interaction for verifying validity of the eSIM module with the eSIM module through the modem, to trigger the check module to verify the validity of the eSIM module. Possibly, the check module may alternatively trigger the eSIM module to verify the device validity (which may also be understood as verifying the validity of the processing module). The check module may communicate with the encryption/decryption TA in the TEE by invoking the encryption/decryption CA, to invoke the encryption/decryption TA to provide services such as encryption/decryption in the process of verifying the validity of the eSIM module.

For function descriptions of another module, refer to the embodiment shown in FIG. 2. Details are not described herein again.

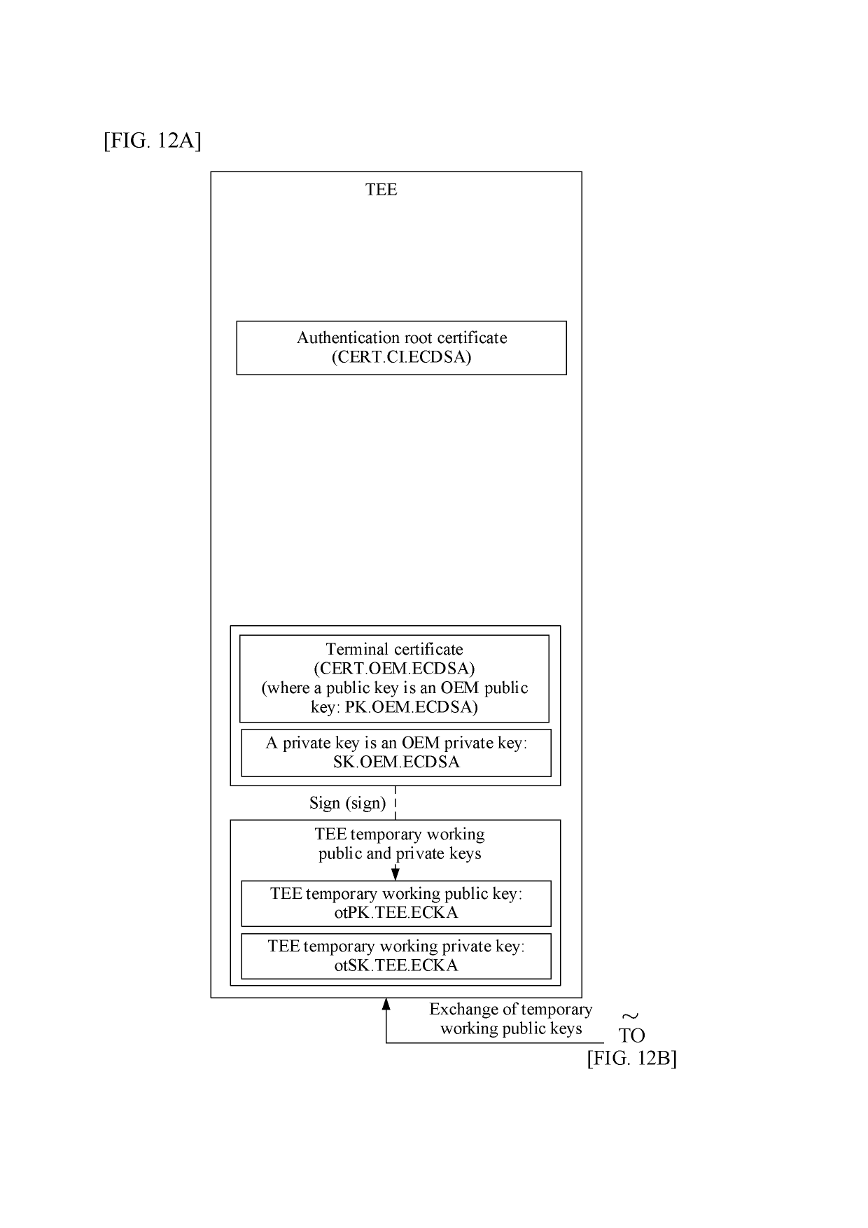

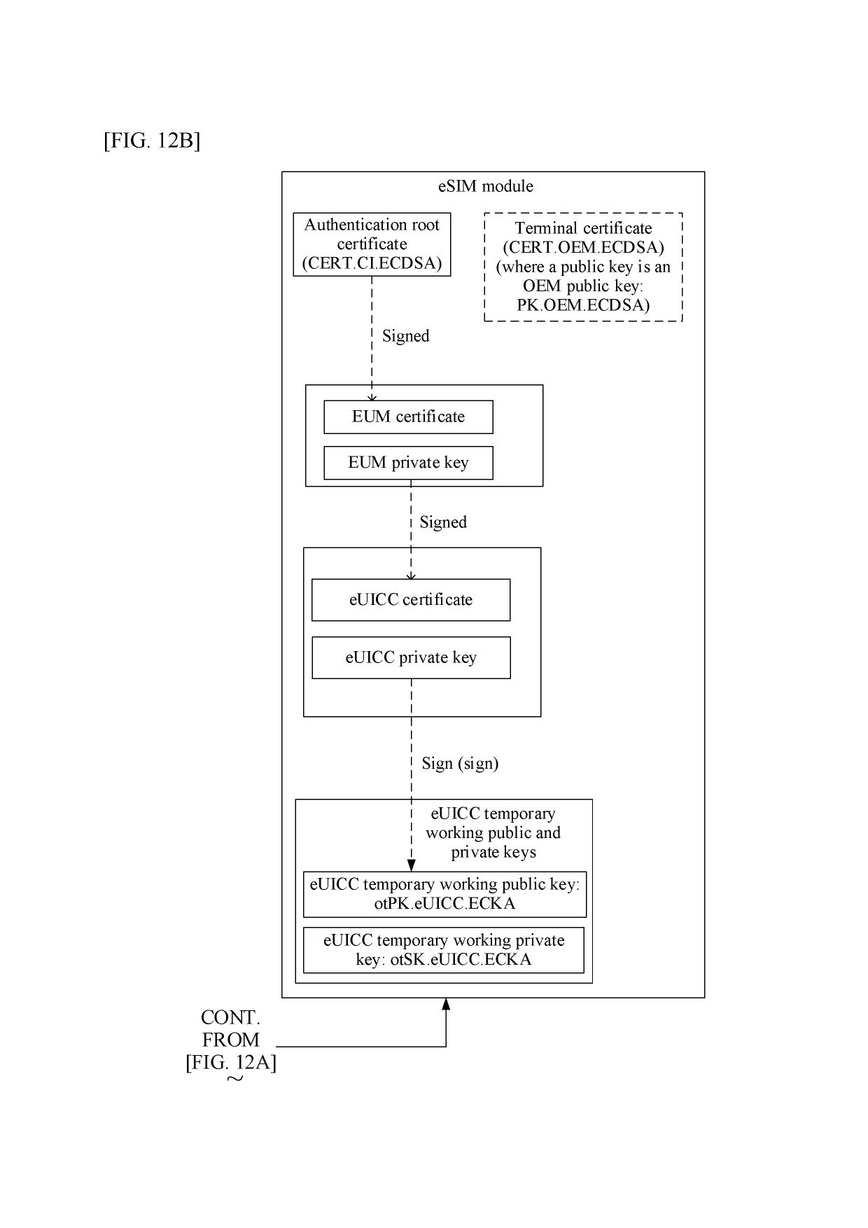

FIG. 12A and FIG. 12B are a diagram of certificate chains in the TEE and the eSIM module of the electronic device according to an embodiment of this application.

As shown in FIG. 12A and FIG. 12B, the TEE may manage the authentication root certificate (CERT.CI.ECDSA) and the terminal certificate (CERT.OEM.ECDSA). The authentication root certificate is a root certificate of an embedded UICC manufacturer (EUM) certificate in the eSIM module, and the EUM certificate is a root certificate of an eUICC certificate. In other words, the EUM certificate is signed by using a private key corresponding to the authentication root certificate, and the eUICC certificate is signed by using a private key corresponding to the EUM certificate.

In a possible implementation, the authentication root certificate (CERT.CI.ECDSA) may be a root certificate issued by an operator, a root certificate issued by a third-party organization, a root certificate issued by a terminal vendor, a root certificate issued by an EUM vendor, or the like.

The terminal certificate (CERT.OEM.ECDSA) may be self-signed by using an OEM private key corresponding to the terminal certificate (CERT.OEM.ECDSA).

In a possible implementation, the terminal certificate (CERT.OEM.ECDSA) may be directly or indirectly issued by using the terminal vendor root certificate, or may be issued by using the authentication root certificate.

The authentication root certificate (CERT.CI.ECDSA), an EUM certificate, an eUICC certificate, an EUM private key corresponding to the EUM certificate, and an eUICC private key (SK.eUICC.ECDSA) corresponding to the eUICC certificate may be preset in the eSIM module. The authentication root certificate (CERT.CI.ECDSA) includes an authentication root public key (PK.CI.ECDSA), the EUM certificate includes an EUM public key, and the eUICC certificate includes an eUICC public key (PK.eUICC.ECDSA). The EUM certificate has been signed by using an authentication root private key corresponding to the authentication root certificate (CERT.CI.ECDSA). The EUM certificate has been signed by using the EUM private key corresponding to the EUM certificate. Optionally, the terminal certificate (CERT.OEM.ECDSA) may be further preset in the eSIM module. In a possible implementation, the eSIM module may obtain the terminal certificate (CERT.OEM.ECDSA) through a server during OTA upgrade after delivery.

The LPA and the eSIM module may exchange temporary working public keys.

Details are as follows:

(1) The LPA invokes the TEE to verify a certificate chain of the eSIM module.

The certificate chain of the eSIM module includes the authentication root certificate, the EUM certificate, and the eUICC certificate. The eSIM module may send the EUM certificate and the eUICC certificate to the LPA. The LPA may invoke the encryption/decryption CA to further invoke the encryption/decryption TA, and verify validity of the EUM certificate by using the authentication root public key in the authentication root certificate preset in the TEE. If verification on the validity of the EUM certificate succeeds, the encryption/decryption TA may verify validity of the eUICC certificate by using the EUM public key in the EUM certificate. If verification on the validity of the eUICC certificate succeeds, the encryption/decryption TA may determine that verification on validity of the certificate chain of the eSIM module succeeds.

(2) The eSIM module may verify the terminal certificate (CERT.OEM.ECDSA).

In a possible implementation, if the terminal certificate (CERT.OEM.ECDSA) is self-signed, the eSIM module may verify validity of the terminal certificate (CERT.OEM.ECDSA) by using an OEM public key in the terminal certificate (CERT.OEM.ECDSA).

In a possible implementation, if the terminal certificate (CERT.OEM.ECDSA) is signed by using the device certificate, the eSIM module may verify validity of the device certificate by using a public key in a root certificate preset in the eSIM module. If verification on the validity of the device certificate succeeds, the eSIM module may verify validity of the terminal certificate (CERT.OEM.ECDSA) by using the device public key in the device certificate.

(3) The LPA invokes the TEE to exchange the temporary working public key with the eSIM module.

The LPA invokes the encryption/decryption TA in the TEE to generate TEE temporary working public and private keys. The TEE temporary working public and private keys include a TEE temporary working public key (otPK.TEE.ECKA) and a TEE temporary working private key (otSK.TEE.ECKA).

The LPA invokes the encryption/decryption TA to sign the TEE temporary working public key (otPK.TEE.ECDSA) by using the OEM private key (SK.OEM.ECDSA), and sends TEE signature data including the TEE temporary working public key (otPK.TEE.ECKA) to the eSIM module.

The eSIM module may verify, by using the OEM public key, the TEE signature data including the TEE temporary working public key (otPK.TEE.ECKA), and obtain the TEE temporary working public key (otPK.TEE.ECKA) after verification succeeds.

The eSIM module may generate eUICC temporary working public and private keys. The eUICC temporary working public and private keys include an eUICC temporary working public key (otPK.eUICC.ECKA) and an eUICC temporary working private key (otSK.eUICC.ECKA). The eSIM module may sign the eUICC temporary working public key (otPK.eUICC.ECKA) by using the eUICC private key (SK.eUICC.ECDSA), and send eUICC signature data including the eUICC temporary working public key (otPK.eUICC.ECKA) to the LPA.

The LPA invokes the encryption/decryption TA to verify, by using the eUICC public key (PK.eUICC.ECDSA), the eUICC signature data including the eUICC temporary working public key (otPK.eUICC.ECKA), and obtain the eUICC temporary working public key (otPK.TEE.ECKA) after verification succeeds.

The eSIM module may generate a shared secret key (ShS) based on the TEE temporary working public key (otPK.TEE.ECKA) and the eUICC temporary working private key (otSK.eUICC.ECKA).

The LPA invokes the encryption/decryption TA to generate the shared secret key (ShS) based on the eUICC temporary working public key (otPK.eUICC.ECKA) and the TEE temporary working private key (otSK.TEE.ECKA).

The TEE temporary working public key (otPK.TEE.ECKA) and the TEE temporary working private key (otSK.TEE.ECKA) are a pair of public and private keys, and the eUICC temporary working public key (otPK.eUICC.ECKA) and the eUICC temporary working private key (otSK.eUICC.ECKA) are a pair of public and private keys. Therefore, both the eSIM module and the encryption/decryption TA may generate the same shared secret key (ShS) by using the temporary working public key of the peer party and their own temporary working private keys.

In a possible implementation, for example, in a production line of the electronic device, after invoking the encryption/decryption TA in the TEE to generate the TEE temporary working public and private keys, the LPA may directly send the TEE temporary working public key to the peer party.

In a possible implementation, the authentication root certificate (CERT.CI.ECDSA) may be a root certificate issued by an operator, a root certificate issued by a third-party organization, a root certificate issued by a terminal vendor, a root certificate issued by an EUM vendor, or the like.

In a possible implementation, the terminal certificate (CERT.OEM.ECDSA) may be directly issued by using the terminal vendor root certificate or an intermediate certificate issued by using the terminal vendor root certificate, or may be issued by using the authentication root certificate.

In a possible implementation, the terminal certificate (CERT.OEM.ECDSA) may be self-signed.

In a possible implementation, the device vendor root certificate (CERT.OEMCI.ECDSA) may be preset in the eSIM module before delivery of the electronic device 100.

In a possible implementation, the device vendor root certificate (CERT.OEMCI.ECDSA) may alternatively be delivered by a server to the electronic device 100 during OTA upgrade after delivery of the electronic device 100. The processing module (for example, the CPU) in the electronic device 100 is preset in the eSIM module.

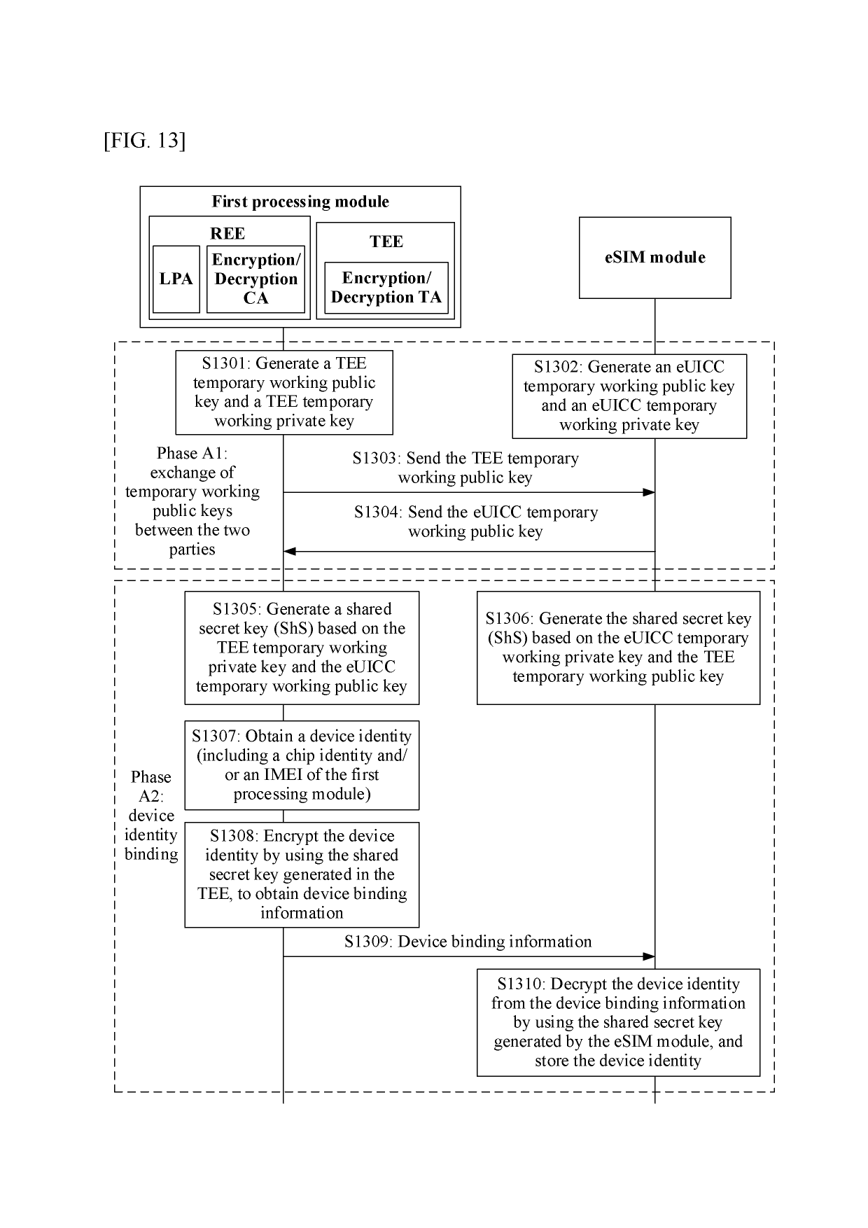

FIG. 13 is a schematic flowchart of one-way device-card binding in an eSIM authentication method according to an embodiment of this application.

The eSIM authentication method may be applied to a first electronic device including a first processing module and an eSIM module. An REE and a TEE may run in the first processing module. An LPA and an encryption/decryption CA may run in the REE, and an encryption/decryption TA may run in the TEE. For specific descriptions of the REE and the TEE, refer to the embodiments shown in FIG. 2 to FIG. 4 or the embodiments shown in FIG. 11 to FIG. 12B. Details are not described herein again.

As shown in FIG. 13, the device-card binding procedure may include two phases: exchange of temporary working private keys between the two parties, and device identity binding.

Phase A1: exchange of temporary working private keys between the two parties

S1301: The first processing module generates a TEE temporary working public key and a TEE temporary working private key.

The encryption/decryption TA in the TEE of the first processing module may generate the TEE temporary working public key and the TEE temporary working private key, and store the TEE temporary working public key and the TEE temporary working private key in the TEE. The TEE temporary working public key and the TEE temporary working private key are a pair of paired public and private keys.

S1302: The eSIM module generates an eUICC temporary working public key and an eUICC temporary working private key.

The eUICC temporary working public key and the eUICC temporary working private key are a pair of paired public and private keys.

S1303: The first processing module sends the TEE temporary working public key to the eSIM module.

The LPA in the first processing module may obtain the TEE temporary working public key from the TEE through the encryption/decryption CA and the encryption/decryption TA, and send the TEE temporary working public key to the eSIM module.

S1304: The eSIM module sends the eUICC temporary working public key to the first processing module.

The eSIM module may send the eUICC temporary working public key to the LPA. The LPA may send the eUICC temporary working public key to the encryption/decryption TA through the encryption/decryption CA.

Phase A2: device identity binding

S1305: The first processing module generates a shared secret key (ShS) based on the TEE temporary working private key and the eUICC temporary working public key.

The encryption/decryption TA may generate the shared secret key (ShS) based on the TEE temporary working private key and the eUICC temporary working public key.

S1306: The eSIM module generates the shared secret key (ShS) based on the eUICC temporary working private key and the TEE temporary working public key.

The TEE temporary working public key and the TEE temporary working private key are a pair of public and private keys, and the eUICC temporary working public key and the eUICC temporary working private key are a pair of public and private keys. Therefore, both the eSIM module and the encryption/decryption TA may generate the same shared secret key (ShS) by using the temporary working public key of the peer party and their own temporary working private keys.

S1307: The first processing module obtains a device identity. The device identity may include a chip identity and/or an IMEI of the first processing module.

The LPA may obtain the device identity.

S1308: The first processing module encrypts the device identity by using the shared secret key generated in the TEE, to obtain device binding information.

The LPA may transfer the device identity to the encryption/decryption TA through the encryption/decryption CA, and invoke the encryption/decryption TA to encrypt the device identity by using the shared secret key, to obtain the device binding information. The encryption/decryption TA may return the device binding information to the LPA through the encryption/decryption CA.

S1309: The first processing module sends the device binding information to the eSIM module.

The LPA may send the device binding information to the eSIM module.

S1310: The eSIM module decrypts the device identity from the device binding information by using the shared secret key generated by the eSIM module, and stores the device identity.

According to the eSIM authentication method provided in this embodiment of this application, because a production line is secure and controllable, security issues such as a man-in-the-middle attack may not be considered. Therefore, when the temporary working public keys are exchanged between the first processing module and the eSIM module, certificate check and signatures may not be required. In this way, the eSIM module is bound to the device identity.

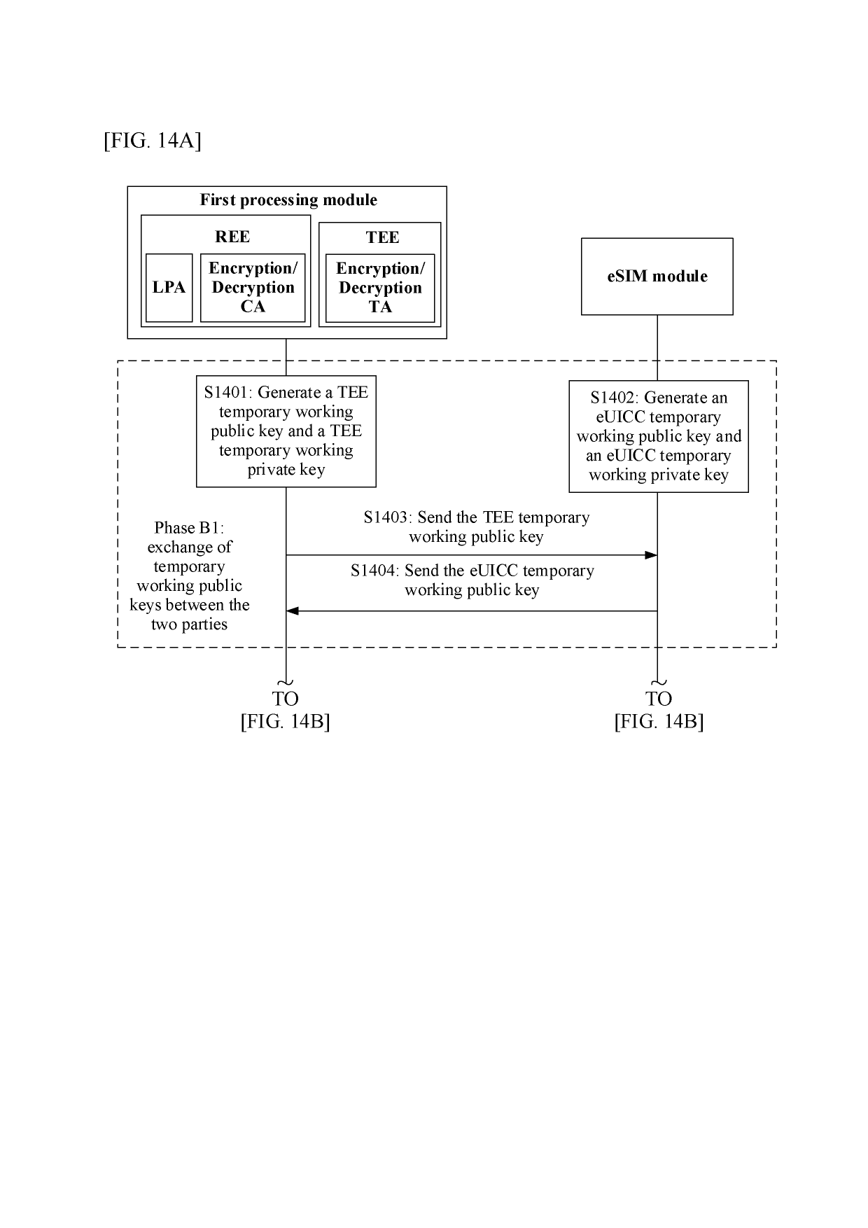

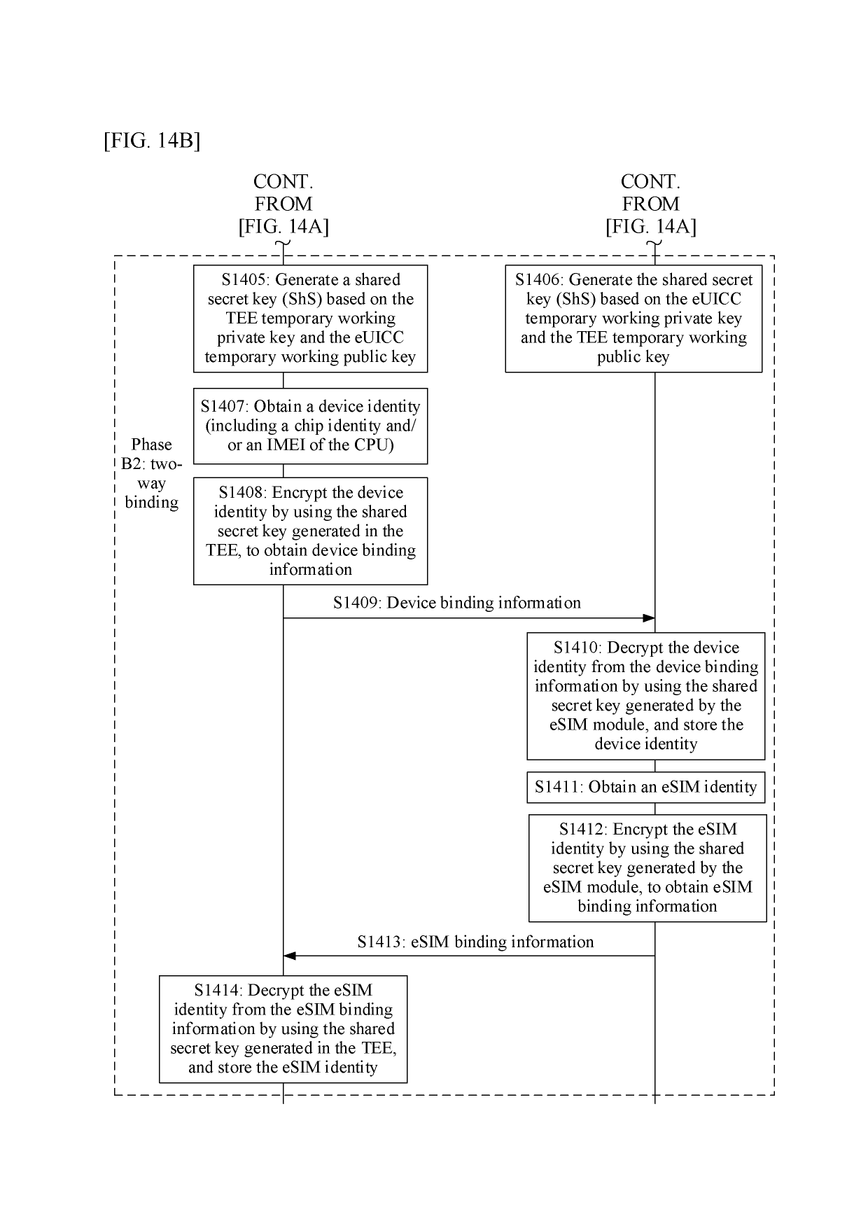

FIG. 14A and FIG. 14B are a schematic flowchart of two-way device-card binding in an eSIM authentication method according to an embodiment of this application.

The eSIM authentication method may be applied to a first electronic device including a first processing module and an eSIM module. An REE and a TEE may run in the first processing module. An LPA and an encryption/decryption CA may run in the REE, and an encryption/decryption TA may run in the TEE. For specific descriptions of the REE and the TEE, refer to the embodiments shown in FIG. 2 to FIG. 4 or the embodiments shown in FIG. 11 to FIG. 12B. Details are not described herein again.

As shown in FIG. 14A and FIG. 14B, the device-card binding procedure may include two phases: exchange of temporary working private keys between the two parties, and device identity binding.

Phase B1: exchange of temporary working private keys between the two parties

S1401: The first processing module generates a TEE temporary working public key and a TEE temporary working private key.

S1402: The eSIM module generates an eUICC temporary working public key and an eUICC temporary working private key.

S1403: The first processing module sends the TEE temporary working public key to the eSIM module.

S1404: The eSIM module sends the eUICC temporary working public key to the first processing module.

Phase B2: device identity binding

S1405: The first processing module generates a shared secret key (ShS) based on the TEE temporary working private key and the eUICC temporary working public key.

S1406: The eSIM module generates the shared secret key (ShS) based on the eUICC temporary working private key and the TEE temporary working public key.

S1407: The first processing module obtains a device identity. The device identity may include a chip identity and/or an IMEI of a CPU.

S1408: The first processing module encrypts the device identity by using the shared secret key generated in the TEE, to obtain device binding information.

S1409: The first processing module sends the device binding information to the eSIM module.

S1410: The eSIM module decrypts the device identity from the device binding information by using the shared secret key generated by the eSIM module, and stores the device identity.

For step S1401 to step S1410, refer to step S1301 to step S1310 in the embodiment shown in FIG. 13.

S1411: The eSIM module obtains an eSIM identity.

The eSIM identity may be an embedded universal integrated circuit card identity (eUICC ID) and/or another identity.

S1412: The eSIM module encrypts the eSIM identity by using the shared secret key generated by the eSIM module, to obtain eSIM binding information.

S1413: The eSIM module sends the eSIM binding information to the first processing module.

The eSIM module may send the eSIM binding information to the LPA of the first processing module.

S1414: The first processing module decrypts the eSIM identity from the eSIM binding information by using the shared secret key generated in the TEE, and stores the eSIM identity.

The LPA may transfer the eSIM binding information to the encryption/decryption TA through the encryption/decryption CA, invoke the encryption/decryption TA to decrypt the eSIM identity from the eSIM binding information by using the shared secret key generated in the TEE, and store the eSIM identity in the TEE.

According to the eSIM authentication method provided in this embodiment of this application, because a production line is secure and controllable, security issues such as a man-in-the-middle attack may not be considered. Therefore, when the temporary working public keys are exchanged between the first processing module and the eSIM module, certificate check and signatures may not be required. In this way, two-way binding between the eSIM module and the device (which may be specifically the first processing module) is completed.

In some embodiments, steps S1401 to S1414 in the embodiment in FIG. 14A and FIG. 14B may alternatively be performed by the first processing module and the eSIM module that are triggered through OTA upgrade after delivery of the electronic device, so that the processing module in the electronic device can still be bound to the eSIM module after the electronic device is delivered and sold.

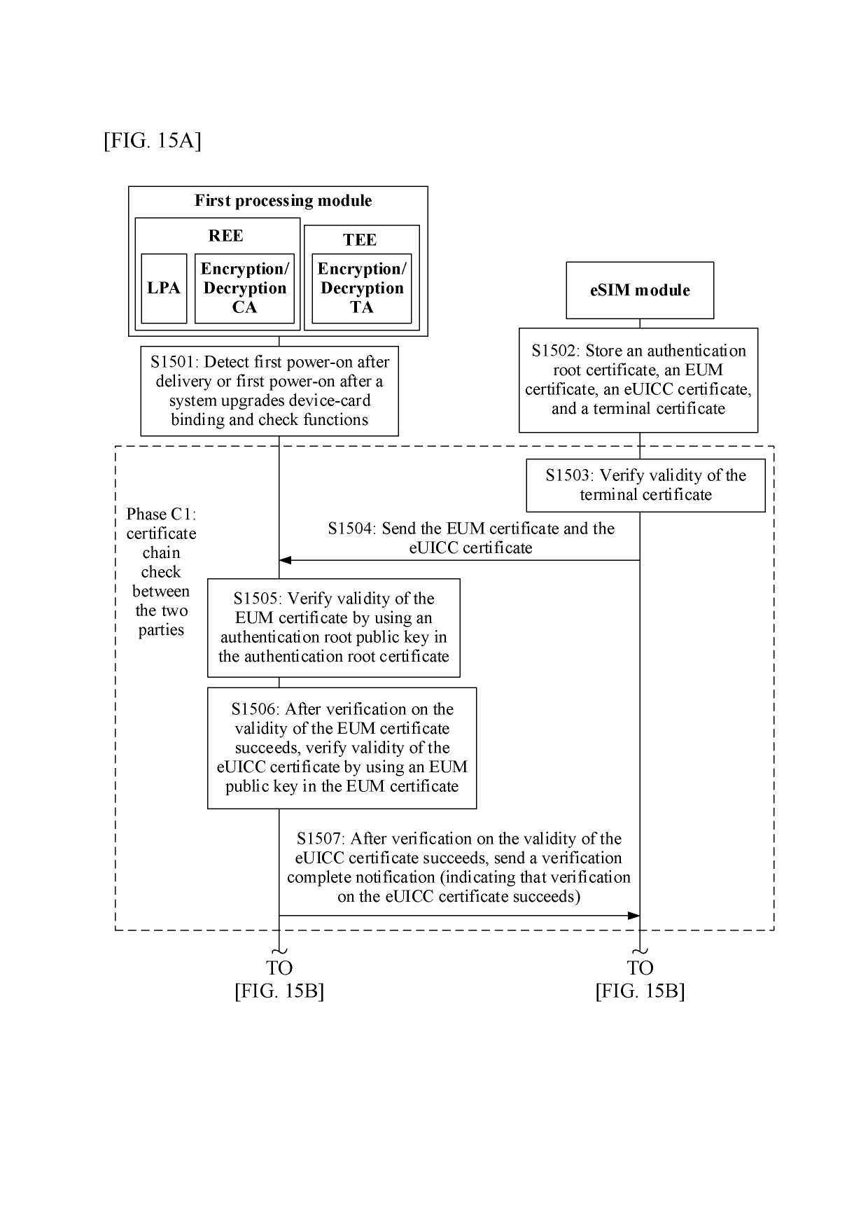

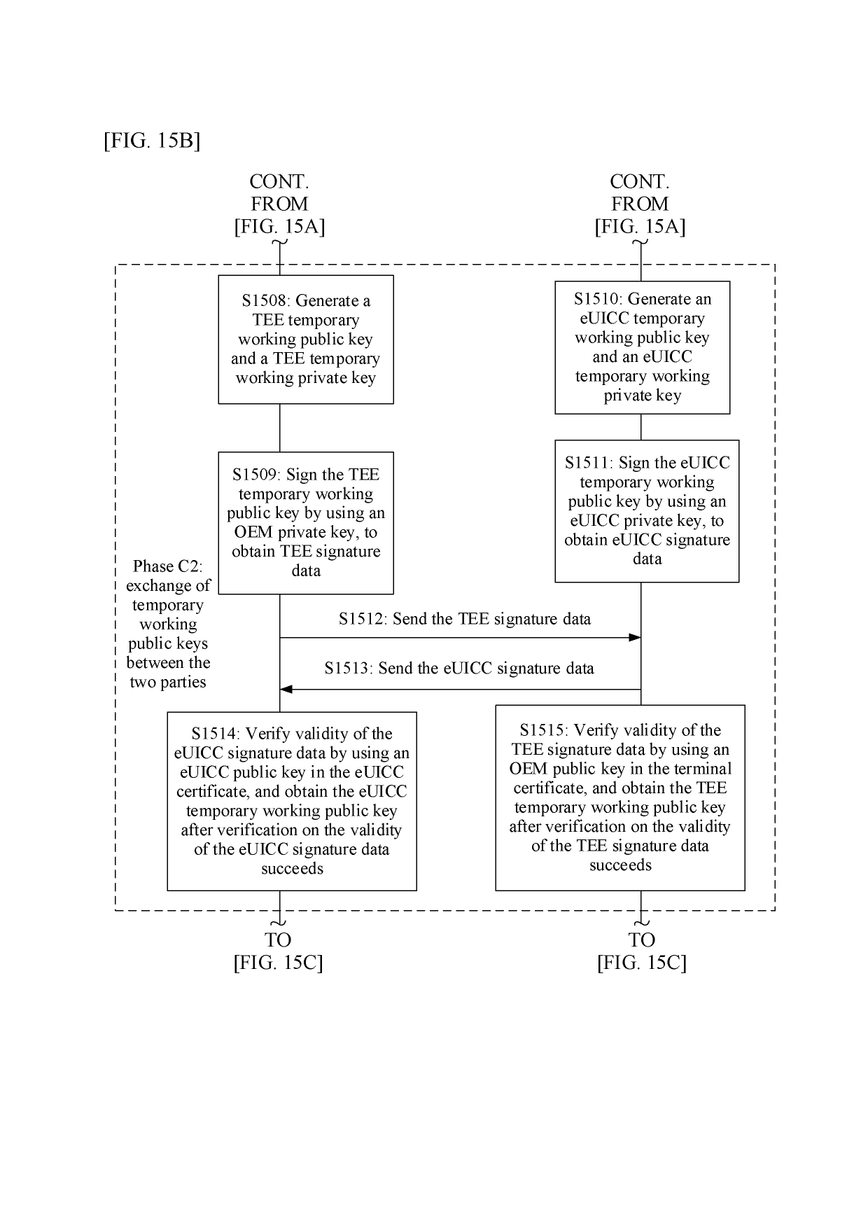

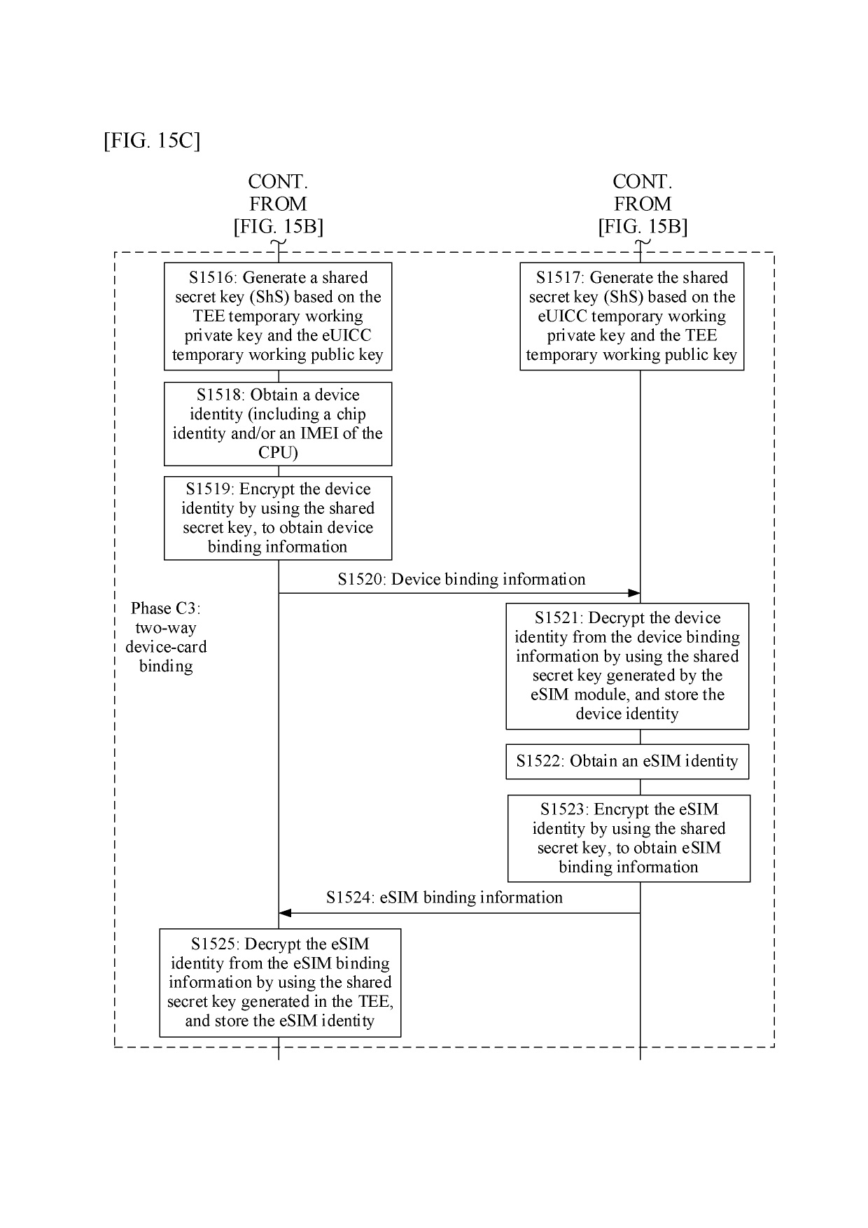

FIG. 15A to FIG. 15C are a schematic flowchart of two-way device-card binding in an eSIM authentication method according to an embodiment of this application.

The eSIM authentication method may be applied to a first electronic device including a first processing module and an eSIM module. An REE and a TEE may run in the first processing module. An LPA and an encryption/decryption CA may run in the REE, and an encryption/decryption TA may run in the TEE. For specific descriptions of the REE and the TEE, refer to the embodiments shown in FIG. 2 to FIG. 4 or the embodiments shown in FIG. 11 to FIG. 12B. Details are not described herein again.

As shown in FIG. 15A to FIG. 15C, the device-card binding procedure may include two phases: exchange of temporary working private keys between the two parties, and device identity binding.

S1501: The first processing module may detect first power-on after delivery or first power-on after a system upgrades device-card binding and check functions.

The first processing module may trigger a subsequent device-card binding procedure after detecting the first power-on after delivery or the first power-on after the system upgrades the device-card binding and check functions. The device-card binding procedure may include the following three phases: certificate chain check between the two parties, exchange of temporary working public keys between the two parties, and two-way device-card binding.

A device-card binding function and a device-card check function may be preset in the first electronic device before delivery. In this way, the first processing module and the eSIM module in the first electronic device can be bound when the first electronic device is powered on for the first time after delivery, to prevent the eSIM module of the first electronic device from being normally used on another device after being disassembled, and also prevent the first electronic device from carrying an eSIM module of another device for normal use.

In a possible implementation, after delivery, the first electronic device may obtain the device-card binding function and the device-card check function when performing system upgrade through the first processing module. In this way, two-way binding between the first processing module and the eSIM module in the electronic device that has been sold is implemented in a system upgrade manner, to prevent the eSIM module of the first electronic device that has been sold from being normally used on another device after being disassembled, and also prevent the first electronic device from carrying an eSIM module of another device for normal use.

S1502: The eSIM module stores an authentication root certificate, an EUM certificate, an eUICC certificate, and a terminal certificate.

Phase C1: phase of certificate chain check between the two parties

S1503: The eSIM module verifies validity of the terminal certificate.

For specific content, refer to the embodiment shown in FIG. 12A and FIG. 12B. Details are not described herein again.

S1504: The eSIM sends the EUM certificate and the eUICC certificate to the first processing module.

S1505: After receiving the EUM certificate and the eUICC certificate, the first processing module may verify validity of the EUM certificate by using an authentication root public key in the authentication root certificate.

S1506: After verification on the validity of the EUM certificate succeeds, the first processing module may verify validity of the eUICC certificate by using an EUM public key in the EUM certificate.

S1507: After verification on the validity of the eUICC certificate succeeds, the first processing module sends a verification complete notification to the eSIM module.

Phase C2: exchange of temporary working public keys between the two parties

S1508: After sending the verification complete notification to the eSIM module, the first processing module may generate a TEE temporary working public key and a TEE temporary working private key.

S1509: The first processing module may sign the TEE temporary working public key by using an OEM private key, to obtain TEE signature data.

S1510: After receiving the verification complete notification, the eSIM module may generate an eUICC temporary working public key and an eUICC temporary working private key.

S1511: The eSIM module may sign the eUICC temporary working public key by using an eUICC private key, to obtain eUICC signature data.

S1512: The first processing module may send the TEE signature data to the eSIM module.

S1513: The eSIM module may send the eUICC signature data to the first processing module.

S1514: The first processing module may verify validity of the eUICC signature data by using an eUICC public key in the eUICC certificate, and obtain the eUICC temporary working public key after verification on the validity of the eUICC signature data succeeds.

S1515: The eSIM module may verify validity of the TEE signature data by using an OEM public key in the terminal certificate, and obtain the TEE temporary working public key after verification on the validity of the TEE signature data succeeds.

Phase C3: two-way device-card binding

S1516: The first processing module may generate a shared secret key (ShS) based on the TEE temporary working private key and the eUICC temporary working public key.

S1517: The eSIM module may generate the shared secret key (ShS) based on the eUICC temporary working private key and the TEE temporary working public key.

S1518: The first processing module may obtain a device identity.

S1519: The first processing module may encrypt the device identity by using the shared secret key, to obtain device binding information.

S1520: The first processing module may send the device binding information to the eSIM module.

S1521: The eSIM module may decrypt the device identity from the device binding information by using the shared secret key generated by the eSIM module, and store the device identity.

For step S1505 to step S1521, refer to step S506 to step S522 in the embodiment shown in FIG. 5A to FIG. 5C.

S1522: The eSIM module obtains an eSIM identity.

S1523: The eSIM module encrypts the eSIM identity by using the shared secret key, to obtain eSIM binding information.

S1524: The eSIM module sends the eSIM binding information to the first processing module.

S1525: The eSIM module decrypts the eSIM identity from the eSIM binding information by using the shared secret key generated in the TEE, and stores the eSIM identity.

For step S1522 to step S1525, refer to step S1411 to step S1414 in the embodiment shown in FIG. 14B. Details are not described herein again.

According to the eSIM authentication method provided in this embodiment of this application, after an occasion like system upgrade or first power-on after delivery, the first processing module and the eSIM module in the first electronic device can first verify certificates and exchange the temporary public keys of the two parties, and then agree on the shared secret key based on their own temporary private keys and the temporary public key of the peer party. The first processing module encrypts the device identity by using the shared secret key, generates the device binding information, and sends the device binding information to the eSIM module. The eSIM module may decrypt a first device identity from the device binding information by using the shared secret key, and store the first device identity. The eSIM module may also encrypt a first eSIM identity by using the shared secret key, to generate the eSIM binding information. The eSIM module may send the eSIM binding information to the first processing module. The first processing module may decrypt the first eSIM identity from the eSIM binding information by using the shared secret key, and store the first device identity in the TEE. In this way, two-way binding between the eSIM module and the first processing module can be completed.

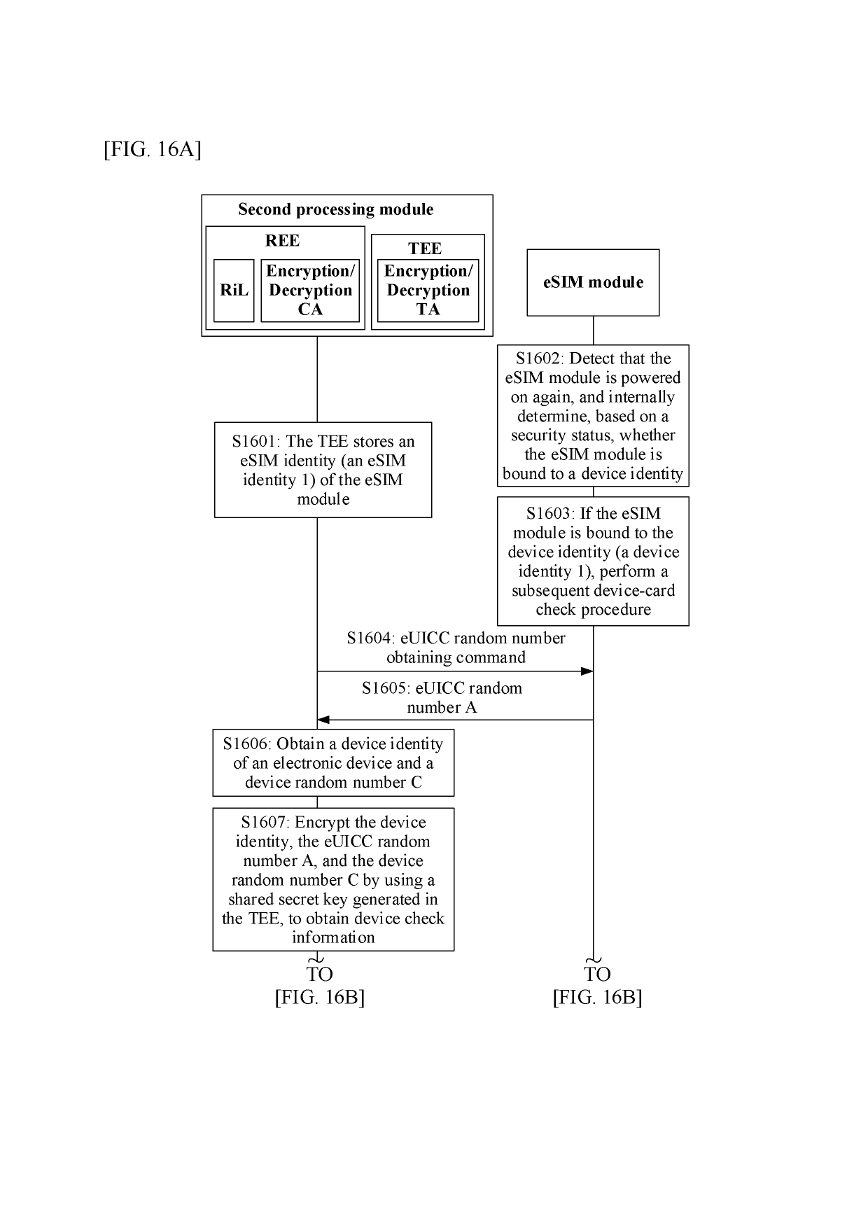

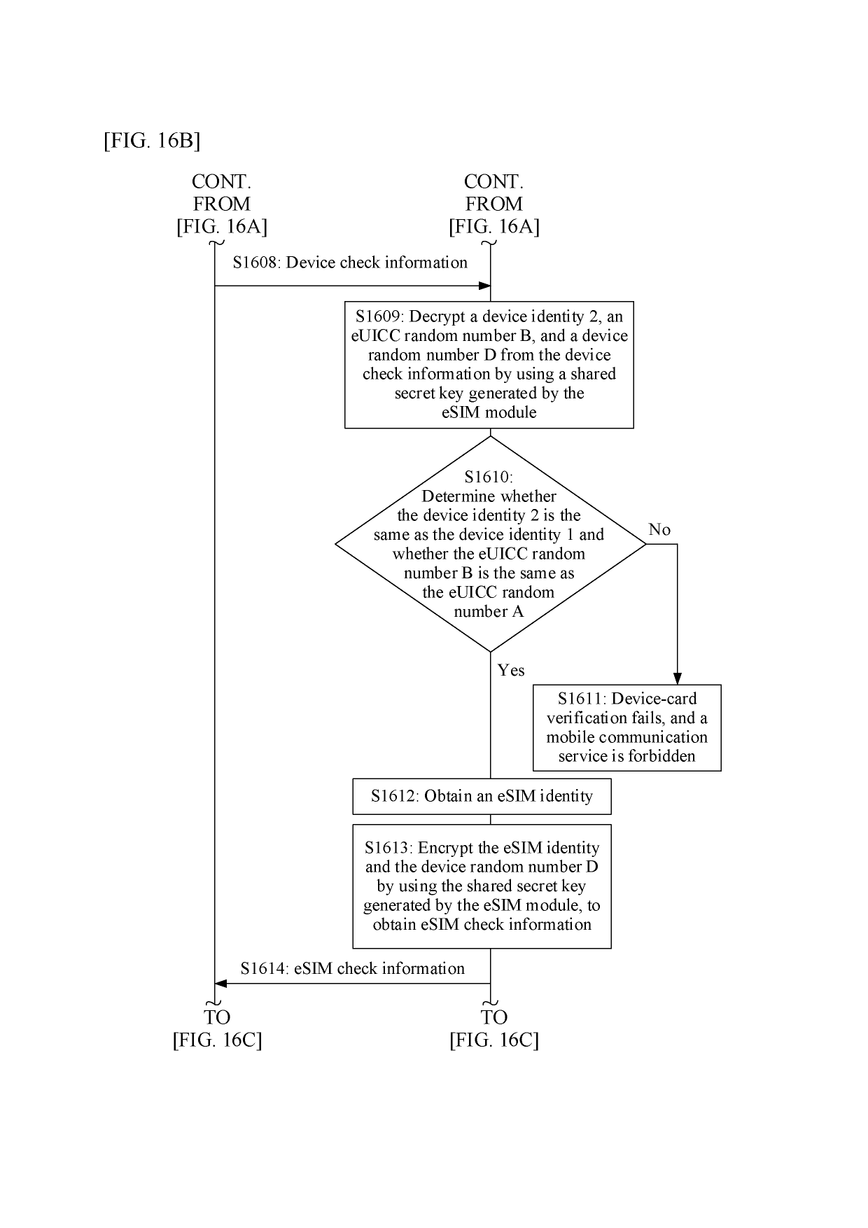

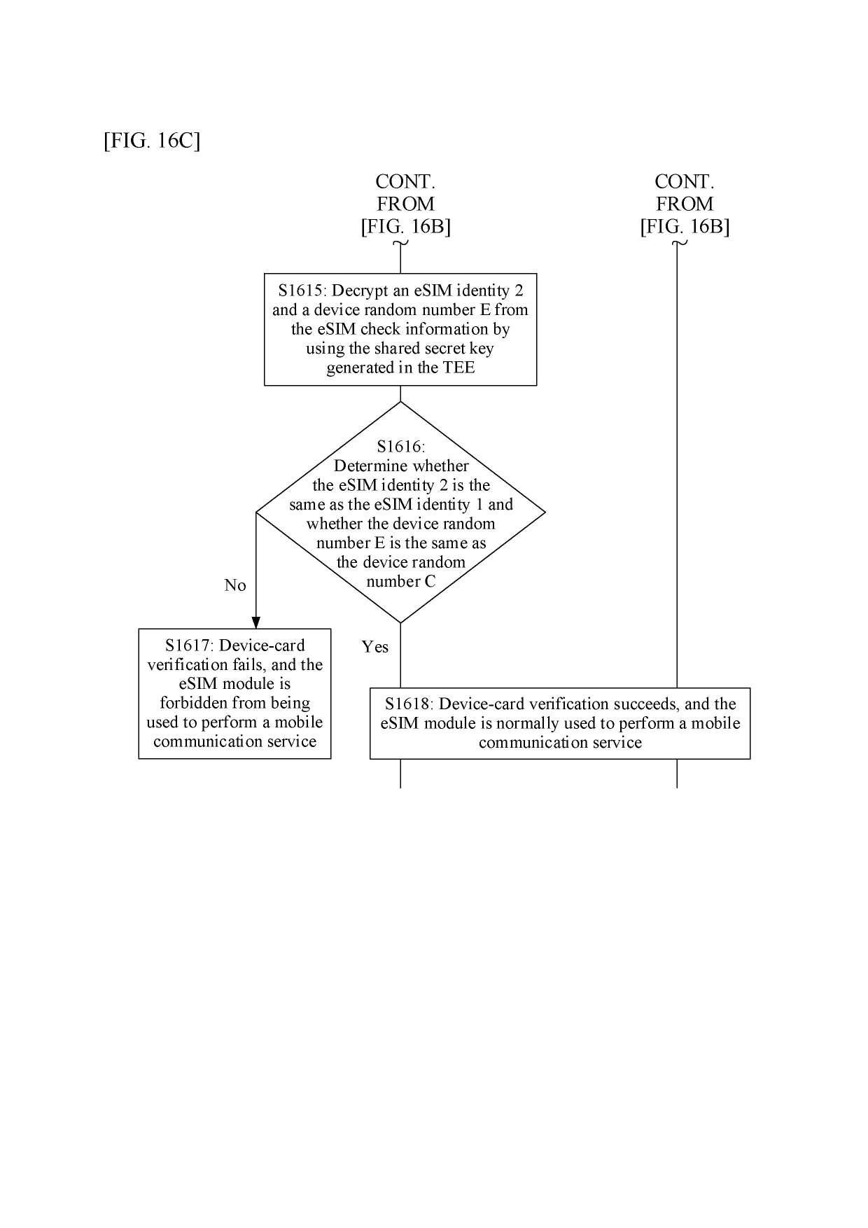

FIG. 16A to FIG. 16C are a schematic flowchart of two-way device-card verification in an eSIM authentication method according to an embodiment of this application.

The eSIM authentication method may be applied to an electronic device including a second CPU and an eSIM module. An REE and a TEE may run in the second CPU. An RiL and an encryption/decryption CA may run in the REE, and an encryption/decryption TA may run in the TEE. For specific descriptions of the REE and the TEE, refer to the embodiments shown in FIG. 2 to FIG. 4 or the embodiments shown in FIG. 11 to FIG. 12B. Details are not described herein again. It should be noted that the RiL is merely an example for explanation and is not limited in this application. During specific implementation, a function of the RiL may alternatively be integrated into another module in another REE.

As shown in FIG. 16A to FIG. 16C, the device-card verification procedure may include the following steps.

S1601: The TEE of the second processing module stores an eSIM identity (an eSIM identity 1) of the eSIM module.

S1602: When detecting that the eSIM module is powered on again, the eSIM module may internally determine, based on a security status, whether the eSIM module is bound to a device identity.

S1603: If the eSIM module is bound to a device identity (a device identity 1), perform a subsequent device-card check procedure.

The subsequent device-card check procedure performed by the eSIM module includes subsequent step S1604 to step S1618.

S1604: The second processing module sends an eUICC random number obtaining command to the eSIM module.

The RiL in the REE may send the eUICC random number obtaining command to the eSIM module.

S1605: The eSIM module sends an eUICC random number A to the second processing module.

The eSIM module sends the eUICC random number A to the RiL in the REE.

S1606: The second processing module obtains a device identity of the electronic device and generates a device random number C.

The RiL in the REE may obtain the device identity of the electronic device and generate the device random number C.

S1607: The second processing module may encrypt the device identity, the eUICC random number A, and the device random number C by using a shared secret key generated in the TEE, to obtain check information.

The RiL in the REE may invoke the encryption/decryption TA in the TEE through the encryption/decryption CA, and encrypt the device identity, the eUICC random number A, and the device random number C by using the shared secret key generated in the TEE, to obtain the check information.

S1608: The second processing module sends the device check information to the eSIM module.

S1609: The eSIM module may decrypt a device identity 2, an eUICC random number B, and a device random number D from the device check information by using the shared secret key generated by the eSIM module.

S1610: The eSIM module may determine whether the device identity 2 is the same as the device identity 1 and whether the eUICC random number B is the same as the eUICC random number A.

S1611: If the device identity 2 is different from the device identity 1 or the eUICC random number B is different from the eUICC random number A, device-card verification fails, and the eSIM module is forbidden from performing a mobile communication service.

S1612: If the device identity 2 is the same as the device identity 1, and the eUICC random number B is the same as the eUICC random number A, the eSIM module obtains an eSIM identity.

S1613: The eSIM module encrypts the eSIM identity and the device random number D by using the shared secret key generated by the eSIM module, to obtain eSIM check information.

S1614: The eSIM module sends the eSIM check information to the second processing module.

S1615: The second processing module decrypts an eSIM identity 2 and a device random number E from the eSIM check information by using the shared secret key generated in the TEE.

The RiL in the REE may invoke the encryption/decryption TA in the TEE through the encryption/decryption CA, to decrypt the eSIM identity 2 and the device random number E from the eSIM check information.

S1616: The second processing module determines whether the eSIM identity 2 is the same as the eSIM identity 1 and whether the device random number E is the same as the device random number C.

The RiL in the REE may determine whether the eSIM identity 2 is the same as the eSIM identity 1 and whether the device random number E is the same as the device random number C.

S1617: If the eSIM identity 2 is different from the eSIM identity 1, or the device random number E is different from the device random number C, the device-card verification fails, and the eSIM module is forbidden from being used to perform the mobile communication service.

In a possible implementation, if the eSIM identity 2 is different from the eSIM identity 1, or the device random number E is different from the device random number C, the RiL in the REE may notify the modem that the eSIM module is forbidden from being used to perform the mobile communication service.

S1618: If the eSIM identity 2 is the same as the eSIM identity 1, and the device random number E is the same as the device random number C, the device-card verification succeeds, and the eSIM module is normally used to perform the mobile communication service.

If the device-card verification fails, it indicates that the second processing module is not bound to the eSIM module.

In a possible implementation, if the second processing module does not receive, after the eSIM module is powered off and then powered on, the eSIM check information sent by the eSIM module, or the eSIM module does not receive, after the eSIM module is powered off and then powered on, the device check information sent by the second processing module, the device-card verification fails.

In a possible implementation, if the device-card verification performed on the second processing module and the eSIM module fails, the second processing module may perform device-card verification with the eSIM module again. If the device-card verification fails for a specified quantity of times (for example, three times), the second processing module and the eSIM module are permanently locked.

According to the eSIM authentication method provided in this embodiment of this application, when the eSIM module is powered on again or before the eSIM module needs to perform the mobile communication service, the eSIM module and the second processing module that communicates with the eSIM module in this case may verify validity of each other. In this way, the eSIM module in the electronic device can be prevented from accessing a mobile communication network after the eSIM module is disassembled and inserted into another device, and the electronic device can also be prevented from being used by a disassembled eSIM module of another device to access the mobile communication network, thereby improving security when the eSIM module accesses the mobile communication network.

In this embodiment of this application, the device identity 1 may be referred to as a first device identity, the device identity 2 may be referred to as a second device identity, the eSIM identity 1 may be referred to as a first eSIM identity, the eSIM identity 2 may be referred to as a second eSIM identity, the eUICC random number A may be referred to as a first eUICC random number, the eUICC random number B may be referred to as a second eUICC random number, the device random number C may be referred to as a first device random number, the device random number E may be referred to as a second device random number, and the device random number D may be referred to as a third device random number.

In this embodiment of this application, the eUICC random number may also be referred to as an eSIM random number. Therefore, the eUICC random number A may be referred to as the first eUICC random number or a first eSIM random number, and the eUICC random number B may be referred to as a second eSIM random number. The eUICC temporary working public key may also be referred to as an eSIM temporary working public key. The eUICC temporary working private key may also be referred to as an eSIM temporary working private key.

The following specifically describes, with reference to signaling, a one-way device-card binding procedure in the eSIM authentication method provided in embodiment of this application.

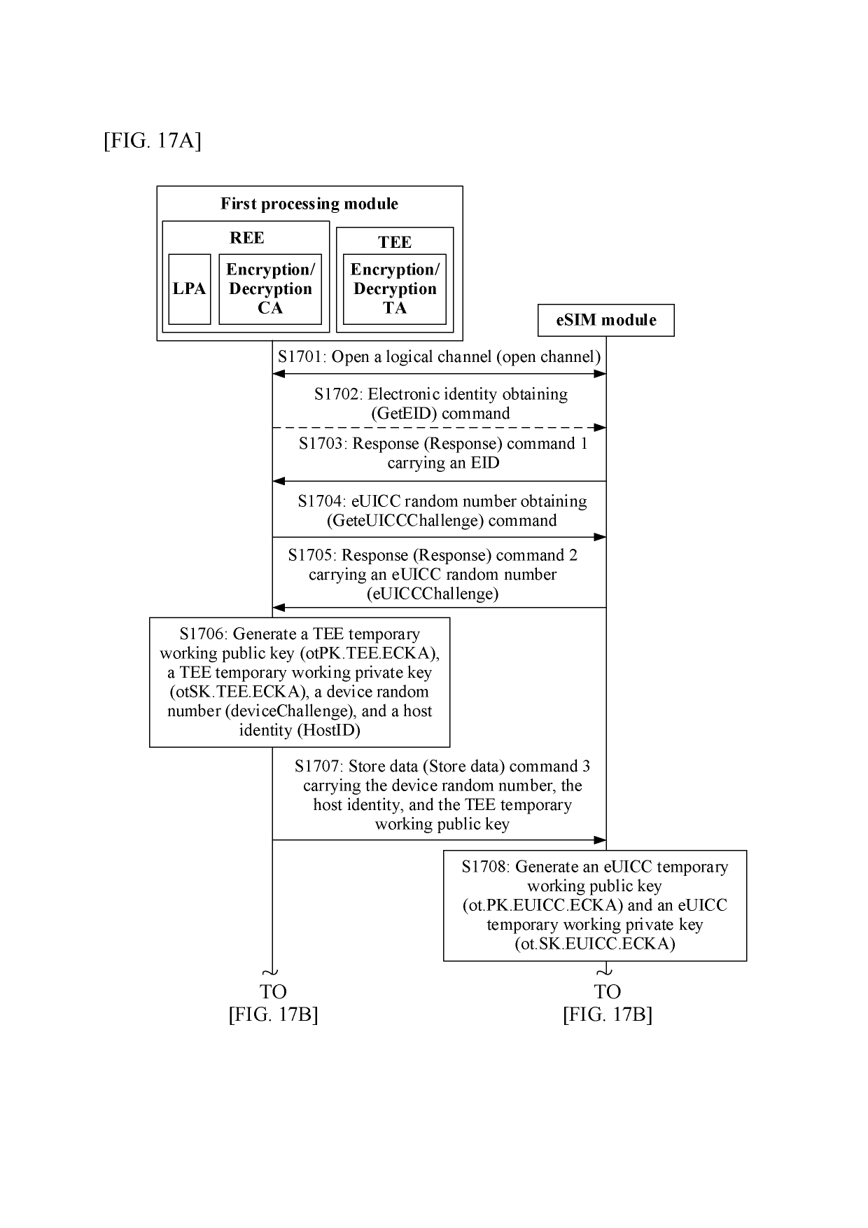

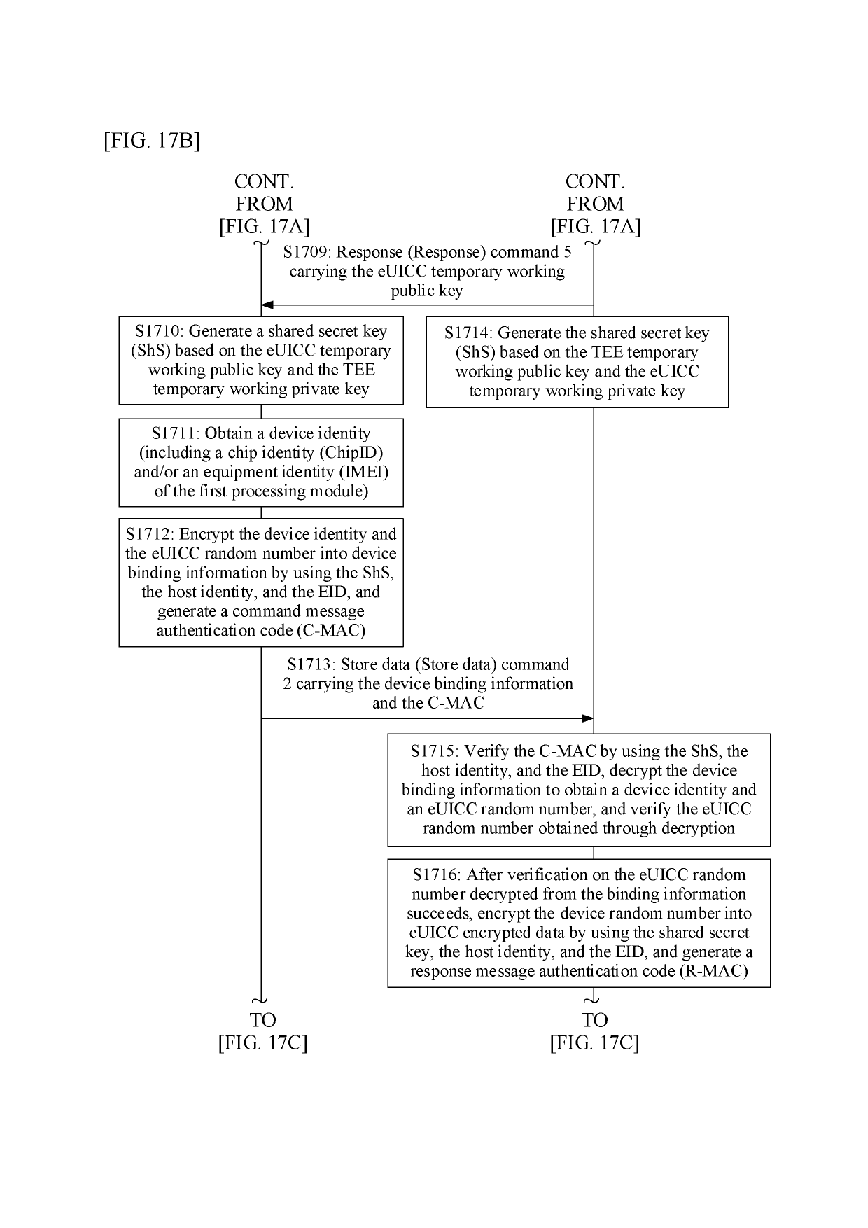

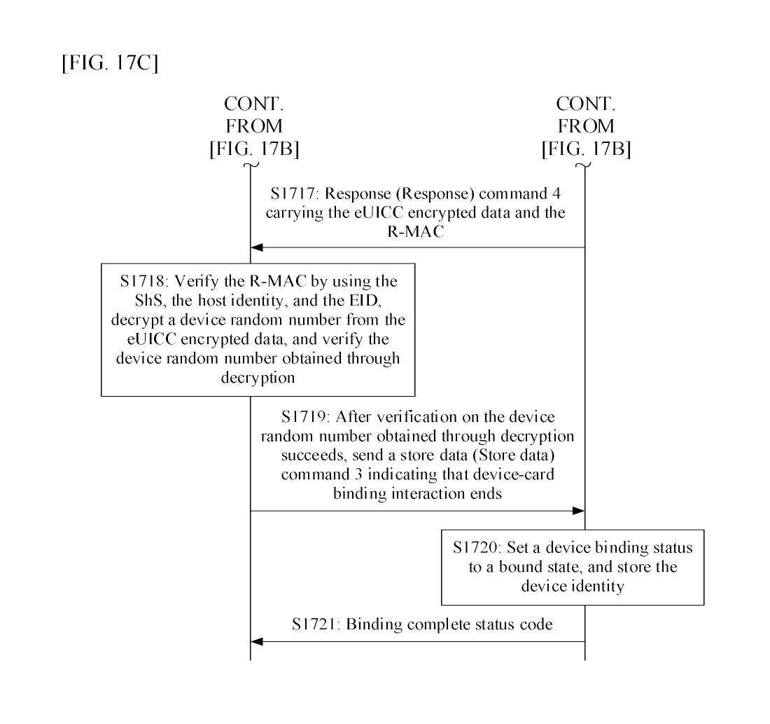

FIG. 17A to FIG. 17C are a schematic flowchart of signaling interaction for one-way device-card binding in an eSIM authentication method according to an embodiment of this application.

The eSIM authentication method may be applied to a first electronic device including a first processing module and an eSIM module. An REE and a TEE may run in the first processing module. An LPA and an encryption/decryption CA may run in the REE, and an encryption/decryption TA may run in the TEE. For specific descriptions of the REE and the TEE, refer to the embodiments shown in FIG. 2 to FIG. 4 or the embodiments shown in FIG. 11 to FIG. 12B. Details are not described herein again.

As shown in FIG. 17A to FIG. 17C, the device-card binding signaling interaction procedure in the eSIM authentication method may include the following steps.

S1701: The first processing module may open a logical channel (open channel) with the eSIM module.

The LPA in the first processing module may open the logical channel with the eSIM module.

S1702: The first processing module may send an electronic identity obtaining (GetEID) command to the eSIM module.

The LPA in the first processing module may send the electronic identity obtaining command to the eSIM module.

S1703: After receiving the electronic identity obtaining command, the eSIM module may return a response command 1 to the first processing module. The response command 1 carries an EID.

The eSIM module may send the response command 1 to the LPA in the first processing module.

S1704: The first processing module may send an eUICC random number obtaining (GeteUICCChallenge) command to the eSIM module.

The LPA in the first processing module may send the eUICC random number obtaining (GeteUICCChallenge) command to the eSIM module.

S1705: After receiving the eUICC random number obtaining command, the eSIM module may return a response command 2 to the first processing module. The response command 2 may carry an eUICC random number (eUICCChallenge).

The eSIM module may return the response command 2 to the LPA in the first processing module.

S1706: The first processing module may generate a TEE temporary working public key (otPK.TEE.ECKA), a TEE temporary working private key (otSK.TEE.ECKA), a device random number (deviceChallenge), and a host identity (HostID).

The LPA in the first processing module may invoke the encryption/decryption TA through the encryption/decryption CA to generate the TEE temporary working public key (otPK.TEE.ECKA) and the TEE temporary working private key (otSK.TEE.ECKA).

The LPA may generate the device random number (deviceChallenge), and obtain the host identity (HostID).

S1707: The first processing module sends a store data command 3 to the eSIM module, where the store data command 3 carries the device random number, the host identity, and the TEE temporary working public key.

The LPA in the first processing module may send the store data command 3 to the eSIM module.

S1708: The eSIM module generates an eUICC temporary working public key (ot.PK.EUICC.ECKA) and an eUICC temporary working private key (ot.SK.EUICC.ECKA).

S1709: The eSIM module sends a response command 5 to the first processing module, where the response command 5 carries the eUICC temporary working public key.

The eSIM module sends the response command 5 to the LPA in the first processing module.

S1710: The first processing module generates a shared secret key (ShS) based on the eUICC temporary working public key and the TEE temporary working private key.

The LPA in the first processing module may invoke the encryption/decryption TA through the encryption/decryption CA, generate the shared secret key (ShS) based on the eUICC temporary working public key and the TEE temporary working private key, and store the shared secret key in the TEE.

S1711: The first processing module obtains a device identity. The device identity may include a chip identity of the first processing module.

The LPA in the first processing module may obtain the device identity.

S1712: The first processing module encrypts the device identity and the eUICC random number into device binding information by using the ShS, the host identity, and the EID, and generates a command message authentication code (C-MAC).

The LPA in the first processing module invokes the encryption/decryption TA through the encryption/decryption CA to encrypt the device identity and the eUICC random number into the device binding information by using the ShS, the host identity, and the EID, and generate the command message authentication code (C-MAC).

Specifically, for a process of encrypting the device identity and the eUICC random number into the device binding information, refer to step S726 in the embodiment shown in FIG. 7D. Details are not described herein again.

S1713: The first processing module sends a store data command 2 to the eSIM module. The store data command 2 carries the device binding information and the C-MAC.

The LPA in the first processing module may send the store data command 2 to the eSIM module. Specifically, for text descriptions of the data command 2, refer to step S727 in the embodiment shown in FIG. 7D.

S1714: The eSIM module generates the shared secret key (ShS) based on the TEE temporary working public key and the eUICC temporary working private key.

S1715: After obtaining the store data command 2, the eSIM module may verify the C-MAC by using the ShS, the host identity, and the EID, decrypt the binding information to obtain the device identity and an eUICC random number, and verify the eUICC random number obtained through decryption.

S1716: After verification on the eUICC random number decrypted from the binding information succeeds, the eSIM module encrypts the device random number into eUICC encrypted data by using the shared secret key, the host identity, and the EID, and generates a response message authentication code (R-MAC).

S1717: The eSIM module may send a response command 4 to the first processing module. The response command 4 carries the eUICC encrypted data and the R-MAC.

S1718: The first processing module verifies the R-MAC by using the ShS, the host identity, and the EID, decrypts a device random number from the eUICC encrypted data, and verifies the device random number obtained through decryption.

The LPA in the first processing module may invoke the encryption/decryption TA through the encryption/decryption CA, to verify the R-MAC by using the ShS, the host identity, and the EID, decrypt a device random number from the eUICC encrypted data, and verify the device random number obtained through decryption.

S1719: After verification on the device random number obtained through decryption succeeds, the first processing module sends a store data command 3 to the eSIM module. The store data command 3 indicates that the device-card binding interaction ends.

S1720: After receiving the store data command 3, the eSIM module sets a device binding status to a bound state, and stores the device identity.

S1721: The eSIM module returns a binding complete status code to the first CPU. The binding complete status code indicates that the device-card binding is completed.

For specific text descriptions of step S1714 to step S1721, refer to step S728 to step S735 in the embodiment shown in FIG. 7C and FIG. 7D. Details are not described herein again.

According to the eSIM authentication method provided in this embodiment of this application, because a production line is secure and controllable, security issues such as a man-in-the-middle attack may not be considered. Therefore, when the temporary working public keys are exchanged between the first processing module and the eSIM module, certificate check and signatures may not be required. In this way, the eSIM module is bound to the device identity.

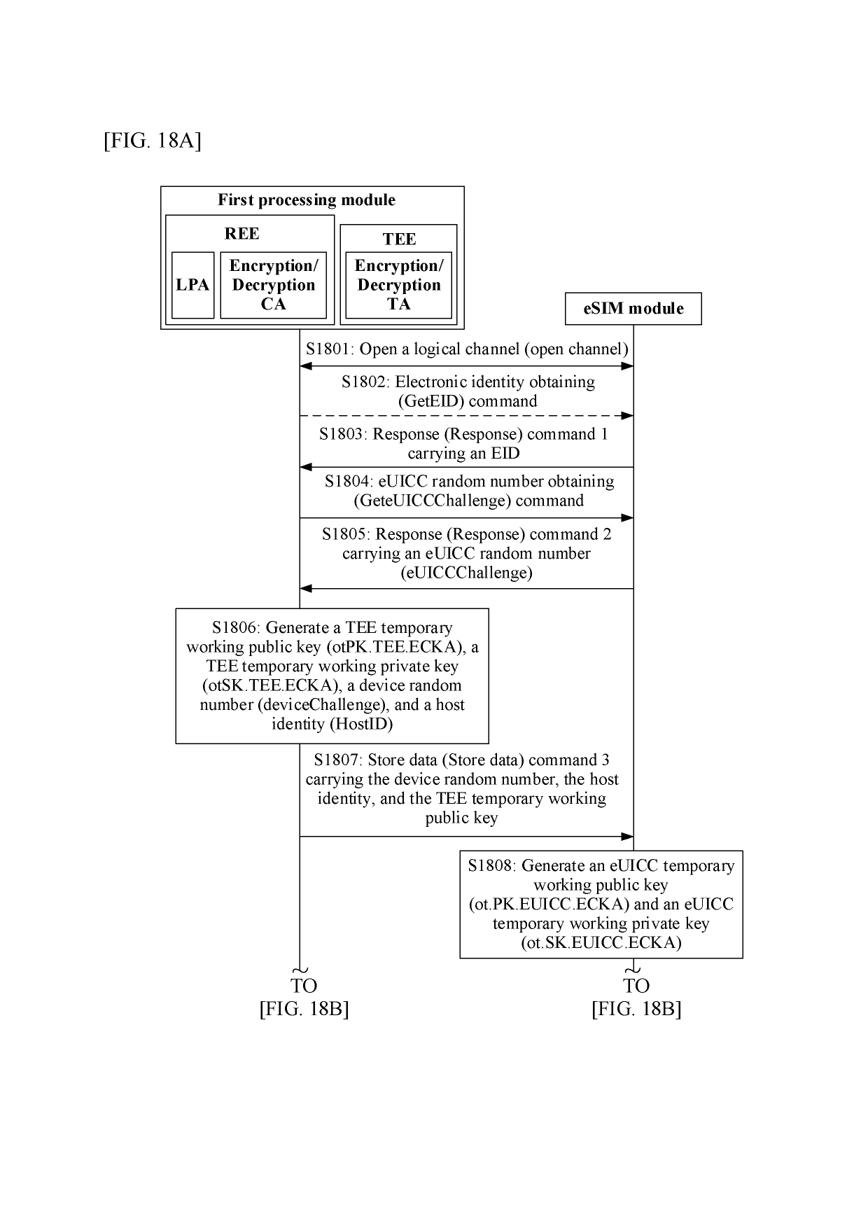

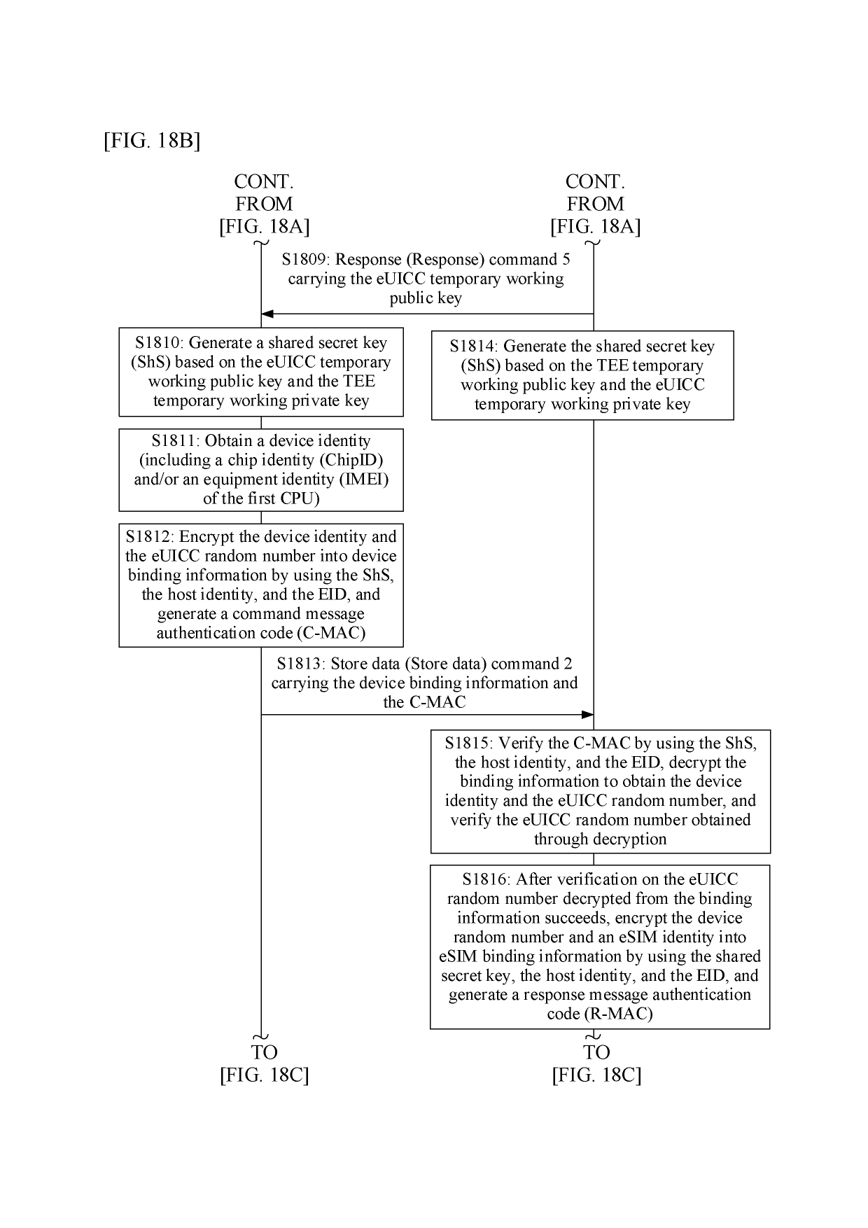

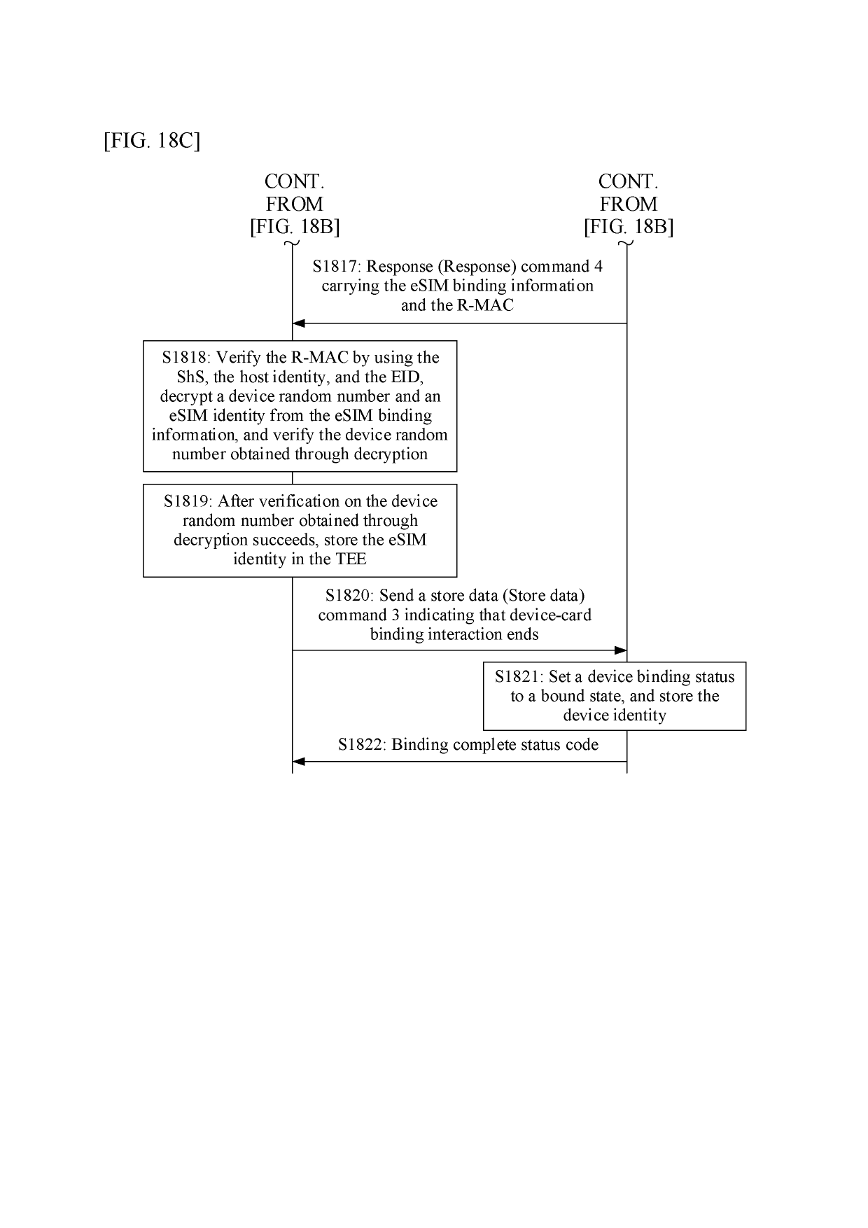

FIG. 18A to FIG. 18C are a schematic flowchart of signaling interaction for two-way device-card binding in an eSIM authentication method according to an embodiment of this application.

The eSIM authentication method may be applied to a first electronic device including a first processing module and an eSIM module. An REE and a TEE may run in the first processing module. An LPA and an encryption/decryption CA may run in the REE, and an encryption/decryption TA may run in the TEE. For specific descriptions of the REE and the TEE, refer to the embodiments shown in FIG. 2 to FIG. 4 or the embodiments shown in FIG. 11 to FIG. 12B. Details are not described herein again.

As shown in FIG. 18A to FIG. 18C, the device-card binding signaling interaction procedure in the eSIM authentication method may include the following steps.

S1801: The first processing module may open a logical channel (open channel) with the eSIM module.

The LPA in the first processing module may open the logical channel with the eSIM module.

S1802: The first processing module may send an electronic identity obtaining (GetEID) command to the eSIM module.

The LPA in the first processing module may send the electronic identity obtaining command to the eSIM module.

S1803: After receiving the electronic identity obtaining command, the eSIM module may return a response command 1 to the first processing module. The response command 1 carries an EID.

The eSIM module may send the response command 1 to the LPA in the first processing module.

S1804: The first processing module may send an eUICC random number obtaining (GeteUICCChallenge) command to the eSIM module.

The LPA in the first processing module may send the eUICC random number obtaining (GeteUICCChallenge) command to the eSIM module.

S1805: After receiving the eUICC random number obtaining command, the eSIM module may return a response command 2 to the first processing module. The response command 2 may carry an eUICC random number (eUICCChallenge).

The eSIM module may return the response command 2 to the LPA in the first processing module.

S1806: The first processing module may generate a TEE temporary working public key (otPK.TEE.ECKA), a TEE temporary working private key (otSK.TEE.ECKA), a device random number (deviceChallenge), and a host identity (HostID).

The LPA in the first processing module may invoke the encryption/decryption TA through the encryption/decryption CA to generate the TEE temporary working public key (otPK.TEE.ECKA) and the TEE temporary working private key (otSK.TEE.ECKA).

The LPA may generate the device random number (deviceChallenge), and obtain the host identity (HostID).

S1807: The first processing module sends a store data command 3 to the eSIM module, where the store data command 3 carries the device random number, the host identity, and the TEE temporary working public key.

The LPA in the first processing module may send the store data command 3 to the eSIM module.

S1808: The eSIM module generates an eUICC temporary working public key (ot.PK.EUICC.ECKA) and an eUICC temporary working private key (ot.SK.EUICC.ECKA).

S1809: The eSIM module sends a response command 5 to the first processing module, where the response command 5 carries the eUICC temporary working public key.

The eSIM module sends the response command 5 to the LPA in the first processing module.

S1810: The first processing module generates a shared secret key (ShS) based on the eUICC temporary working public key and the TEE temporary working private key.

The LPA in the first processing module may invoke the encryption/decryption TA through the encryption/decryption CA, generate the shared secret key (ShS) based on the eUICC temporary working public key and the TEE temporary working private key, and store the shared secret key in the TEE.

S1811: The first processing module obtains a device identity. The device identity may include a chip identity of the first processing module.

The LPA in the first processing module may obtain the device identity.

S1812: The first processing module encrypts the device identity and the eUICC random number into device binding information by using the ShS, the host identity, and the EID, and generates a command message authentication code (C-MAC).

The LPA in the first processing module invokes the encryption/decryption TA through the encryption/decryption CA to encrypt the device identity and the eUICC random number into the device binding information by using the ShS, the host identity, and the EID, and generate the command message authentication code (C-MAC).

Specifically, for a process of encrypting the device identity and the eUICC random number into the device binding information, refer to step S726 in the embodiment shown in FIG. 7D. Details are not described herein again.

S1813: The first processing module sends a store data command 2 to the eSIM module. The store data command 2 carries the device binding information and the C-MAC.

The LPA in the first processing module may send the store data command 2 to the eSIM module. Specifically, for text descriptions of the data command 2, refer to step S727 in the embodiment shown in FIG. 7D.

S1814: The eSIM module generates the shared secret key (ShS) based on the TEE temporary working public key and the eUICC temporary working private key.

S1815: After obtaining the store data command 2, the eSIM module may verify the C-MAC by using the ShS, the host identity, and the EID, decrypt the binding information to obtain the device identity and the eUICC random number, and verify the eUICC random number obtained through decryption.

S1816: After verification on the eUICC random number decrypted from the binding information succeeds, the eSIM module encrypts the device random number and the eSIM identity into eSIM binding information by using the shared secret key, the host identity, and the EID, and generates a response message authentication code (R-MAC).

S1817: The eSIM module may send a response command 4 to the first processing module. The response command 4 carries the eSIM binding information and the R-MAC.

For a specific process of encrypting the eSIM binding information in the step, refer to the process of encrypting the eUICC encrypted data in the embodiment in FIG. 7A to FIG. 7E. Details are not described herein again.

S1818: The first processing module verifies the R-MAC by using the ShS, the host identity, and the EID, decrypts a device random number and an eSIM identity from the eSIM binding information, and verifies the device random number obtained through decryption.

The LPA in the first processing module may invoke the encryption/decryption TA through the encryption/decryption CA, to verify the R-MAC by using the ShS, the host identity, and the EID, decrypt the device random number and the eSIM identity from the eSIM binding information, and verify the device random number obtained through decryption.

For a process of decrypting the eSIM binding information, refer to the related process of decrypting the eUICC in the embodiment shown in FIG. 7A to FIG. 7E. Details are not described herein again.

S1819: After verification on the device random number obtained through decryption succeeds, the first processing module stores the eSIM identity in the TEE.

The LPA in the first processing module may invoke the encryption/decryption TA through the encryption/decryption CA, to store the eSIM identity in the TEE.

S1820: The first processing module sends a store data command 3 to the eSIM module. The store data command 3 indicates that the device-card binding interaction ends.

S1821: After receiving the store data command 3, the eSIM module sets a device binding status to a bound state, and stores the device identity.

S1822: The eSIM module returns a binding complete status code to the first CPU. The binding complete status code indicates that the device-card binding is completed.

For specific text descriptions of step S1820 to step S1822, refer to step S733 to step S735 in the embodiment shown in FIG. 7E. Details are not described herein again.

According to the eSIM authentication method provided in this embodiment of this application, because a production line is secure and controllable, security issues such as a man-in-the-middle attack may not be considered. Therefore, when the temporary working public keys are exchanged between the first processing module and the eSIM module, certificate check and signatures may not be required. In this way, two-way binding between the eSIM module and the device (which may be specifically the first processing module) is completed.

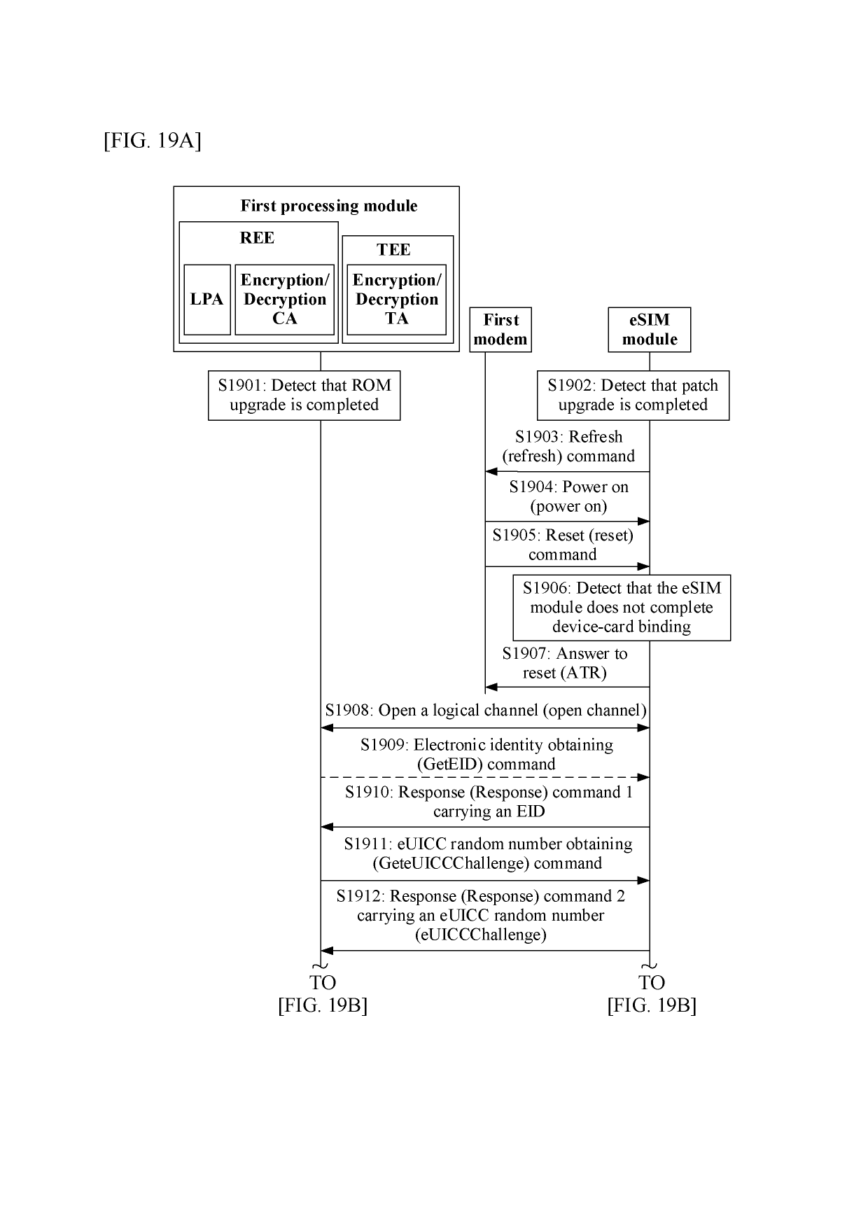

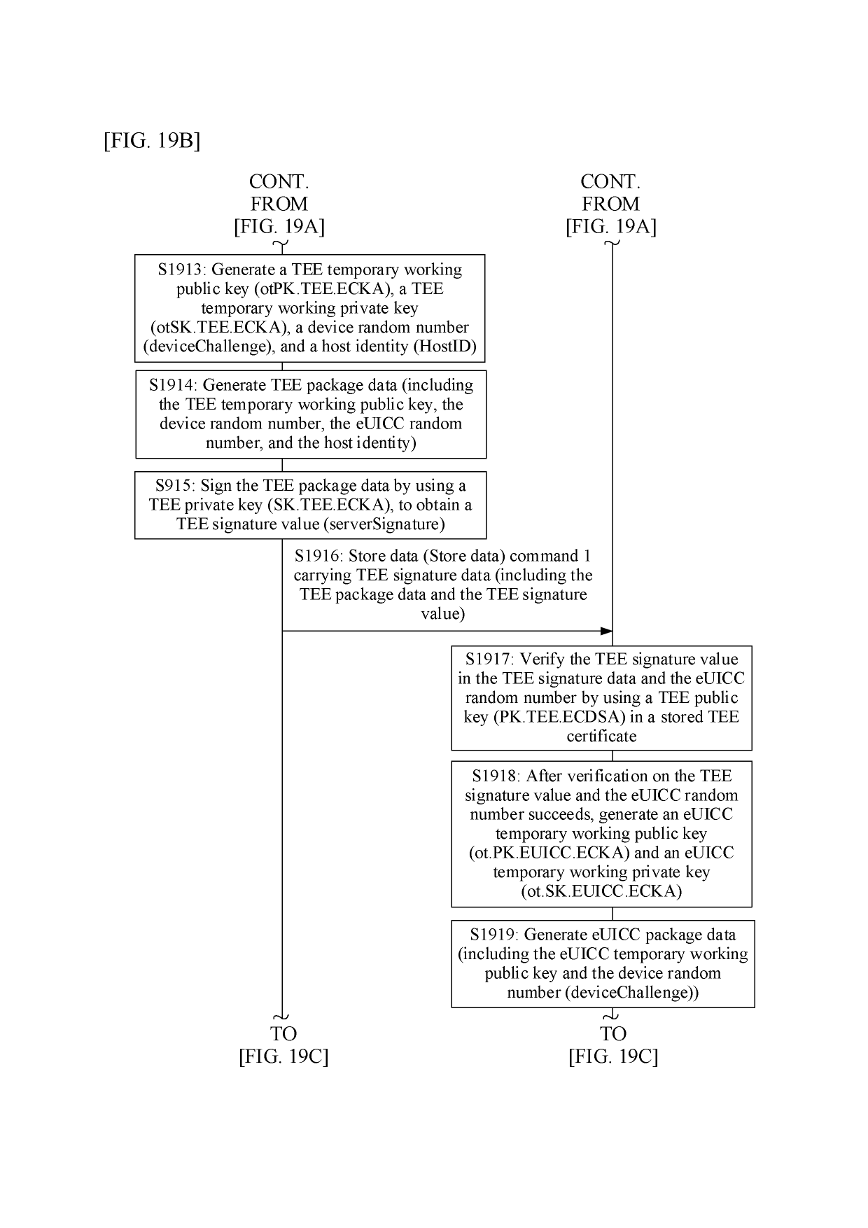

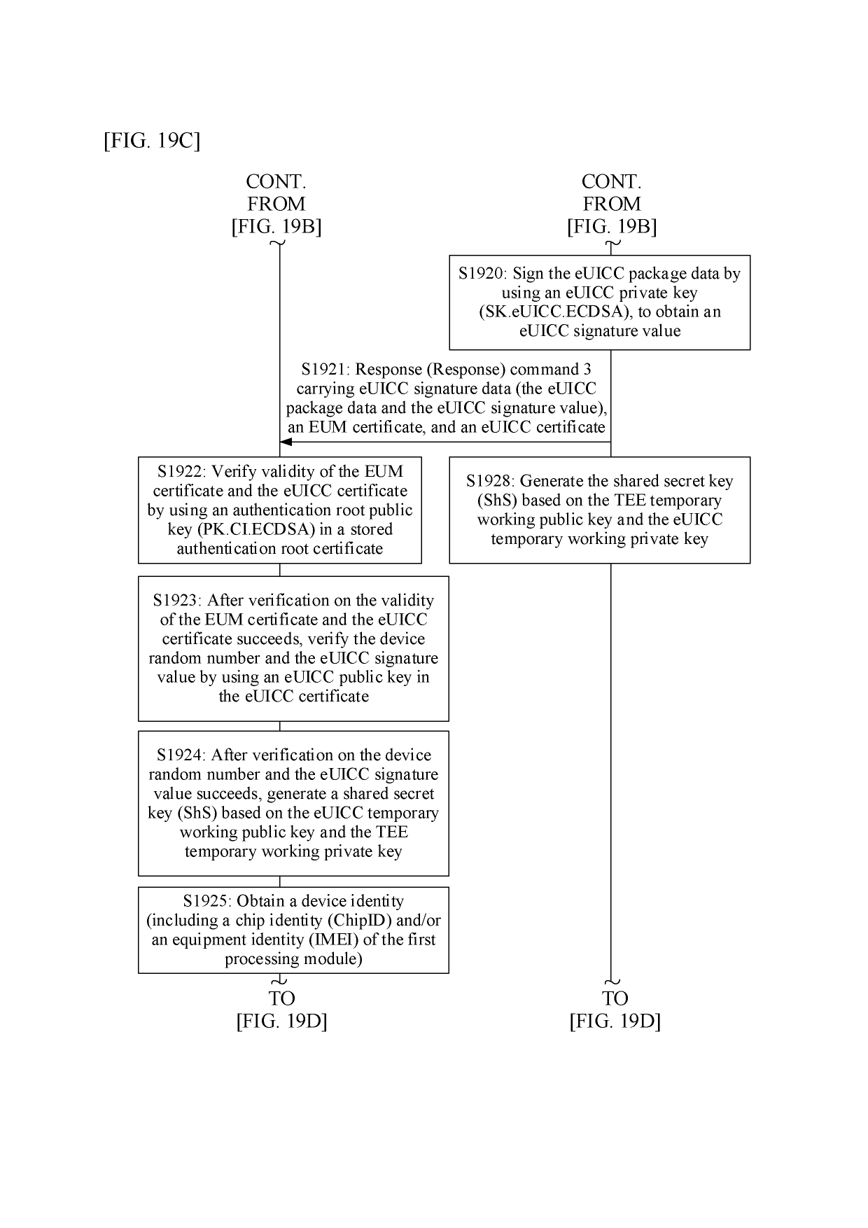

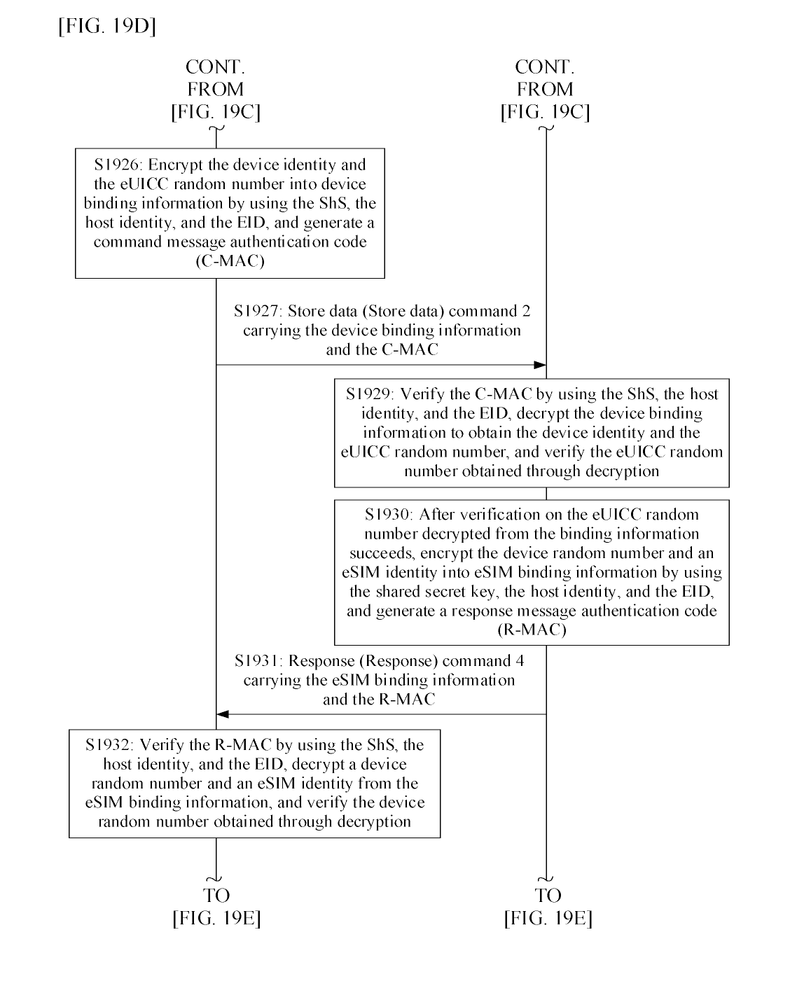

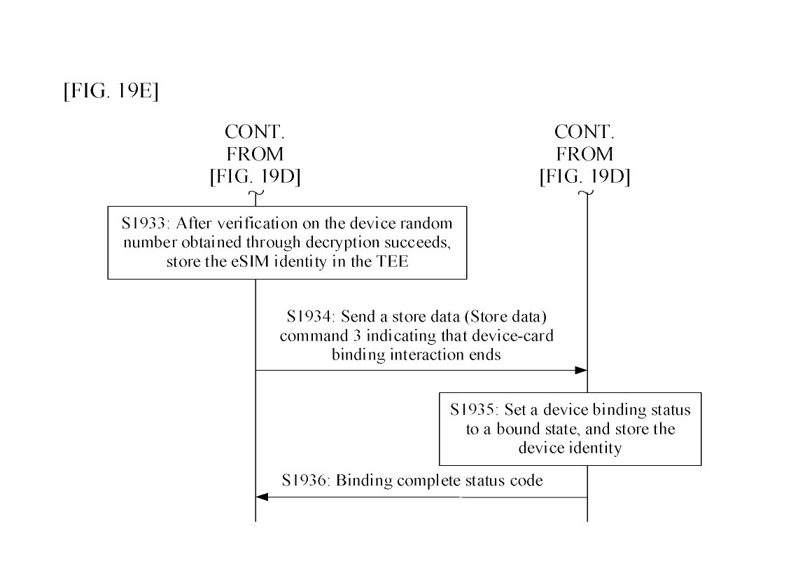

FIG. 19A to FIG. 19E are a schematic flowchart of signaling interaction for two-way device-card binding in an eSIM authentication method according to another embodiment of this application.

The eSIM authentication method may be applied to a first electronic device including a first processing module and an eSIM module. An REE and a TEE may run in the first processing module. An LPA and an encryption/decryption CA may run in the REE, and an encryption/decryption TA may run in the TEE. For specific descriptions of the REE and the TEE, refer to the embodiments shown in FIG. 2 to FIG. 4 or the embodiments shown in FIG. 11 to FIG. 12B. Details are not described herein again.

As shown in FIG. 19A to FIG. 19E, the device-card binding signaling interaction procedure in the eSIM authentication method may include the following steps.

S1901: The first processing module detects that ROM upgrade is completed.

S1902: The eSIM module detects that patch upgrade is completed.

S1903: The eSIM module may send a refresh command to a first modem.

S1904: The first modem powers on the eSIM module.

S1905: After powering on the eSIM module, the first modem sends a reset command to the eSIM module.

S1906: The eSIM module may detect that the eSIM module does not complete device-card binding.

S1907: The eSIM module may send an answer to reset (ATR) to the first modem.

S1908: The first processing module may open a logical channel (open channel) with the eSIM module.

S1909: The first processing module may send an electronic identity obtaining (GetEID) command to the eSIM module.

S1910: After receiving the electronic identity obtaining command, the eSIM module may return a response command 1 to the first processing module. The response command 1 carries an EID.

S1911: The first processing module may send an eUICC random number obtaining (GeteUICCChallenge) command to the eSIM module.

S1912: After receiving the eUICC random number obtaining command, the eSIM module may return a response (command 2 to the first processing module. The response command 2 may carry an eUICC random number (eUICCChallenge).

S1913: The first processing module may generate a TEE temporary working public key (otPK.TEE.ECKA), a TEE temporary working private key (otSK.TEE.ECKA), a device random number (deviceChallenge), and a host identity (HostID).

S1914: The first processing module may generate TEE package data. The TEE package data includes the TEE temporary working public key, the device random number, the eUICC random number, and the host identity.

S1915: The first processing module may sign the TEE package data by using a TEE private key (SK.TEE.ECKA), to obtain a TEE signature value (serverSignature).

The LPA may invoke the encryption/decryption CA, and invoke the encryption/decryption TA through the encryption/decryption CA to sign the TEE package data by using the TEE private key (SK.TEE.ECDSA), to obtain the TEE signature value (serverSignature).

In a possible implementation, the TEE private key (SK.TEE.ECDSA) may be an OEM private key (SK.OEM.ECDSA) corresponding to the terminal certificate (CERT.OEM.ECDSA) in the foregoing embodiment, the TEE public key (PK.TEE.ECDSA) paired with the TEE private key (SK.TEE.ECDSA) may be used as the OEM public key in the terminal certificate (CERT.OEM.ECDSA) in the foregoing embodiment. (PK.OEM.ECDSA).

S1916: The first processing module may send a store data command 1 to the eSIM module. The store data command 1 carries TEE signature data, and the TEE signature data may include the TEE package data and the TEE signature value.

S1917: After receiving the store data command 1, the eSIM module may verify the TEE signature value in the TEE signature data and the eUICC random number by using the TEE public key (PK.TEE.ECDSA) in the stored TEE certificate.

S1918: After verification on the TEE signature value and the eUICC random number succeeds, the eSIM module may generate an eUICC temporary working public key (ot.PK.EUICC.ECKA) and an eUICC temporary working private key (ot.SK.EUICC.ECKA).

S1919: The eSIM module may generate eUICC package data. The eUICC package data may include the eUICC temporary working public key and a device random number (deviceChallenge).

S1920: The eSIM module may sign the eUICC package data by using an eUICC private key (SK.eUICC.ECDSA), to obtain an eUICC signature value.

S1921: The eSIM module may send a response command 3 to the first CPU. The response command 3 carries the eUICC signature data, the EUM certificate (CERT.EUM.ECDSA), and the eUICC certificate (CERT.eUICC.ECDSA).

S1922: After receiving the response command 3, the first processing module may verify validity of the EUM certificate and the eUICC certificate by using the authentication root public key (PK.CI.ECDSA) in a stored authentication root certificate.

S1923: After verification on the validity of the EUM certificate and the eUICC certificate succeeds, the first processing module may verify the device random number and the eUICC signature value by using an eUICC public key in the eUICC certificate.

S1924: After verification on the device random number and the eUICC signature value succeeds, the first processing module generates the shared secret key (ShS) based on the eUICC temporary working public key and the TEE temporary working private key.

For specific text descriptions of step S1901 to step S1924, refer to step S701 to step S724 in the embodiment shown in FIG. 7A to FIG. 7D.

S1925: The first processing module may obtain a device identity. The device identity may include a chip identity (ChipID), an equipment identity (IMEI), and/or the like of the first processing module.

S1926: The first processing module may encrypt the device identity and the eUICC random number into device binding information by using the ShS, the host identity, and the EID, and generate a command message authentication code (C-MAC).

S1927: The first processing module may send a store data command 2 to the eSIM module. The store data command 2 may carry the device binding information and the C-MAC.

S1928: After sending the response command 3 to the first processing module, the eSIM module may generate the ShS based on the TEE temporary working public key and the eUICC temporary working private key.

S1929: After obtaining the store data command 2, the eSIM module may verify the C-MAC by using the ShS, the host identity, and the EID, decrypt the device binding information to obtain the device identity and the eUICC random number, and verify the eUICC random number obtained through decryption.

S1930: After verification on the eUICC random number decrypted from the binding information succeeds, the eSIM module encrypts the device random number and the eSIM identity into eSIM binding information by using the shared secret key, the host identity, and the EID and generates a response message authentication code (R-MAC).

S1931: The eSIM module may send a response command 4 to the first processing module. The response command 4 carries the eSIM binding information and the R-MAC.

S1932: The first processing module verifies the R-MAC by using the ShS, the host identity, and the EID, decrypts a device random number and an eSIM identity from the eSIM binding information, and verifies the device random number obtained through decryption.

S1933: After verification on the device random number obtained through decryption succeeds, the first processing module stores the eSIM identity in the TEE.

S1934: After verification on the device random number obtained through decryption succeeds, the first processing module sends a store data command 3 to the eSIM module. The store data command 3 indicates that the device-card binding interaction ends.

S1935: After receiving the store data command 3, the eSIM module sets the device binding status to a bound state, and stores the device identity.

S1936: The eSIM module returns a binding complete status code to the first processing module. The binding complete status code indicates that the device-card binding is completed.

For specific text descriptions of step S1925 to step S1936, refer to step S1811 to step S1822 in the embodiment shown in FIG. 18A to FIG. 18C.

According to the eSIM authentication method provided in this embodiment of this application, after an occasion like the first electronic device is in a production line before delivery, a system is upgraded after the first electronic device is delivered and sold, or the first electronic device is powered on for the first time after delivery, the first processing module and the eSIM module in the first electronic device can first verify certificates and exchange the temporary public keys of the two parties, and then agree on the shared secret key based on their own temporary private keys and the temporary public key of the peer party. The first processing module encrypts the device identity by using the shared secret key, generates the device binding information, and sends the device binding information to the eSIM module. The eSIM module may decrypt a first device identity from the device binding information by using the shared secret key, and store the first device identity. The eSIM module may also encrypt a first eSIM identity by using the shared secret key, to generate the eSIM binding information. The eSIM module may send the eSIM binding information to the first processing module. The first processing module may decrypt the first eSIM identity from the eSIM binding information by using the shared secret key, and store the first device identity in the TEE. In this way, two-way binding between the eSIM module and the first processing module can be completed.

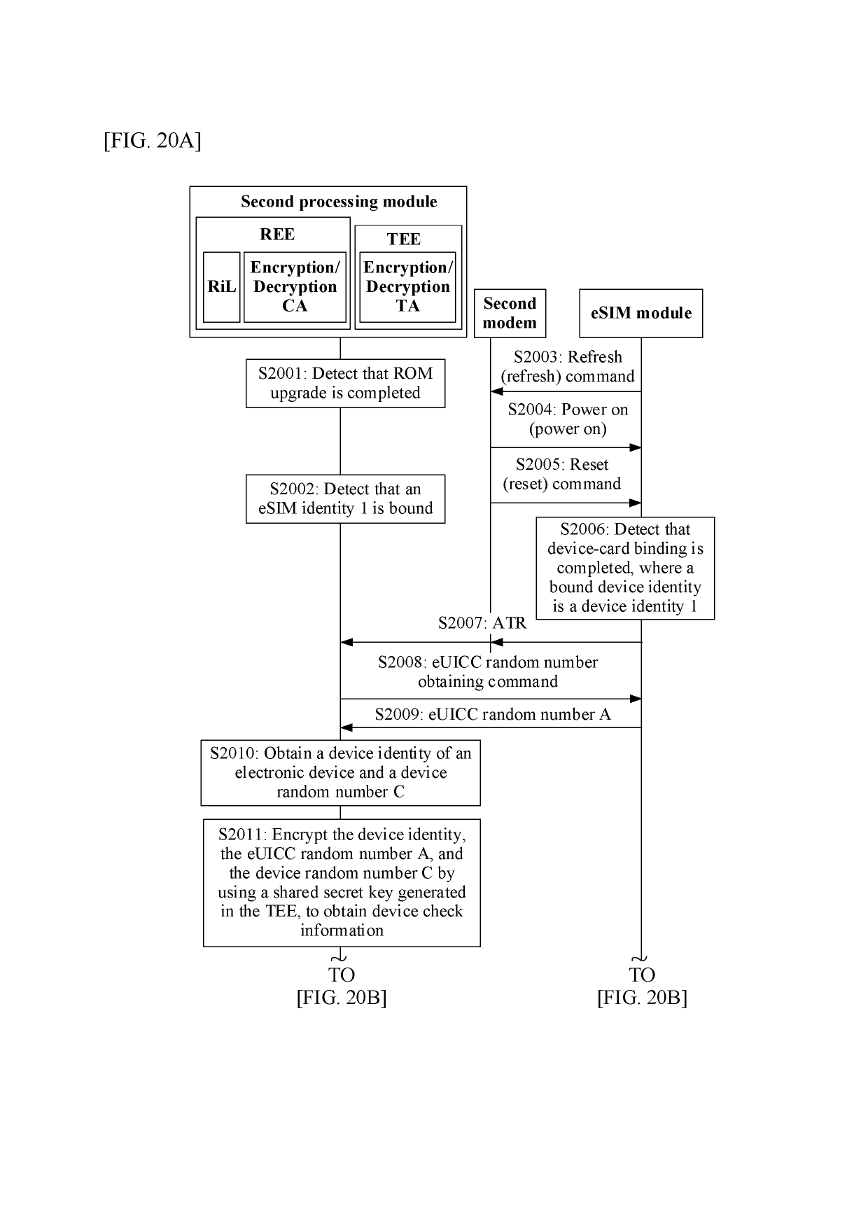

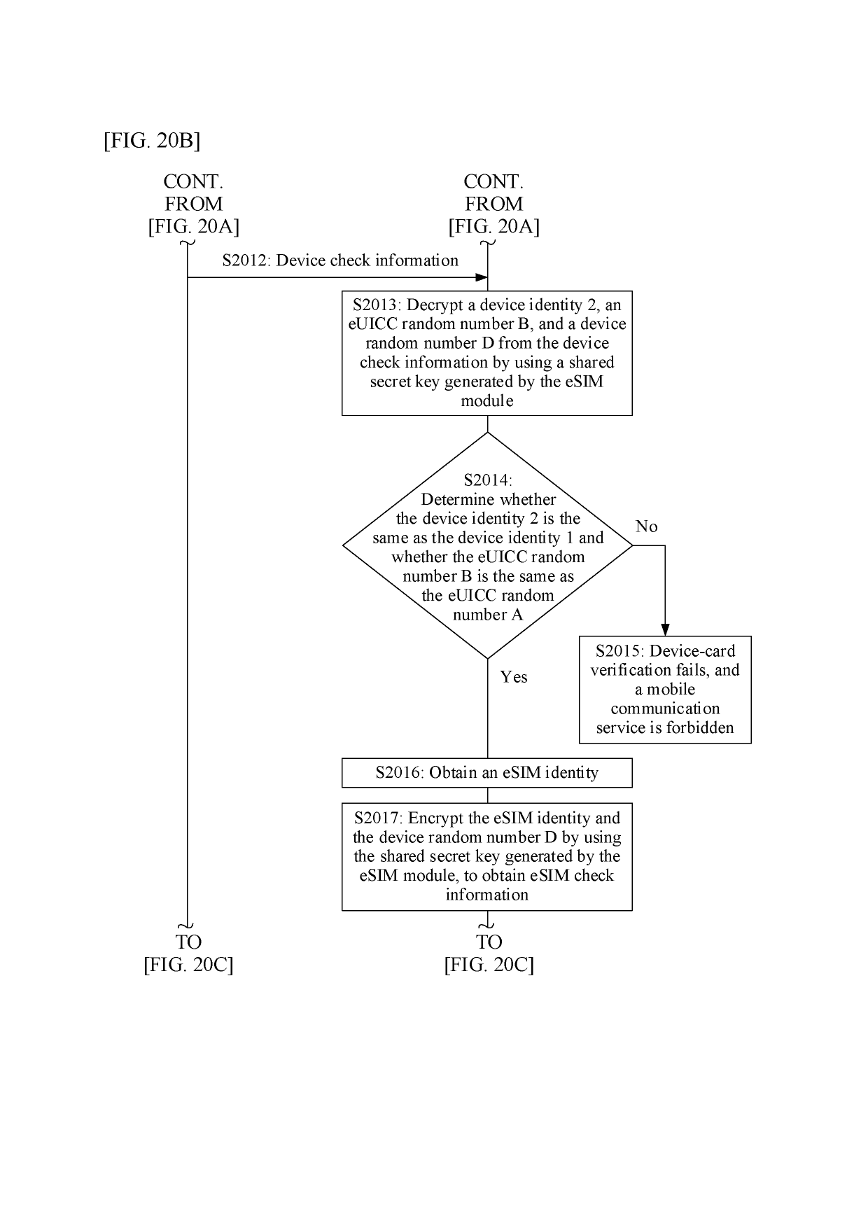

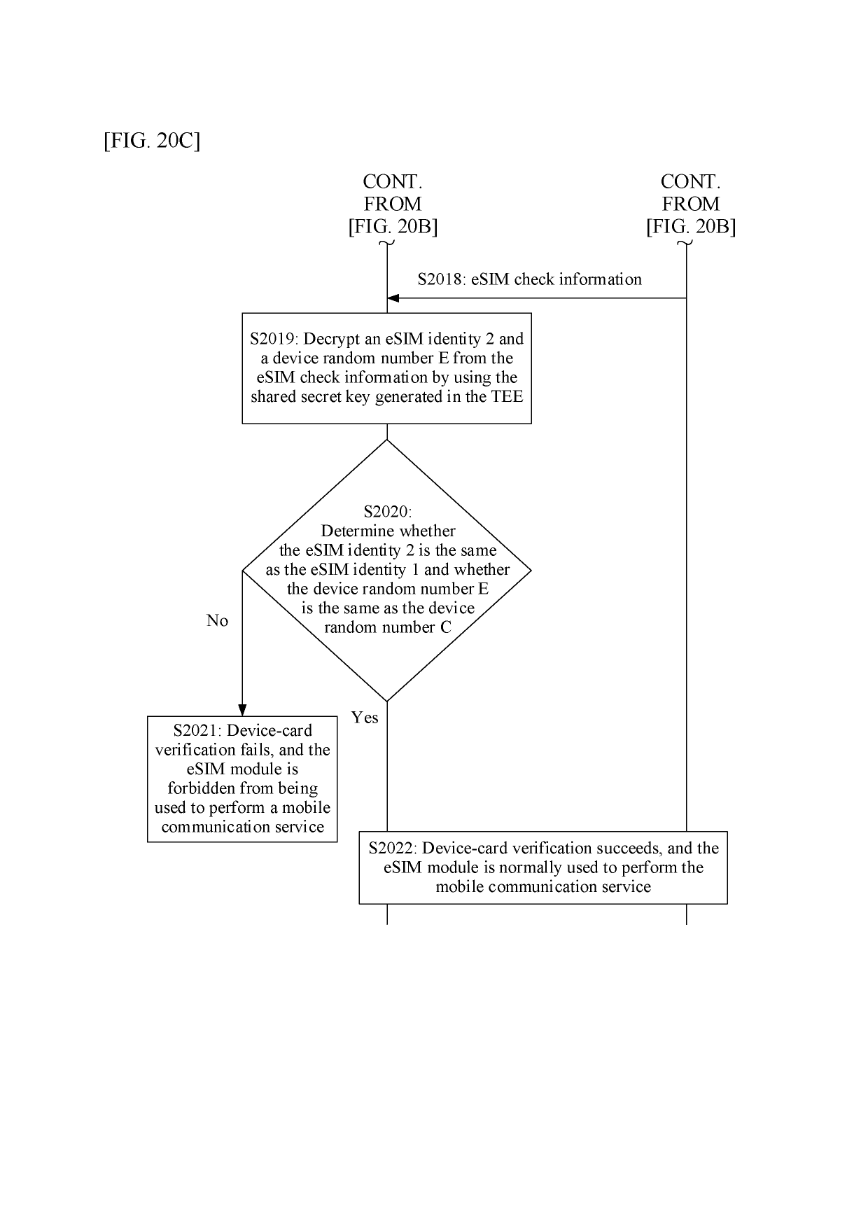

FIG. 20A to FIG. 20C are a schematic flowchart of two-way device-card verification in an eSIM authentication method according to an embodiment of this application.

The eSIM authentication method may be applied to an electronic device including a second CPU and an eSIM module. An REE and a TEE may run in the second CPU. An RiL and an encryption/decryption CA may run in the REE, and an encryption/decryption TA may run in the TEE. For specific descriptions of the REE and the TEE, refer to the embodiments shown in FIG. 2 to FIG. 4 or the embodiments shown in FIG. 11 to FIG. 12B. Details are not described herein again. It should be noted that the RiL is merely an example for explanation and is not limited in this application. During specific implementation, a function of the RiL may alternatively be integrated into another module in another REE.

As shown in FIG. 20A to FIG. 20C, the device-card verification procedure may include the following steps.

S2001: The second processing module detects that ROM upgrade is completed.

S2002: The second processing module detects that an eSIM identity 1 is bound.

S2003: The eSIM module sends a refresh command to a second modem.

The refresh command may be a proactive command.

S2004: The second modem powers on the eSIM module.

After receiving the refresh command, the second modem may power on the eSIM module again.

S2005: After powering on the eSIM module, the second modem sends a reset command to the eSIM module.

S2006: The eSIM module may detect that the eSIM module has completed device-card binding.

After receiving the reset command, the eSIM module may complete a reset operation, and detect, by using a bound device tag, that the device-card binding is completed.

S2007: The eSIM module may send an ATR to the second processing module through the second modem.

The ATR indicates that the reset of the eSIM module is completed.

S2008: The second processing module sends an eUICC random number obtaining command to the eSIM module.

The RiL in the REE may send the eUICC random number obtaining command to the eSIM module.

S2009: The eSIM module sends an eUICC random number A to the second processing module.

The eSIM module sends the eUICC random number A to the RiL in the REE.

S2010: The second processing module obtains a device identity of the electronic device and a device random number C.

The RiL in the REE may obtain the device identity of the electronic device and the device random number C.

S2011: The second processing module may encrypt the device identity, the eUICC random number A, and the device random number C by using a shared secret key generated in the TEE, to obtain check information.

The RiL in the REE may invoke the encryption/decryption TA in the TEE through the encryption/decryption CA, and encrypt the device identity, the eUICC random number A, and the device random number C by using the shared secret key generated in the TEE, to obtain the check information.

S2012: The second processing module sends the device check information to the eSIM module.

S2013: The eSIM module may decrypt a device identity 2, an eUICC random number B, and a device random number D from the device check information by using the shared secret key generated by the eSIM module.

S2014: The eSIM module may determine whether the device identity 2 is the same as the device identity 1 and whether the eUICC random number B is the same as the eUICC random number A.

S2015: If the device identity 2 is different from the device identity 1 or the eUICC random number B is different from the eUICC random number A, device-card verification fails, and the eSIM module is forbidden from performing a mobile communication service.

S2016: If the device identity 2 is the same as the device identity 1, and the eUICC random number B is the same as the eUICC random number A, the eSIM module obtains an eSIM identity.

S2017: The eSIM module encrypts the eSIM identity and the device random number D by using the shared secret key generated by the eSIM module, to obtain eSIM check information.

S2018: The eSIM module sends the eSIM check information to the second processing module.

S2019: The second processing module decrypts an eSIM identity 2 and a device random number E from the eSIM check information by using the shared secret key generated in the TEE.

The RiL in the REE may invoke the encryption/decryption TA in the TEE through the encryption/decryption CA, to decrypt the eSIM identity 2 and the device random number E from the eSIM check information.

S2020: The second processing module determines whether the eSIM identity 2 is the same as the eSIM identity 1 and whether the device random number E is the same as the device random number C.

The RiL in the REE may determine whether the eSIM identity 2 is the same as the eSIM identity 1 and whether the device random number E is the same as the device random number C.

S2021: If the eSIM identity 2 is different from the eSIM identity 1, or the device random number E is different from the device random number C, the device-card verification fails, and the eSIM module is forbidden from being used to perform the mobile communication service.

In a possible implementation, if the eSIM identity 2 is different from the eSIM identity 1, or the device random number E is different from the device random number C, the RiL in the REE may notify the modem that the eSIM module is forbidden from being used to perform the mobile communication service.

S2022: If the eSIM identity 2 is the same as the eSIM identity 1, and the device random number E is the same as the device random number C, the device-card verification succeeds, and the eSIM module is normally used to perform the mobile communication service.

If the device-card verification fails, it indicates that the second processing module is not bound to the eSIM module.

In a possible implementation, if the second processing module does not receive, after the eSIM module is powered off and then powered on, the eSIM check information sent by the eSIM module, or the eSIM module does not receive, after the eSIM module is powered off and then powered on, the device check information sent by the second processing module, the device-card verification fails.

In a possible implementation, if the device-card verification performed on the second processing module and the eSIM module fails, the second processing module may perform device-card verification with the eSIM module again. If the device-card verification fails for a specified quantity of times (for example, three times), the second processing module and the eSIM module are permanently locked.

According to the eSIM authentication method provided in this embodiment of this application, when the eSIM module is powered on again or before the eSIM module needs to perform the mobile communication service, the eSIM module and the second processing module that communicates with the eSIM module in this case may verify validity of each other. In this way, the eSIM module in the electronic device can be prevented from accessing a mobile communication network after the eSIM module is disassembled and inserted into another device, and the electronic device can also be prevented from being used by a disassembled eSIM module of another device to access the mobile communication network, thereby improving security when the eSIM module accesses the mobile communication network.

In some embodiments, an eSIM authentication method is applied to an electronic device including a processing module and a second eSIM module. The method includes: A TEE of the processing module stores a first eSIM identity sent by a first eSIM module; the second eSIM module obtains a second eSIM identity of the second eSIM module after the second eSIM module is powered off and then powered on; the second eSIM module encrypts the second eSIM identity to obtain eSIM check information; the second eSIM module sends eSIM check information to the processing module; the processing module decrypts a second eSIM identity from the eSIM check information; and if the second eSIM identity is the same as the first eSIM identity, the processing module normally uses the second eSIM module to perform a mobile communication service; or if the second eSIM identity is different from the first eSIM identity, or the processing module does not receive, after the second eSIM module is powered off and then powered on, the device check information sent by the second processing module, the processing module is forbidden from using the second eSIM module to perform a mobile communication service.

According to the eSIM authentication method provided in this embodiment of this application, the processing module and the first eSIM module in an electronic device may first agree on a shared key. Then, the first eSIM module encrypts an eSIM identity by using the shared secret key, generates eSIM binding information, and sends the eSIM binding information to the processing module. The processing module may decrypt the first eSIM identity from the eSIM binding information by using the shared secret key, and store the first eSIM identity. When the eSIM module is powered on again or before the eSIM module needs to perform the mobile communication service, the processing module may enable the second eSIM module that communicates with the processing module in this case to obtain the second eSIM identity, and encrypt the second eSIM identity by using the shared secret key, to generate the eSIM check information. The processing module may decrypt the second eSIM identity from the eSIM check information by using the shared secret key. If the second eSIM identity is the same as the first eSIM identity stored in the TEE of the processing module, it indicates that the second eSIM module and the first eSIM module that is bound to the processing module are a same eSIM module. Therefore, the processing module may normally perform the mobile communication service. If the second eSIM identity is different from the first eSIM identity stored in the TEE of the processing module, or the processing module does not receive, after the second eSIM module is powered off and then powered on, the device check information sent by the second processing module, it indicates that the second eSIM module and the first eSIM module that is bound to the processing module are not a same eSIM module. Therefore, the processing module may be forbidden from using the second eSIM to perform the mobile communication service. In this way, the eSIM module in the electronic device can be prevented from accessing a mobile communication network after the eSIM module is disassembled and inserted into another device, thereby improving security when the eSIM module accesses the mobile communication network.

In a possible implementation, before the TEE of the processing module stores the first eSIM identity sent by the first eSIM module, the method further includes: The processing module receives the eSIM binding information sent by the first eSIM module; and the processing module decrypts the first eSIM identity from the eSIM binding information after receiving the eSIM binding information, and stores the first eSIM identity in the TEE.

In a possible implementation, that the processing module decrypts the first eSIM identity from the eSIM binding information after receiving the eSIM binding information specifically includes: After receiving the eSIM binding information, the processing module decrypts the first eSIM identity from the eSIM binding information by using the shared secret key generated in the TEE in the processing module.

In a possible implementation, that the processing module decrypts the second eSIM identity from the eSIM check information after receiving the eSIM check information specifically includes: After receiving the eSIM check information, the processing module decrypts the second device identity from the check information by using the shared secret key generated in the TEE.

In a possible implementation, before the processing module stores the first eSIM identity sent by the first eSIM module, the method further includes: The processing module generates a TEE temporary working public key and a TEE temporary working private key by using the TEE; the processing module receives an eUICC temporary working public key sent by the first processing module; and the processing module generates the shared secret key based on the TEE temporary working private key and the eUICC temporary working public key.

In a possible implementation, before the processing module receives the eUICC temporary working public key sent by the first eSIM module, the method further includes: The processing module receives TEE signature data sent by the first processing module. The processing module verifies validity of the eUICC signature data by using an eUICC public key in an eUICC certificate. That the processing module receives the eUICC temporary working public key sent by the first eSIM module specifically includes: After verification on the validity of the eUICC signature data succeeds, the processing module obtains the eUICC temporary working public key from the eUICC signature data.

In a possible implementation, before the processing module receives the eUICC signature data sent by the first eSIM module, the method further includes: The processing module receives an EUM certificate and the eUICC certificate that are sent by the first eSIM module; the processing module verifies validity of the EUM certificate by using an authentication root public key in an authentication root certificate; after verification on the validity of the EUM certificate succeeds, the processing module verifies validity of the eUICC certificate by using an EUM public key in the EUM certificate; and after verification on the validity of the eUICC certificate succeeds, the processing module obtains the eUICC public key from the eUICC certificate.

In a possible implementation, the method further includes: The processing module generates the TEE temporary working private key and the TEE temporary working public key in the TEE, where the TEE temporary working private key and the TEE temporary working public key are a pair of public and private keys; the processing module signs the TEE temporary working public key by using a TEE private key, to obtain TEE signature data; and the processing module sends the TEE signature data to the first eSIM module, where the TEE signature data is used by the first eSIM module to obtain the TEE temporary working public key and generate the shared secret key based on the TEE temporary working public key and an eUICC temporary working private key, and the eUICC temporary working private key and the eUICC temporary working public key are a pair of public and private keys.

In a possible implementation, before the processing module receives the eSIM check information sent by the second eSIM module, the method further includes: After detecting that the second eSIM module is powered off and then powered on, the processing module sends a first device random number to the second eSIM module, where the first device random number is encrypted into the eSIM check information together with the second eSIM identity by the second eSIM module.

In a possible implementation, the method further includes: The processing module decrypts a second device random number from the eSIM check information. That the processing module normally uses the second eSIM module to perform the mobile communication service if the second eSIM identity is the same as the first eSIM identity specifically includes: If the second eSIM identity is the same as the first eSIM identity and the second device random number is the same as the first device random number, the processing module normally uses the second eSIM module to perform the mobile communication service.

Specifically, for a process of binding and checking the processing module and the eSIM module, refer to the foregoing embodiments. Details are not described herein again.

In some embodiments, an embodiment of this application provides an eSIM authentication method, which may be applied to an electronic device including a second processing module and a second eSIM module. The method includes: A TEE of the second processing module stores a first eSIM identity sent by a first eSIM module; the second eSIM module stores a first device identity sent by a first processing module; the second eSIM module obtains a second eSIM identity of the second eSIM module after the second eSIM module is powered off and then powered on; the second eSIM module encrypts the second eSIM identity to obtain eSIM check information; the second eSIM module sends the eSIM check information to the second processing module; the second processing module obtains the second device identity, and encrypts the second device identity to obtain device check information; the second processing module decrypts the second eSIM identity from the eSIM check information; the second eSIM module decrypts the second device identity from the device check information; and if the second eSIM identity is the same as the first eSIM identity and the second device identity is the same as the first device identity, the electronic device normally uses the second eSIM module to perform a mobile communication service; or if the second eSIM identity is different from the first eSIM identity, or the second device identity is different from the first device identity, or the second processing module does not receive, after the second eSIM module is powered off and then powered on, the eSIM check information sent by the second eSIM module, or the second eSIM module does not receive, after the second eSIM module is powered off and then powered on, the device check information sent by the second processing module, the electronic device is forbidden from using the second eSIM module to perform a mobile communication service.

According to the eSIM authentication method provided in this embodiment of this application, the second processing module is validly bound to the first eSIM module. Therefore, the TEE of the second processing module stores the first eSIM identity of the first eSIM module and a shared secret key that is agreed-on with the first eSIM module. The second eSIM module is validly bound to the first processing module. Therefore, the second eSIM module stores the first device identity of the first processing module and a shared secret key that is agreed-on with the first processing module. When the second processing module works in cooperation with the second eSIM module, before the second eSIM module is powered on or if the second eSIM module needs to perform the mobile communication service, the second processing module may obtain the second device identity of the second processing module, encrypt the second device identity into the device check information by using the shared secret key, and send the device check information to the second eSIM module. The second eSIM module may also obtain the second eSIM identity of the second eSIM module, encrypt the second eSIM identity into the eSIM check information by using the shared secret key, and send the eSIM check information to the second processing module. The second processing module may decrypt the second eSIM identity from the eSIM check information by using the shared secret key, and the second eSIM module may decrypt the second device identity from the device check information by using the shared secret key. If the second eSIM identity is the same as the first eSIM identity stored in the TEE of the processing module, and the second device identity is the same as the first device identity, it indicates that the second eSIM module and the second processing module are bound to each other. Therefore, the second processing module may normally use the second eSIM module to perform the mobile communication service. If the second eSIM identity is different from the first eSIM identity stored in the TEE of the processing module, or the second device identity is different from the first device identity, or the second processing module does not receive, after the second eSIM module is powered off and then powered on, the eSIM check information sent by the second eSIM module, or the second eSIM module does not receive, after the second eSIM module is powered off and then powered on, the device check information sent by the second processing module, it indicates that the second eSIM module and the second processing module are not bound to each other. Therefore, the second processing module may be forbidden from using the second eSIM to perform the mobile communication service. In this way, the eSIM module in the electronic device can be prevented from accessing a mobile communication network after the eSIM module is disassembled and inserted into another device, thereby improving security when the eSIM module accesses the mobile communication network.

Specifically, for a process of binding and checking the processing module and the eSIM module, refer to the foregoing embodiments. Details are not described herein again.

In conclusion, the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application

What is claimed is:

1. A method applied to an embedded subscriber identity module (eSIM) module, the method comprising:
storing a first device identity sent by a first processing module;
receiving, after detecting that the eSIM module is powered off and then powered on, device check information sent by a second processing module;
decrypting a second device identity from the device check information;
in response to the first device identity being the same as the second device identity, normally performing a mobile communication service; and
in response to the first device identity being different from the second device identity, or in response to the eSIM module not receiving the device check information sent by the second processing module after detecting that the eSIM module is powered off and then powered on, forbidding the eSIM module from performing the mobile communication service.

2. The method according to claim 1, wherein, the method further comprises, before storing the first device identity sent by the first processing module:
receiving device binding information sent by the first processing module; and
decrypting the first device identity from the device binding information after receiving the device binding information, and storing the first device identity.

3. The method according to claim 2, wherein decrypting, by the eSIM module, the first device identity from the device binding information after receiving the device binding information comprises:
after receiving the device binding information, decrypting the first device identity from the device binding information by using a shared secret key generated by the eSIM module.

4. The method according to claim 1, wherein decrypting, by the eSIM module, the second device identity from the device check information after receiving the device check information comprises:
after receiving the device check information, decrypting the second device identity from the device check information by using a shared secret key generated by the eSIM module.

5. The method according to claim 3, further comprising, before storing the first device identity sent by the first processing module:
generating an eUICC temporary working public key and an eUICC temporary working private key;
receiving a TEE temporary working public key sent by the first processing module; and
generating the shared secret key based on the eUICC temporary working private key and the TEE temporary working public key.

6. The method according to claim 5, further comprising. before receiving the TEE temporary working public key sent by the first processing module:
receiving TEE signature data sent by the first processing module, and
verifying a validity of the TEE signature data by using a TEE public key; and
receiving the TEE temporary working public key sent by the first processing module by:
after the verification on the validity of the TEE signature data succeeds, obtaining the TEE temporary working public key from the TEE signature data.

7. The method according to claim 6, further comprising, before receiving the TEE signature data sent by the first processing module:
verifying a validity of a TEE certificate; and
after the verification of the validity of the TEE certificate succeeds, obtaining the TEE public key from the TEE certificate.

8. The method according to claim 7, wherein:
the TEE certificate comprises a terminal certificate;
the TEE public key is an OEM public key in the terminal certificate; and
verifying the validity of the TEE certificate comprises:
verifying the validity of the terminal certificate by using the OEM public key in the terminal certificate.

9. The method according to claim 7, wherein:
the TEE certificate comprises a device certificate and a terminal certificate;
the TEE public key is an OEM public key in the terminal certificate; and
the method further comprises before verifying , the validity of the TEE certificate:
receiving the TEE certificate sent by the first processing module; and
verifying the validity of the TEE certificate comprises:
verifying a validity of the device certificate by using a terminal vendor root public key in a terminal vendor root certificate, and
after the verification of the validity of the device certificate succeeds, verifying the validity of the terminal certificate by using a device public key in the device certificate, wherein in response to both the validity of the device certificate and the validity of the terminal certificate succeeding, the validity of the TEE certificate succeeds.

10. The method according to claim 7, wherein:
the TEE certificate is a terminal vendor root certificate, and the terminal vendor root certificate is preset in the eSIM module; and
verifying the validity of the TEE certificate comprises:
verifying a validity of the terminal vendor root certificate by using a terminal vendor root public key in the terminal vendor root certificate.

11. The method according to claim 7, wherein the method further comprises:
generating the eUICC temporary working private key and the eUICC temporary working public key, wherein the eUICC temporary working private key and the eUICC temporary working public key are a pair of public and private keys;
signing the eUICC temporary working public key by using an eUICC private key, to obtain eUICC signature data; and
sending the eUICC signature data to the first processing module, wherein the eUICC signature data is used by the first processing module to obtain the eUICC temporary working public key and and is used to generate the shared secret key based on the eUICC temporary working public key and a TEE temporary working private key, and the TEE temporary working private key and the TEE temporary working public key are a pair of public and private keys.

12. The method according to claim 11, wherein the method further comprises:
sending an EUM certificate and an eUICC certificate to the first processing module, wherein the eUICC certificate is signed by using an EUM private key paired with an EUM public key in the EUM certificate, the EUM certificate comprises an eUICC public key, the eUICC public key and the eUICC private key are a pair of public and private keys, and the eUICC public key is used by the first processing module to verify validity of the eUICC signature data.

13. The method according to claim 1, wherein:
the first device identity is a chip identity of the first processing module, and the second device identity is a chip identity of the second processing module; or
the first device identity is an international mobile equipment identity IMEI of the first processing module, and the second device identity is an IMEI of the second processing module; or
the first device identity is a chip identity of the first processing module and an IMEI of the first processing module, and the second device identity is a chip identity of the second processing module and an IMEI of the second processing module.

14. The method according to claim 1, wherein receiving, after detecting that the eSIM module is powered off and then powered on, the device check information sent by the second processing module comprises:
after detecting that the eSIM module is powered off and then powered on, sending a first request to the second processing module, wherein the first request is used to request the second processing module to send a device identity to the eSIM module.

15. The method according to claim 14, wherein the first request comprises a first eUICC random number, and the first eUICC random number is encrypted into the device check information together with the second device identity by the second processing module.

16. The method according to claim 15, wherein the method further comprises:
decrypting, by the eSIM module, a second eUICC random number from the device check information, wherein normally performing the mobile communication service is performed in response to:
first device identity being the same as the second device identity; and
the second eUICC random number being the same as the first eUICC random number.

17. The method according to claim 14, wherein the first request is a get input command.

18. The method according to claim 2, wherein receiving, by the eSIM module, the device binding information sent by the first processing module comprises:
receiving, by the eSIM module, the device binding information sent by the first processing module by using a store data command.

19. A method applied to an electronic device comprising an eSIM module and a second processing module, the method comprising:
storing, by the eSIM module, a first device identity sent by a first processing module;
after detecting that the eSIM module is powered off and then powered on, sending, by the eSIM module, a first request to the second processing module, wherein the first request is used to request the second processing module to send a device identity to the eSIM module;
obtaining, by the second processing module, a second device identity;
encrypting, by the second processing module, the second device identity to obtain device check information;
sending, by the second processing module, the device check information to the eSIM module;
decrypting, by the eSIM module, the second device identity from the device check information;
in response to the first device identity being the same as the second device identity, normally performing, by the eSIM module, a mobile communication service; and
in response to the first device identity being different from the second device identity, or in response to the eSIM module not receiving the device check information sent by the second processing module after detecting that the eSIM module is powered off and then powered on, forbidding the eSIM module from performing the mobile communication service.

20. The method according to claim 19, further comprising, before storing, by the eSIM module, the first device identity sent by the first processing module:
receiving, by the eSIM module, device binding information sent by the first processing module; and
decrypting, by the eSIM module, the first device identity from the device binding information after receiving the device binding information, and storing the first device identity.
